(19) United States
(12) Patent Application Publication
(10) Pub. No.: US 2021/0100242 A1
(43) Pub. Date: Apr. 8, 2021

(54) FORMULATIONS FOR CONTROL AND REPELLENCY OF BITING ARTHROPODS

(71) Applicant: BEDOUKIAN RESEARCH, INC., Danbury, CT (US)

(72) Inventor: Robert H. BEDOUKIAN, West Redding, CT (US)

(73) Assignee: BEDOUKIAN RESEARCH, INC., Danbury, CT (US)

(21) Appl. No.: 17/064,916

(22) Filed: Oct. 7, 2020

Related U.S. Application Data
(60) Provisional application No. 62/912,259, filed on Oct. 8, 2019.

(51) Int. Cl. A01N 37/02; A01N 43/56; A01N 43/08; A01N 31/06; A01N 43/30

(52) U.S. Cl. CPC A01N 37/02; A01N 43/56; A01N 43/30; A01N 31/06; A01N 43/08

(57) ABSTRACT

This disclosure relates to biting arthropod control or repellent formulations for the control or repellency of biting arthropods. The formulations comprise at least one sensate compound, wherein the at least one sensate compound is present in an effective amount sufficient to control or repel biting arthropods. This disclosure also relates to a method for the control or repellency of biting arthropods. The method comprises bringing the biting arthropods into contact with a biting arthropod control or repellent formulation. The biting arthropod control or repellent formulation comprises at least one sensate compound, wherein the at least one sensate compound is present in an effective amount sufficient to control or repel biting arthropods.

### RELATED APPLICATION

This application claims the benefit of U.S. Application No. 62/912,259, filed Oct. 8, 2019, which is incorporated herein by reference in its entirety.

### BACKGROUND OF THE DISCLOSURE

### 1. Field of the Disclosure

This disclosure relates to repellent formulations of sensate compounds used as agents to control and repel biting arthropods, and especially biting insects.

### 2. Description of the Related Art

Many mammals, including humans, have suffered the action of mosquitoes and other biting insects. The blood sucking of mosquitoes results in an itching sensation and often a rash. Also, many mosquitoes cause potentially life-threatening illness. Aedes aegypti can cause dengue fever and yellow fever, Anopheles quadrimaculatus can cause malaria and Culex quinquefasciatus can cause West Nile disease. One possible solution to these problems is applying an arthropod repelling agent to the skin as a topical repellent. Applying arthropod or insect repellents to fabric, like mosquito netting, is another way of reducing arthropod, insect or mosquito bites.

DEET®, namely N,N-Diethyl-m-toluamide, is widely used against biting arthropods and insects, but is characterized by an unseemly bad smell, is not particularly long lasting in its effect and it dissolves plastics. Moreover, several safety questions have been raised concerning the use of DEET® and some governments have restricted the amount of the active component that may be employed in formulations. This itself presents a further problem since DEET® is subject to evaporation and it needs to be formulated at higher than effective dosages in order to maintain its effectiveness. Furthermore, many insects and pests have developed resistance to DEET® due to its wide spread usage.

As such, there is a need to provide a biting insect repellent formulation that can reduce or eliminate the use of standard repellents like DEET®, para-Menthane-3,8-diol (PMD) or Picaridin.

### SUMMARY OF THE DISCLOSURE

In accordance with this disclosure, a method is provided for the control or repellency of biting arthropods. The method comprises bringing the biting arthropods into contact with a biting arthropod control or repellent formulation. The biting arthropod control or repellent formulation comprises at least one sensate compound, wherein the at least one sensate compound is present in an effective amount sufficient to control or repel biting arthropods.

Also, in accordance with this disclosure, biting arthropod control or repellent formulations are provided for the control or repellency of biting arthropods. The formulations comprise at least one sensate compound, wherein the at least one sensate compound is present in an effective amount sufficient to control or repel biting arthropods.

Certain embodiments of this disclosure include, but are not limited to, the use of at least one sensate compound to improve the efficacy of the materials in mosquito repellency, and minimizing the sensate perception by the user to a comfortable level for human use. The formulations of this disclosure include sensate compounds with select flavor or fragrance compounds to amplify or attenuate the perception of biting arthropods.

This disclosure also includes optical isomers, diastereomers and enantiomers of the named structures. Thus, at all stereocenters where stereochemistry is not explicitly defined, all possible epimers are envisioned.

Further objects, features and advantages of the present disclosure will be understood by reference to the following detailed description.

### DESCRIPTION OF THE EMBODIMENTS

As used herein, sensate compounds include any and all compounds that cause tingling, burning or cooling effects. The sensate compounds can serve to activate or desensitize touch, taste or odor perception. Illustrative sensate compounds include, for example, cooling agents, analgesics, and the like.

Also, as used herein, FEMA refers to “Flavor & Extract Manufacturers Association”, and GRAS refers to “Generally Recognized As Safe”.

Control and repellency of biting arthropods, and especially biting insects, is obtained by contact of the biting arthropods with one or more sensate compounds.

The biting arthropod and especially biting insect, repellent formulations of this disclosure comprise at least one sensate compound, wherein the at least one sensate compound is present in an effective amount sufficient to control or repel biting arthropods.

The disclosure also comprises control of such biting arthropods, especially biting insects, by bringing the biting arthropods into contact with one of the biting arthropod repellent formulations having one or more sensate compounds.

While not wishing to be bound to any particular theory, it is believed that the biting arthropod repellent formulations of this disclosure either make the biting arthropods more sensitive to the formulations or that they desensitize the biting arthropods to the attractants on the skin.

Representative examples of sensate compounds useful in this disclosure include, but are not limited to:

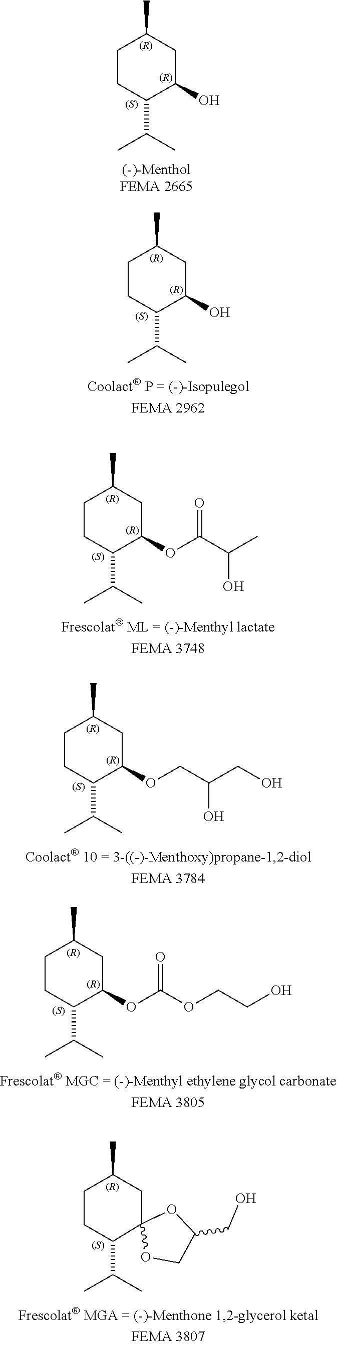

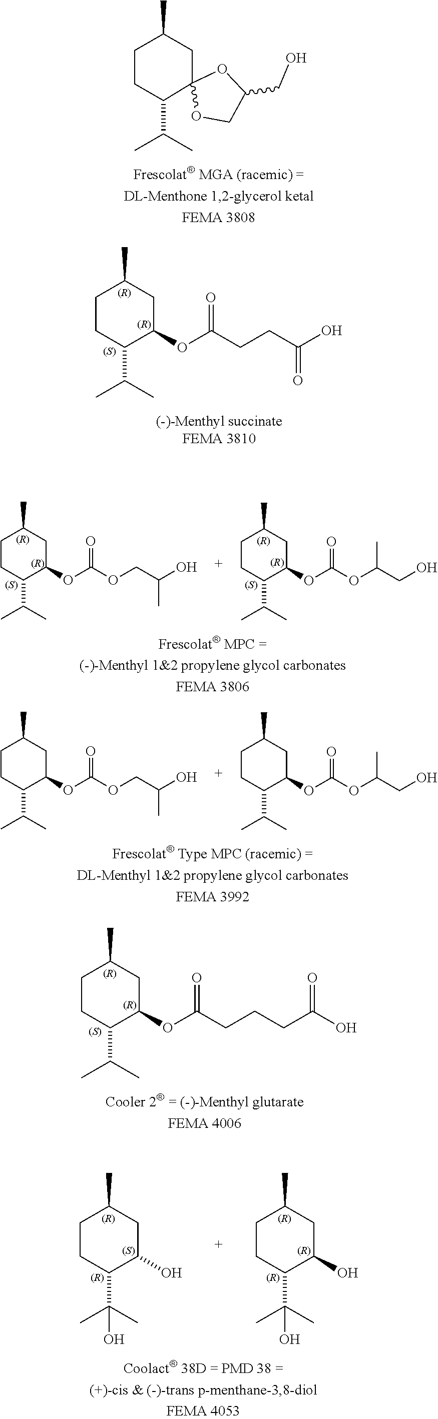

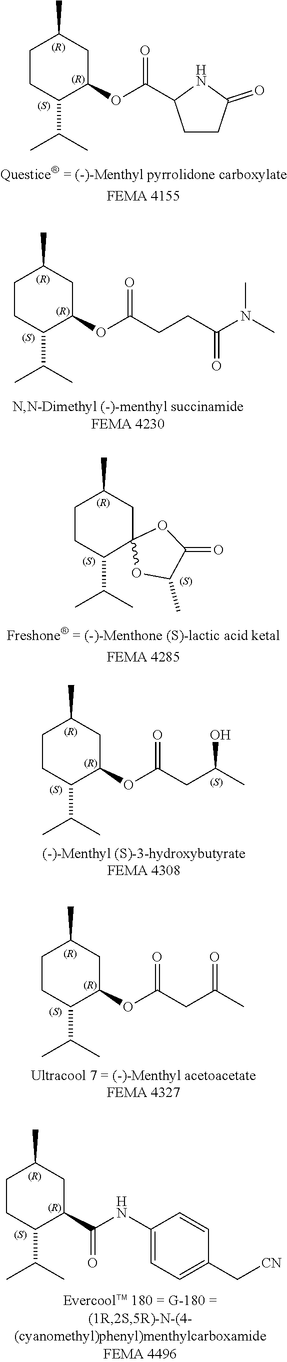

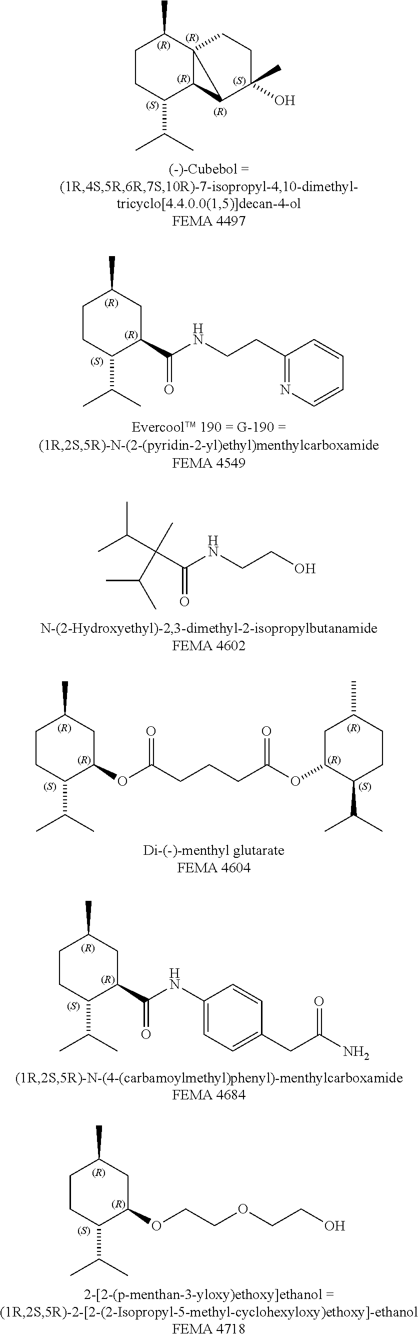

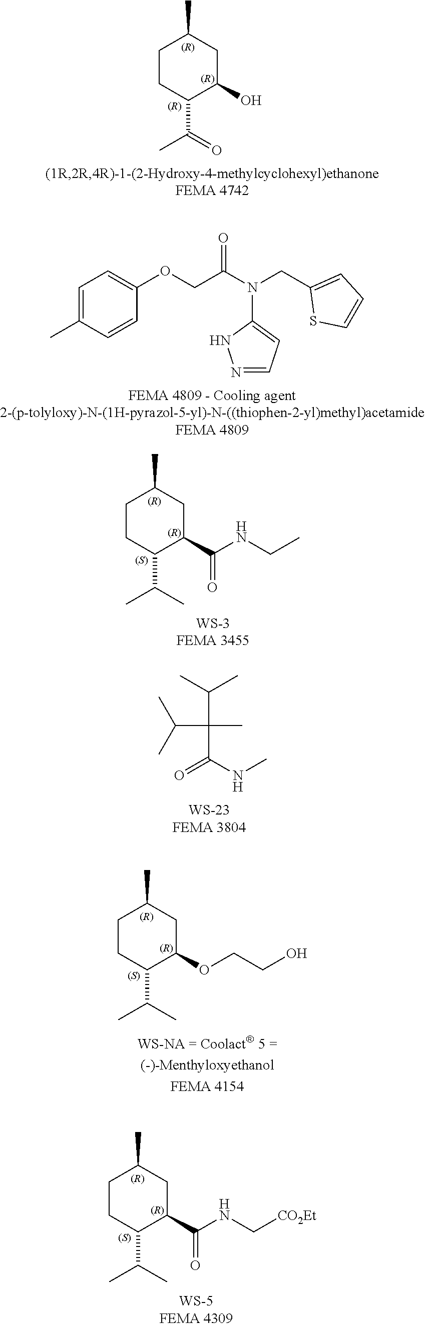

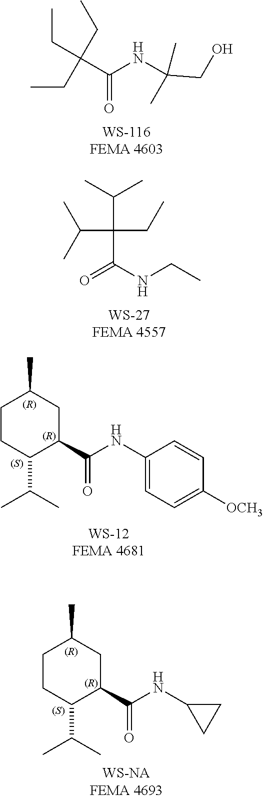

In an embodiment, sensate compounds useful in this disclosure include, for example, WS-23 (2-isopropyl-N,2,3-trimethylbutyramide), FEMA 3804; WS-3 (N-ethyl-p-menthane-3-carboxamide), FEMA 3455; WS-5 [ethyl 3-(p-menthane-3-carboxamido)acetate], FEMA 4309; WS-12 (1R,2S,5R)—N-(4-methoxyphenyl)-p-menthanecarboxamide, FEMA 4681; WS-27 (N-ethyl-2,2-diisopropylbutanamide), FEMA 4557; N-cyclopropyl-5-methyl-2-isopropylcyclohexanecarboxamide, FEMA 4693; WS-116 (N-(1,1-dimethyl-2-hydroxyethyl)-2,2-diethylbutanamide), FEMA 4603; menthoxyethanol, FEMA 4154; N-(4-cyanomethylphenyl)-p-menthanecarboxamide, FEMA 4496; N-(2-(pyridin-2-yl)ethyl)-3-p-menthanecarboxamide, FEMA 4549; N-(2-hydroxyethyl)-2-isopropyl-2,3-dimethylbutanamide, FEMA 4602; N-(4-(carbamoylmethyl)phenyl)-menthylcarboxamide, FEMA 4684; (1R,2S,5R)—N-(4-methoxyphenyl)-p-menthanecarboxamide (WS-12), FEMA 4681; (2S,5R)—N-[4-(2-amino-2-oxoethyl)phenyl]-p-menthanecarboxamide, FEMA 4684; N-cyclopropyl-5-methyl-2-isopropylcyclohexanecarbonecarboxamide, FEMA 4693; 2-[(2-p-menthoxy)ethoxy]ethanol, FEMA 4718; 2,6-diethyl-5-isopropyl-2-methyltetrahydropyran, FEMA 4680; a TRPV1 antagonist that inhibits heat sensation and thus enhances cooling agents trans-4-tert-butylcyclohexanol, FEMA 4724; 2-(p-tolyloxy)-N-(1H-pyrazol-5-yl)-N-((thiophen-2-yl)methyl)acetamide, FEMA 4809; racemic N-isopropyl-5-methylcyclohexyl)cyclopropanecarboxamide, FEMA 4558; menthone glycerol ketal, FEMA 3807 and 3748; menthoxypropane-1,2-diol FEMA 3784; N-(2-hydroxyethyl)-2,3-dimethyl-2-isopropylbutyramide, FEMA 4602; N-(1,1-dimethyl-2-hydroxyethyl)2,2-diethylbutanamide, FEMA 4603); 1R,2S,5R)—N-(4-methoxyphenyl)-p-menthanecarboxamide, WS-12, N-cyclopropyl-5-methyl-2-isopropylcyclohexanecarbonecarboxamide, FEMA 4693; (1R,3R,4S)-3-menthyl-3,6-dioxaheptanoate, (1R,2S,5R)-3-menthyl methoxyacetate, (1R,2S,5R)-3-menthyl 3,6,9-trioxadecanoate, (1R,2S,5R)-3-menthyl 3,6,9-trioxadecanoate, (1R,2S,5R)-3-menthyl (2-hydroxyethoxy)acetate & (1R,2S,5R)-menthyl 11-hydroxy-3,6,9-trioxaundecanoate, N-(4-cyanomethylphenyl) p-menthanecarboxamide FEMA 4496; N,N-dimethyl menthyl succinamide (2-isopropyl-5-methylcyclohexyl 4-(dimethylamino)-4-oxobutanoate), FEMA 4230; N-(4-cyanomethylphenyl) p-menthanecarboxamide, FEMA 4496; N-(2-pyridin-2-ylethyl) p-menthanecarboxamide, FEMA 4549; menthyl lactate, FEMA 3748; N-(4-cyanomethylphenyl) p-menthanecarboxamide, FEMA 4496; N-(2-pyridin-2-ylethyl) p-menthanecarboxamide, FEMA 4549; menthyl lactate, FEMA 3748; menthol, WS-3, WS-23 and (−)-menthoxypropane-1,2-diol (TK-10), 6-isopropyl-3,9-dimethyl-1,4-dioxaspiro[4.5]decan-2-one, FEMA 4285; menthane carboxamides, N-benzo[1,3] dioxol-5-yl-3-p-menthanecarboxamide, N-benzooxazol-4-yl-3-p-menthanecarboxamide, N-4-([1,2,4]triazol-1-yl)-phenyl-3-p-menthanecarboxamide & N-4-(pyrazol-1-yl)-phenyl-3-p-menthanecarboxamide, 2,2,5,6,6-pentamethyl-2,3,6,6a-tetrahydropentalen-3a(1H)-ol, 5-(2-hydroxy-2-methylpropyl)-3,4,4-trimethylcyclopent-2-en-1-one, pyridinalkylcyclohexane carboxamides, (1R,2S,5R)-2-isopropyl-5-methyl-N-(2-(pyridin-2-yl)ethyl)cyclohexanecarboxamide, FEMA 4549, (2S,5R)-2-isopropyl-5-methyl-N-(2-(pyridin-4-yl)ethyl)cyclohexanecarboxamide, N-(4-cyanomethylphenyl) p-menthanecarboxamide, FEMA 4496; 1-isopropyl-4-methyl-bicyclo[2.2.2-1oct-5-ene-2,3-dicarbinol, 4-methoxy-N-phenyl-N-[2-(pyridin-2-yl)ethyl]benzamide, 4-methoxy-N-phenyl-N-[2-(pyridin-2-yl)ethyl]benzenesulfonamide, 4-chloro-N-phenyl-N-[2-(pyridin-2-yl)ethyl]benzenesulfonamide, 4-cyano-N-phenyl-N-[2-(pyridin-2-yl)ethyl]benzenesulfonamide, 4-((benzhydrylamino)methyl)-2-methoxyphenol, 4-((bis(4-methoxyphenyl)-methylamino)-methyl)-2-methoxyphenol, 4-((1,2-diphenylethylamino)methyl)-2-methoxyphenol, 4-((benzhydryloxy)methyl)-2-methoxyphenol, 4-((9H-fluoren-9-ylamino)methyl)-2- or 4-((benzhydrylamino)methyl)-2-ethoxyphenol, 1-(4-methoxyphenyl)-2-(1-methyl-1H-benzo[d]imidazol-2-yl)vinyl4-methoxybenzoate, 2-(1-isopropyl-6-methyl-1H-benzo[d]imidazol-2-yl)-1-(4-methoxyphenyl)vinyl4-methoxybenzoate, (Z)-2-(1-isopropyl-5-methyl-1H-benzo[d]imidazol-2-yl)-1-(4-methoxy-phenyl)vinyl-4-methoxybenzoate, N-(1-methyl-1-isopropylbutyl)benzamide, fenchyl, D-bornyl, L-bornyl, exo-norbornyl, 2-methylisobornyl, 2-ethylfenchyl, 2-methylbornyl, cis-pinan-2-yl, verbanyl and isobornyl derivatives, menthyl oxamate derivatives, menthyl 3-oxocarboxylic acid esters, L-menthyl 3-oxobutyrate, L-menthyl 3-oxopentanoate, 3,4-methylenedioxycinnamic acid, N,N-diphenylamide, (1R,2R,4S)-dihydroumbellulol, (1R,2R,5R)—N-ethyl-5-methyl-2-(prop-1-en-2-yl)cyclohexanecarboxamide, 1-[2-hydroxyphenyl]-4-[2-nitrophenyl-]-1,2,3,6-tetrahydropyrimidine-2-one), (2E,6E/Z,8E)-N-(2-methylpropyl)-2,6,8-decatrienamide, FEMA 4668; octadiene amides, octatriene amides, nonadiene amides, nonatriene amides, decadiene amides, decatriene amides, menthone, isopulegol, isopulegone including geometric isomers and non-nitrogen containing derivatives, cubebol, ketals from menthone, fenchol derivatives, bornyl derivatives, N,N-diethyl-m-toluamide, para-menthane-3,8-diol, menthyl pyrrolidone carboxylate, and the like. Sensate compounds having a carbon structure of derivatives of 2-isopropyl-5-methylcyclohexane are useful in this disclosure.

Illustrative sensate compounds useful in this disclosure are described, for example, in U.S. Pat. Nos. 4,150,052, 4,296,255, 4,296,093, 4,230,688, 4,226,988, 4,193,936, 4,178,459, 4,153,679, 4,150,052, 4,070,496, 4,070,449, 4,060,091, 4,059,118, 4,034,109, 4,033,994, 4,032,661, 4,020,153, 5,266,592, 4,459,425, 5,773,410, 6,267,974, 6,592,884, 5,959,161, 6,328,982, 6,359,168, 6,214,788, 5,608,119, 6,451,844, 6,884,906, 7,030,273, 7,189,760, 7,414,152, 7,935,848, 7,959,958, and 8,377,422; United States Patent Application Publication Nos. 2004/0028714, 20040067970, 2005/0265930, 2006/0249167, 2007/0048424, 2007/0059417, 2007/0155755, 2007/0274928, 2008/0292763, 2008/0293821, 2008/0319055, 2008/0311232, 2008/0038386, 2008/0175800, 2008/0096969, 2009/0054520, 2010/00272655, 2010/007608, 2011/0145970, 2013/0216486, 2014/0219930, and 2015/0139918; WO Patent Nos. 2005/049553, 2006/092074, 2006/099762, 2006/103401, 2007/022651, 2007/048265, 2007/104175, 2008/006236, 2008/148234, 2010/128026, 2011/061330, 2011/138696, 2012/061698, 2013/033501, 2013/080830, and 2014/010657; European Patent No. 2772477 Japanese Patent No. 2004059474 and 60199804; and German Patent No. 19840321; the disclosures of all of which are incorporated herein by reference.

Other illustrative sensate compounds useful in this disclosure are described, for example, in http://www.leffingwell.com/cooler_than_menthol.htm, the disclosure of which is incorporated herein by reference.

For purposes of this disclosure, sensate compounds include known compounds, such as those described herein, as well as compounds having similar chemical structures (e.g., amides, amines, esters, alcohols, diols, ketones, ketals, acids, lactones, and the like) to the known compounds, but may or may not have the same sensate characteristics as the known compounds when applied to humans.

The sensate compounds of this disclosure may be combined with other compounds, in particular, at least one compound (a) selected from the group consisting of:

(1) alkyl ketones and cyclic ketones, saturated or unsaturated, branched or unbranched, containing from about 6 to about 18 carbon atoms, or any range of carbon atoms within said range;

(2) compounds of the structure (A)

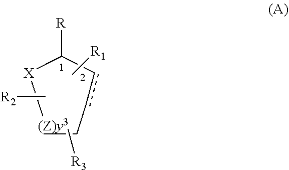

wherein:

R is selected from —OH, ═O, —OC(O)R₄, —OR₆, and —(OR₆)₂, wherein each R₆ is independently selected from an alkyl group containing from about 1 to about 4 carbon atoms and R₄ is a branched or straight chain, saturated or unsaturated, hydrocarbyl group with zero to two double bonds and from about 1 to about 15 carbon atoms;

X is O or CH₂, with the proviso that when X is O, R can only be ═O;

each Z is independently selected from (CH) and (CH₂);

y is a numeral selected from 1 and 2;

R₁ is selected from H or a branched or straight chain, saturated or unsaturated, hydrocarbyl group with zero to two double bonds and from about 1 to about 15 carbon atoms;

R₂ is selected from H and a branched or straight chain, saturated or unsaturated, hydrocarbyl group with zero to three double bonds and from about 1 to about 15 carbon atoms;

R₃ is selected from H, a branched or straight chain, saturated or unsaturated, hydrocarbyl group with zero to three double bonds and from about 1 to about 15 carbon atoms, —(CH₂)ₙOH, —C(O)OR₅, —CH₂C(O)OR₇, —CH₂C(O)R₈, —C(O)NR₉R₁₀, and —CH₂C(O)NR₁₁R₁₂, wherein each of R₅, R₇, R₈, R₉, R₁₀, R₁₁ and R₁₂ is independently selected from H and a branched or straight chain, saturated or unsaturated, hydrocarbyl group with zero to three double bonds and from about 1 to about 15 carbon atoms, and n is n integer of from 1 to 12;

the bond between the 2 and 3 positions in the ring structure may be a single or a double bond; and

wherein the compounds of structure (A) contain from about 11 to about 20 carbon atoms; and includes optical isomers, diastereomers and enantiomers of the compounds of structure (A);

(3) branched or unbranched, straight chain or cyclic, saturated or unsaturated, carboxylic acids containing from about 3 to about 18 carbon atoms or any range of carbon atoms within said range, including isomers thereof; and

(4) esters of branched or unbranched, straight chain or cyclic, saturated or unsaturated, carboxylic acids containing from about 3 to about 18 carbon atoms or any range of carbon atoms within said range, including isomers thereof.

As examples of compounds (a), there may be mentioned geranyl acetone (6,10-dimethyl-5,9-undecadien-2-one), methyl undecyl ketone (2-tridecanone), geranylcyclopentanone (2-(3,7-dimethylocta-2,6-dienyl)cyclopentan-1-one), octenylcyclopentanone (2-(2-octen-1-yl)-cyclopentanone), methyl decyl ketone (2-dodecanone), nootkatone (4,4a-dimethyl-6-prop-1-en-2-yl-3,4,5,6,7,8-hexahydronaphthalen-2-one), alpha-ionone (4-(2,6,6-trimethyl-2-cyclohexenyl)-3-buten-2-one), beta ionone (4-(2,6,6-trimethyl-1-cyclohexenyl)-3-buten-2-one), alpha-isomethylionone (3-methyl-4-(2,6,6-trimethyl-2-cyclohexen-1-yl)-3-buten-2-one), nectaryl (2-(2-(4-methyl-3-cyclohexen-1-yl) propyl) cyclopentanone), isobutylionone ((E)-5-Methyl-1-(2,6,6-trimethyl-1-cyclohex-2-enyl) hex-1-en-3-one), isolongifolen-9-one ((1R)-2,2,7,7-tetramethyltricyclo[6.2.1.01,6] undec-5-en-4-one) dimethylionone ((E)-2-methyl-1-(2,2,6-trimethyl-1-cyclohex-3-enyl)pent-1-en-3-one), isolongifolanone (2,2,7,7-tetramethyltricyclo[6.2.1.01,6]undecan-5-one), pseudoionone (6,10-dimethyl-3,5,9-undecatrien-2-one), 2-cyclopentylcyclopentanone, methyl nonyl ketone, 2-decen2-one and 1-carvone. Especially preferred are octenyl cyclopentanone, geranyl cyclopentanone, methyl decyl ketone, methyl undecyl ketone, geranylacetone, ionone, isolongifolenone, and nootkatone.

As examples of alkyl and cyclic ketones of compounds (a) there may be mentioned geranyl acetone (6,10-dimethyl-5,9-undecadien-2-one), farnesyl acetone (5,9,13-pentadecatrien-2-one, 6,10,14-trimethyl-) methyl undecyl ketone (2-tridecanone), methyl decyl ketone (2-dodecanone), alpha-ionone (4-(2,6,6-trimethyl-2-cyclohexenyl)-3-buten-2-one), beta ionone (4-(2,6,6-trimethyl-1-cyclohexenyl)-3-buten-2-one), alpha-isomethylionone (3-methyl-4-(2,6,6-trimethyl-2-cyclohexen-1-yl)-3-buten-2-one), isobutylionone ((E)-5-methyl-1-(2,6,6-trimethyl-1-cyclohex-2-enyl) hex-1-en-3-one), isolongifolen-9-one ((1R)-2,2,7,7-tetramethyltricyclo[6.2.1.01,6] undec-5-en-4-one), dimethylionone ((E)-2-methyl-1-(2,2,6-trimethyl-1-cyclohex-3-enyl)pent-1-en-3-one), isolongifolanone (2,2,7,7-tetramethyltricyclo[6.2.1.01,6]undecan-5-one), pseudoionone (6,10-dimethyl-3,5,9-undecatrien-2-one), 2-cyclopentylcyclopentanone, methyl nonyl ketone (2-undecanone), and 3-decen-2-one. Especially preferred are methyl decyl ketone, methyl undecyl ketone, methyl nonyl ketone, geranyl acetone, farnesyl acetone, ionone, and isolongifolenone.

Representative examples of alkyl ketones of compounds (a) include, but are not limited to, geranyl acetone having the formula

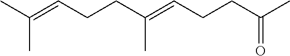

and a methyl ketone with variable chain length (e.g., R is a hydrocarbon group having from about 1 to about 18 carbon atoms)

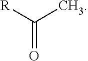

Representative preferred examples of alkyl ketones of compounds (a) include, but are not limited to, geranyl acetone, farnesyl acetone, methyl undecyl ketone, and methyl nonyl ketone.

Representative examples of compounds of structure (A) include, but are not limited to,

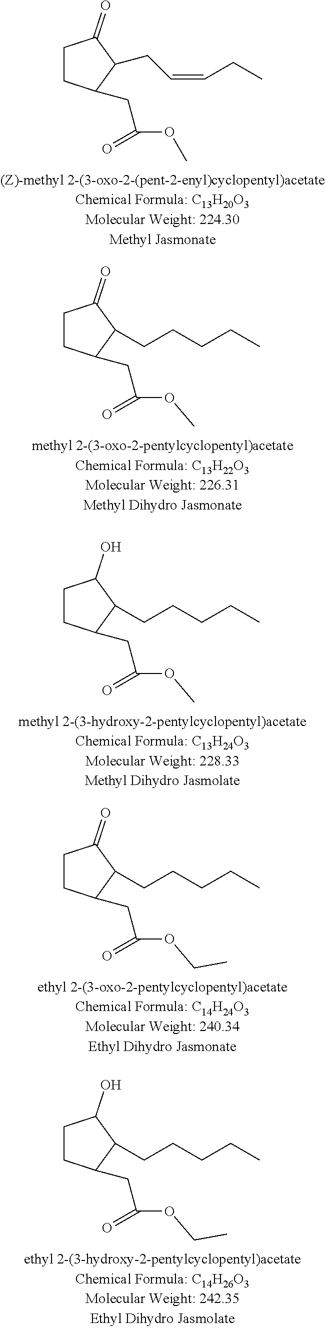 [SMILES: CC/C=C\CC1C(=O)CCC1CC(=O)OC ; CCCCCC1C(=O)CCC1CC(=O)OC ; CCCCCC1C(O)CCC1CC(=O)OC ; CCCCCC1C(=O)CCC1CC(=O)OCC ; CCCCCC1C(O)CCC1CC(=O)OCC]

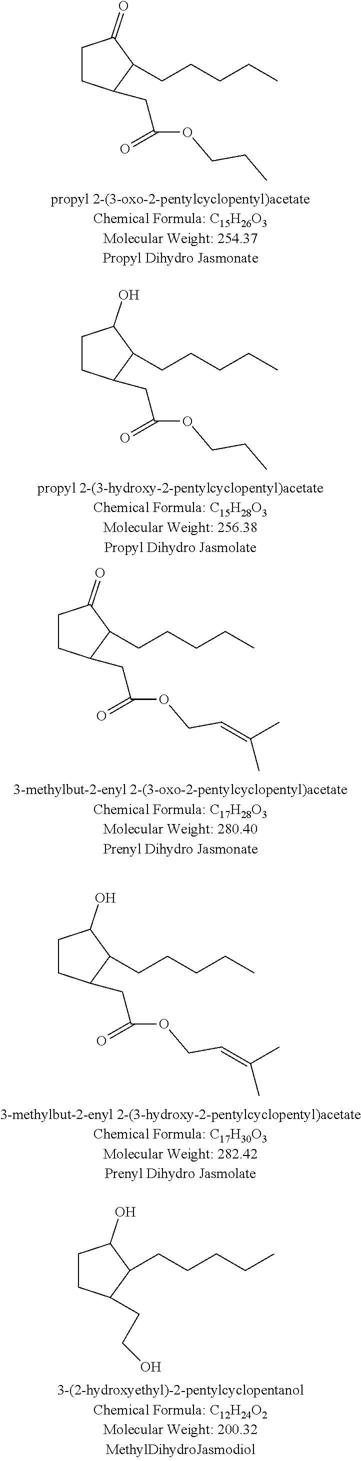 [SMILES: CCCCCC1C(=O)CCC1CC(=O)OCCC ; CCCCCC1C(O)CCC1CC(=O)OCCC ; CCCCCC1C(=O)CCC1CC(=O)OCC=C(C)C ; CCCCCC1C(O)CCC1CC(=O)OCC=C(C)C ; CCCCCC1C(O)CCC1CCO]

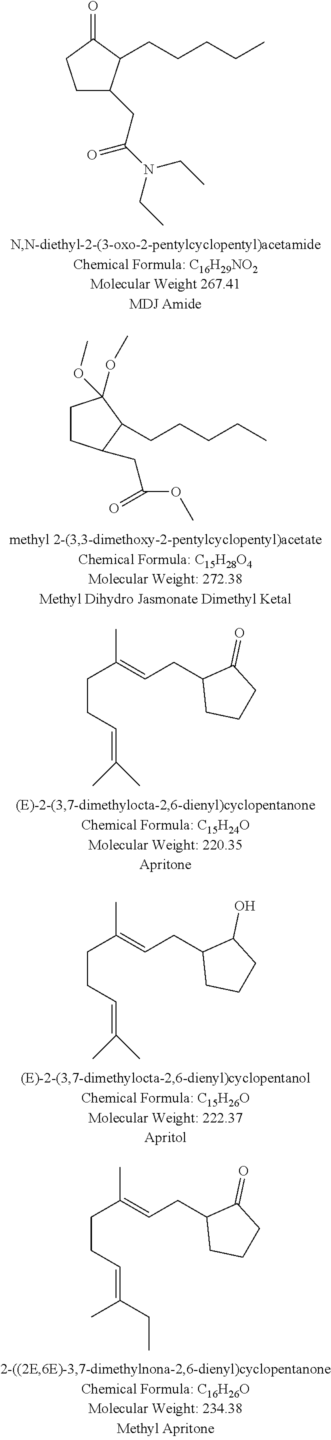 [SMILES: CCCCCC1C(=O)CCC1CC(=O)N(CC)CC ; CCCCCC1C(CC(=O)OC)CCC1(OC)OC ; CC(C)=CCC/C(C)=C/CC1CCCC1=O ; CC(C)=CCC/C(C)=C/CC1CCCC1O ; CC/C(C)=C/CC/C(C)=C/CC1CCCC1=O]

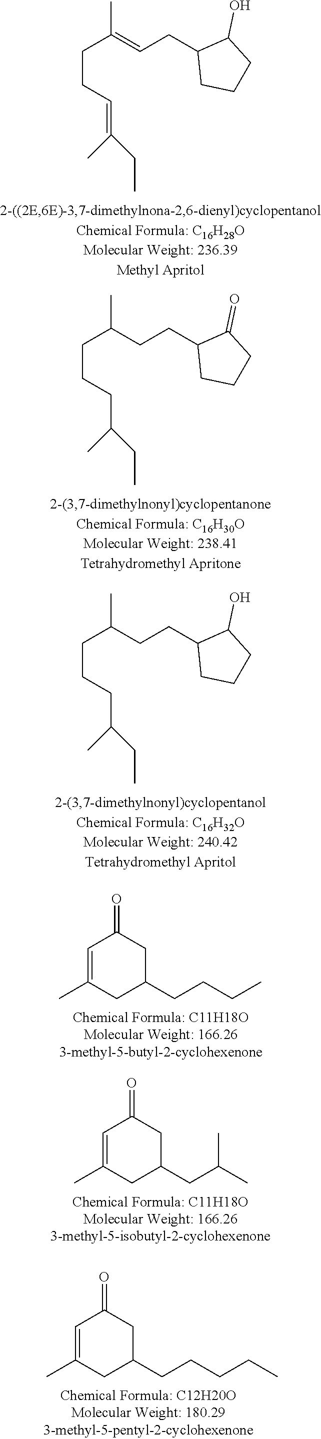

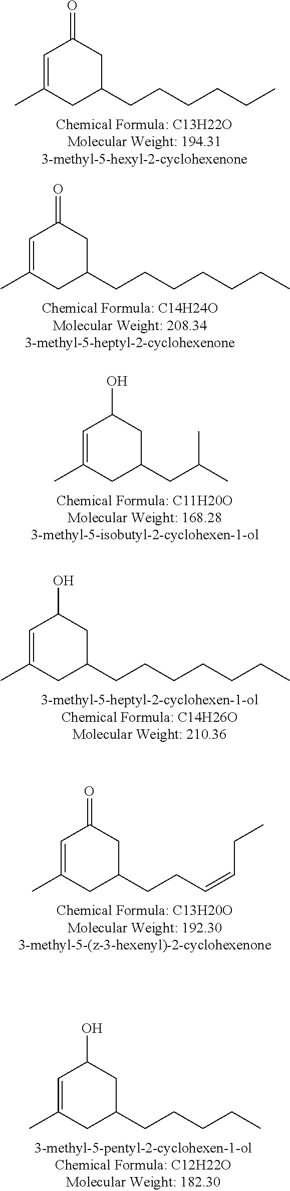

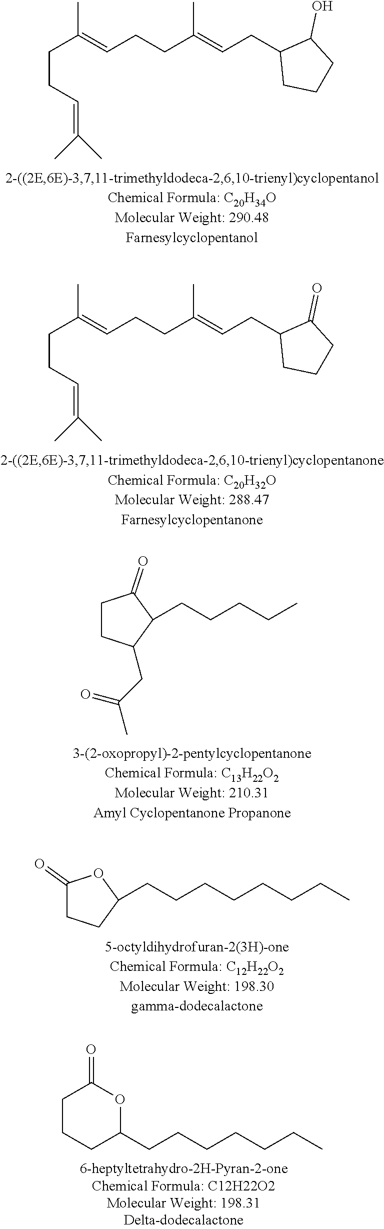 [SMILES: CC(C)=CCC/C(C)=C/CC/C(C)=C/CC1CCCC1O ; CC(C)=CCC/C(C)=C/CC/C(C)=C/CC1CCCC1=O ; CCCCCC1C(=O)CCC1CC(C)=O ; CCCCCCCCC1CCC(=O)O1 ; CCCCCCCC1CCCC(=O)O1]

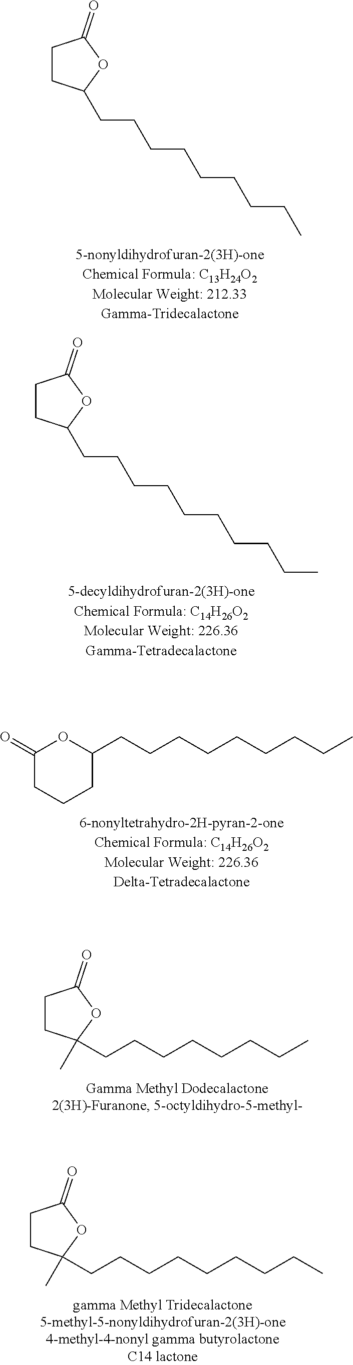 [SMILES: CCCCCCCCCC1CCC(=O)O1 ; CCCCCCCCCCC1CCC(=O)O1 ; CCCCCCCCCC1CCCC(=O)O1 ; CCCCCCCCC1(C)CCC(=O)O1 ; CCCCCCCCCC1(C)CCC(=O)O1]

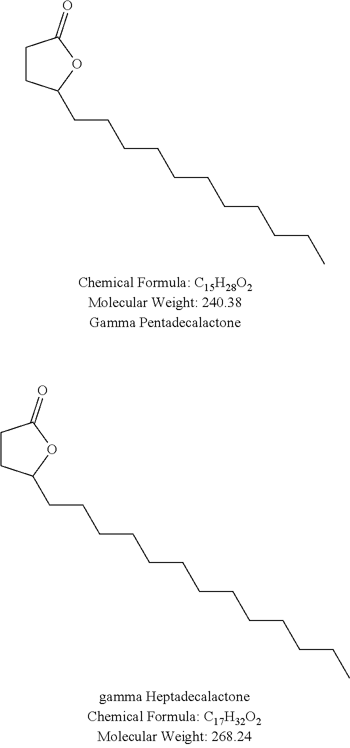 [SMILES: CCCCCCCCCCCC1CCC(=O)O1 ; CCCCCCCCCCCCCC1CCC(=O)O1]

Especially preferred compounds of structure (A) include methyl apritone, methyl dihydrojasmonate, propyl dihydrojasmonate, gamma-dodecalactone, delta-dodecalactone, gamma-tridecalactone, gamma-tetradecalactone, gamma methyl dodecalactone, gamma methyl tridecalactone, 3-methyl-5-pentyl-2-cyclohexenone, 3-methyl-5-pentyl-2-cyclohexenol and 3-methyl-5-heptyl-2-cyclohexenone.

Representative examples of carboxylic acids of compounds (a) include, but are not limited to, lactic acid, salicylic acid, geranic acid, citronellic acid, 3-methyl-2-decenoic acid, and any isomers thereof. Preferred carboxylic acids of compounds (a) include the following having the formula:

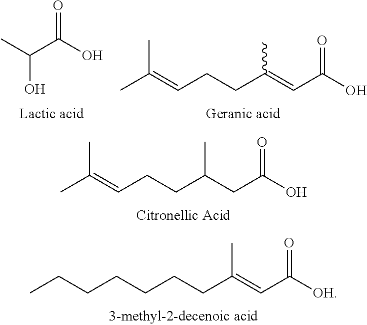

Representative examples of esters of carboxylic acids of compounds (a) include, but are not limited to, methyl lactate, ethyl lactate, propyl lactate, butyl lactate, amyl lactate, isoamyl lactate, hexyl lactate, cis-3-hexenyl lactate, methyl geranate, ethyl geranate, isoamyl geranate, methyl citronellate, ethyl citronellate, methyl salicylate, ethyl salicylate, amyl salicylate, isoamyl salicylate, hexyl salicylate, cis-3-hexenyl salicylate, and any isomers thereof.

Representative preferred examples of compounds (a) include, but are not limited to: geranyl acetone, farnesyl acetone, gamma dodecalactone, 3-methyl-5-hexyl-2-cyclohexenone, cis-3-hexenyl salicylate, propyl dihydrojasmonate, methyl dihydrojasmolate, methyl undecyl ketone, methyl nonyl ketone and 3-methyl-2-decenoic acid.

The formulations of this disclosure may be employed against any biting arthropod desired to be repelled or controlled. Such biting arthropods and insects include mosquitoes, bed bugs, biting flies, ticks, ants, fleas, biting midges, and spiders.

The active compounds of the formulations may be formulated into any suitable formulations such as for example, including but not limited to, solutions, oils, creams, lotions, shampoos, aerosols or the like. Traditional inert carriers such as, including but not limited to, alcohols, esters and petroleum distillates, could be used to produce formulations of the active compounds to be used as repellent formulations. Another series of carriers are the biodegradable oils, including but not limited to, the Olestra® family of oils, isopropyl myristate and squalane.

When the formulation will be used as an aerosol, it is preferable to add a propellant. Suitable propellants include, but are not limited to, propane, butane, isobutane, dimethyl ether, carbon dioxide, nitrous oxide, nitrogen, and combinations thereof.

The total amount of active biting arthropod repellent compound utilized in any biting arthropod control or repellent formulation will depend upon the type of formulation used and the particular biting arthropod against which the formulation is employed but will generally range from about 0.5% to about 50% by weight in a carrier.

The amount of the formulation comprising the at least one sensate compound will depend upon the type of formulation used and the particular biting insect, arachnid or other arthropod against which the formulation is employed, but will generally range from about 0.005% to 50% by weight, or from about 0.01% to about 30% by weight, or from about 0.05% to about 25% by weight, or from about 0.05% to about 20% by weight, or from about 0.05% to about 15% by weight, or from about 0.05% to about 10% by weight, or from about 0.05% to about 5% by weight, in a carrier.

In an embodiment, the formulation comprising a sensate compound and a compound (a) can be present in an amount from about 0.01 to about 50% by weight or greater, in a carrier, and in a weight ratio of the sensate compound to compound (a) from about 2000:1 to about 1:2000, preferably a weight ratio from about 1:1 to about 1:2000, or from about 1:1 to about 1:1500, or from about 1:1 to about 1:1000, or from about 1:1 to about 1:500, or from about 1:1 to about 1:100, or from about 1:1 to about 1:10.

In another embodiment, the formulation comprising a sensate compound and a compound (a) can be present in an amount from about 0.05 to about 30% by weight or greater, in a carrier, and in a weight ratio of the sensate compound to the compound (a) from about 1500:1 to about 1:1500, preferably a weight ratio from about 1:1 to about 1:1500, or from about 1:1 to about 1:1000, or from about 1:1 to about 1:500, or from about 1:1 to about 1:100, or from about 1:1 to about 1:10.

In yet another embodiment, the formulation comprising a sensate compound and a compound (a) can be present in an amount from about 0.1 to about 25% by weight or greater, in a carrier, and in a weight ratio of the sensate compound to the compound (a) from about 1000:1 to about 1:1000, preferably a weight ratio from about 1:1 to about 1:1000, or from about 1:1 to about 1:500, or from about 1:1 to about 1:100, or from about 1:1 to about 1:10.1

In still another embodiment, the formulation comprising a sensate compound and a compound (a) can be present in an amount from about 0.5 to about 20% by weight or greater, in a carrier, and in a weight ratio of the sensate compound to the compound (a) from about 500:1 to about 1:500, preferably a weight ratio from about 1:1 to about 1:500, or from about 1:1 to about 1:100, or from about 1:1 to about 1:10.

In another embodiment, the formulation comprising a sensate compound and a compound (a), in which the sensate compound is selected from menthol, menthone, isopulegol, isopulegone including geometric isomers and non-nitrogen containing derivatives, cubebol, ketals from menthone, fenchol derivatives, and bornyl derivatives, and the compound (a) is selected from geranyl acetone, farnesyl acetone, gamma dodecalactone, 3-methyl-5-hexyl-2-cyclohexenone, cis-3-hexenyl salicylate, propyl dihydrojasmonate, methyl dihydrojasmolate, methyl undecyl ketone, methyl nonyl ketone and 3-methyl-2-decenoic acid, is present in an amount from about 0.01 to about 50% by weight or greater, in a carrier, and in a weight ratio of the sensate compound to the compound (a) from about 2000:1 to about 1:2000, preferably a weight ratio from about 1:1 to about 1:2000, or from about 1:1 to about 1:1500, or from about 1:1 to about 1:1000, or from about 1:1 to about 1:500, or from about 1:1 to about 1:100, or from about 1:1 to about 1:10.

In yet another embodiment, the formulation comprising a sensate compound and a compound (a), in which the sensate compound is selected from menthol, menthone, isopulegol, isopulegone including geometric isomers and non-nitrogen containing derivatives, cubebol, ketals from menthone, fenchol derivatives, and bornyl derivatives, and the compound (a) is selected from geranyl acetone, farnesyl acetone, gamma dodecalactone, 3-methyl-5-hexyl-2-cyclohexenone, cis-3-hexenyl salicylate, propyl dihydrojasmonate, methyl dihydrojasmolate, methyl undecyl ketone, methyl nonyl ketone and 3-methyl-2-decenoic acid, is present in an amount from about 0.1 to about 25% by weight or greater, in a carrier, and in a weight ratio of the sensate compound to the compound (a) from about 1000:1 to about 1:1000, preferably a weight ratio from about 1:1 to about 1:1000, or from about 1:1 to about 1:500, or from about 1:1 to about 1:100, or from about 1:1 to about 1:10.

In still another embodiment, the formulation comprising a sensate compound and a compound (a), in which the sensate compound is selected from menthol, menthone, isopulegol, isopulegone including geometric isomers and non-nitrogen containing derivatives, cubebol, ketals from menthone, fenchol derivatives, and bornyl derivatives, and the compound (a) is selected from geranyl acetone, farnesyl acetone, gamma dodecalactone, 3-methyl-5-hexyl-2-cyclohexenone, cis-3-hexenyl salicylate, propyl dihydrojasmonate, methyl dihydrojasmolate, methyl undecyl ketone, methyl nonyl ketone and 3-methyl-2-decenoic acid, is present in an amount from about 0.5 to about 20% by weight or greater, in a carrier, and in a weight ratio of the sensate compound to the compound (a) from about 500:1 to about 1:500, preferably a weight ratio from about 1:1 to about 1:500, or from about 1:1 to about 1:100, or from about 1:1 to about 1:10.

The formulation may be applied to surfaces of, or impregnated in, clothing or fabric. The formulation may be applied to fabrics such as, but not limited to mosquito nets. The amount of active material can be about 0.01 μg/in² to about 100 μg/in², or about 0.01 μg/in² to about 90 μg/in², or about 0.01 μg/in² to about 80 μg/in², or about 0.01 μg/in² to about 70 μg/in², or about 0.01 μg/in² to about 60 μg/in², or about 0.01 μg/in² to about 50 μg/in², or about 0.01 μg/in² to about 40 μg/in², or about 0.01 μg/in² to about 30 μg/in², or about 0.01 μg/in² to about 20 μg/in², or about 0.01 μg/in² to about 10 μg/in².

The formulation may be applied to outdoor materials such as, but not limited to, lawns, trees, shrubbery, or flooring to prevent the biting arthropods from resting there. Also, the formulation may be applied to indoor materials or fabrics such as, but not limited to bed nets or mosquito nets. For outdoor and indoor surfaces, the amount of active material can be about 10 mg/m² to about 1000 mg/m², or about 10 mg/m² to about 900 mg/m², or about 10 mg/m² to about 800 mg/m², or about 10 mg/m² to about 700 mg/m², or about 10 mg/m² to about 600 mg/m², or about 10 mg/m² to about 500 mg/m², or about 10 mg/m² to about 400 mg/m², or about 10 mg/m² to about 300 mg/m², or about 10 mg/m² to about 200 mg/m², or about 10 mg/m² to about 100 mg/m², or about 10 mg/m² to about 90 mg/m², or about 10 mg/m² to about 80 mg/m², or about 10 mg/m² to about 70 mg/m², or about 10 mg/m² to about 60 mg/m², or about 10 mg/m² to about 50 mg/m², or about 10 mg/m² to about 40 mg/m², or about 10 mg/m² to about 30 mg/m², or about 10 mg/m² to about 20 mg/m².

The formulations of active repellent ingredients may also be applied to outdoor materials such as, but not limited to, lawns, trees, shrubbery, or flooring to prevent the biting arthropods from resting there.

The formulations described above can be prepared by any convenient means, e.g., by mixing the active compound or active compounds with one or more other carriers or vehicles such as, including but not limited to, those described herein before.

The biting arthropod and especially biting insect, repellent formulations of this disclosure may comprise synergistic formulations of the at least one sensate compound.

Preferred embodiments of this disclosure are described in the following clauses.

1. A biting arthropod control or repellent formulation for the control or repellency of biting arthropods, the formulation comprising at least one sensate compound; wherein the at least one sensate compound is present in an effective amount sufficient to control or repel biting arthropods.

2. The biting arthropod control or repellent formulation of clause 1 wherein the sensate compound is selected from the group consisting of:

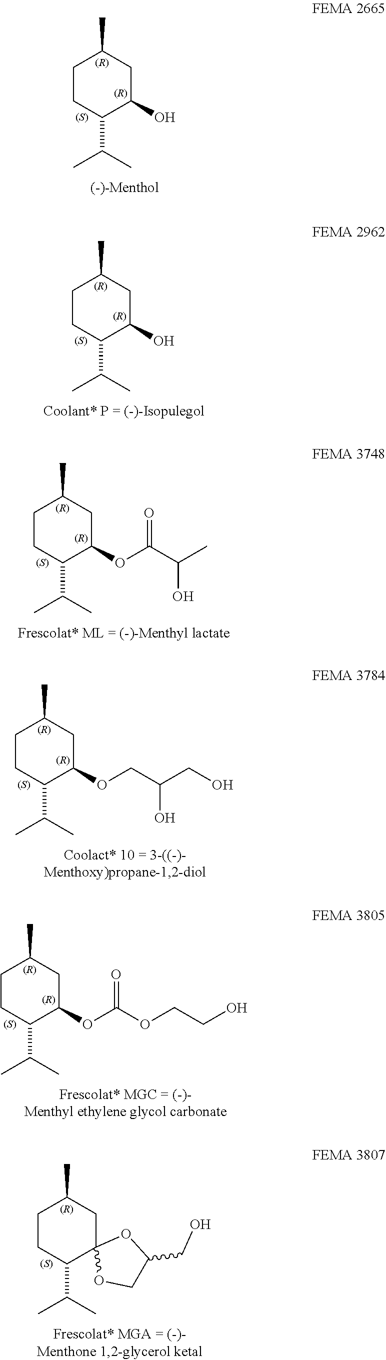

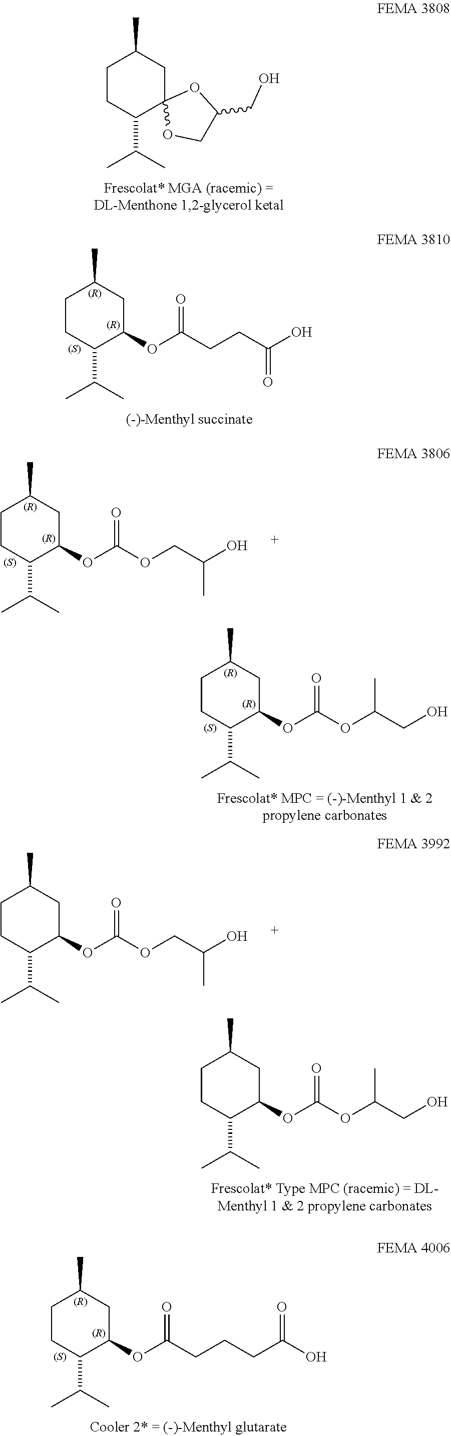

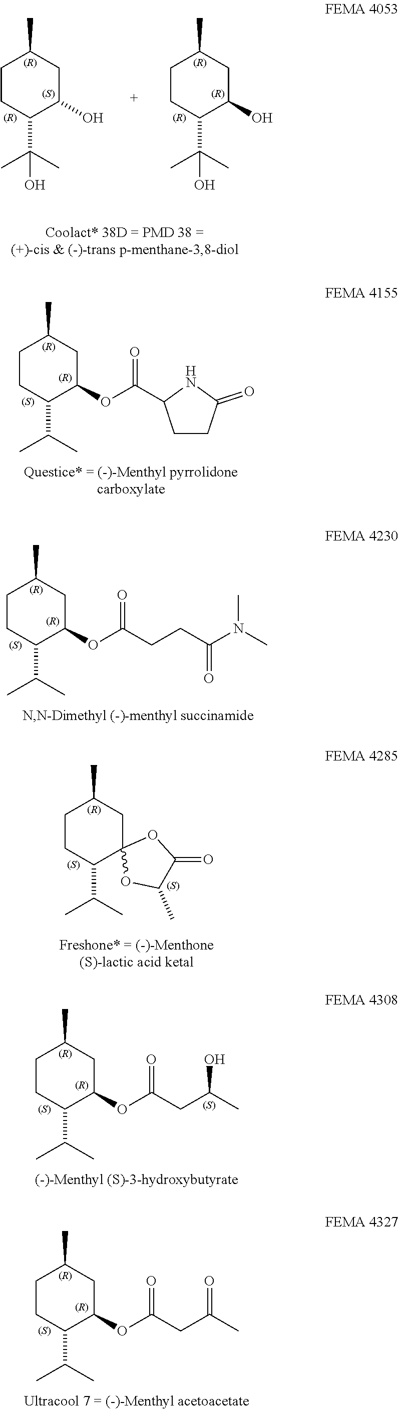

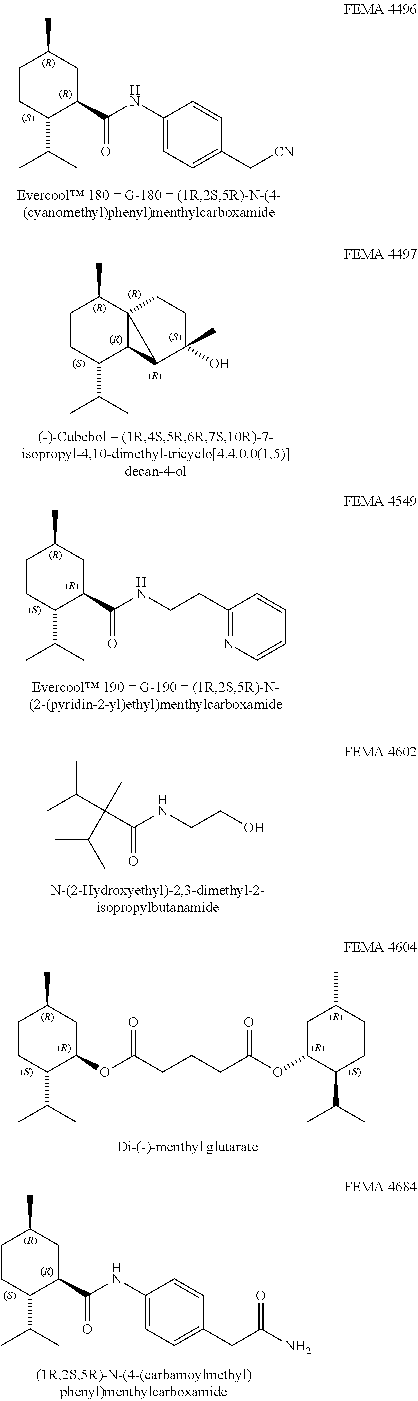

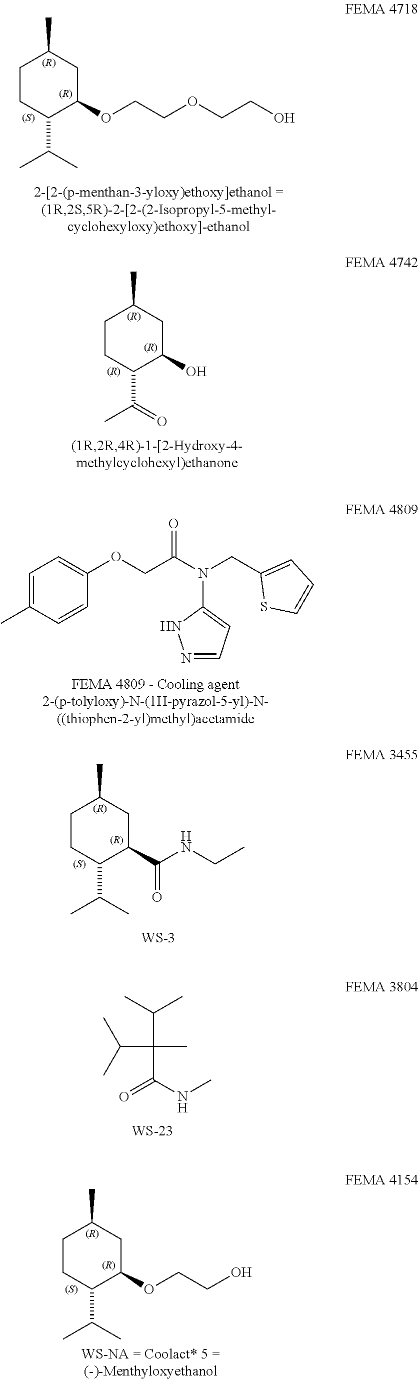

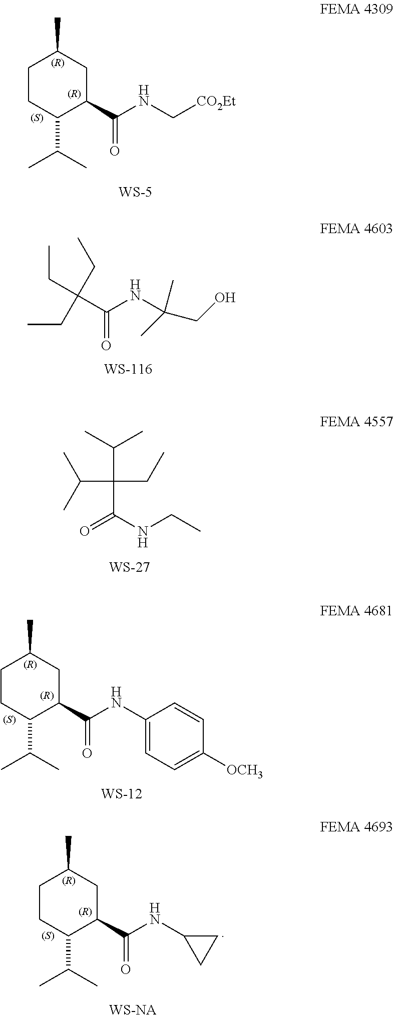

3. The biting arthropod control or repellent formulation of clause 1 wherein the at least one sensate compound is selected from the group consisting of: WS-23 (2-isopropyl-N,2,3-trimethylbutyramide), FEMA 3804; WS-3 (N-ethyl-p-menthane-3-carboxamide), FEMA 3455; WS-5 [ethyl 3-(p-menthane-3-carboxamido)acetate], FEMA 4309; WS-12 (1R,2S,5R)—N-(4-methoxyphenyl)-p-menthanecarboxamide, FEMA 4681; WS-27 (N-ethyl-2,2-diisopropylbutanamide), FEMA 4557; N-cyclopropyl-5-methyl-2-isopropylcyclohexanecarboxamide, FEMA 4693; WS-116 (N-(1,1-dimethyl-2-hydroxyethyl)-2,2-diethylbutanamide), FEMA 4603; menthoxyethanol, FEMA 4154; N-(4-cyanomethylphenyl)-p-menthanecarboxamide, FEMA 4496; N-(2-(pyridin-2-yl)ethyl)-3-p-menthanecarboxamide, FEMA 4549; N-(2-hydroxyethyl)-2-isopropyl-2,3-dimethylbutanamide, FEMA 4602; N-(4-(carbamoylmethyl)phenyl)-menthylcarboxamide, FEMA 4684; (1R,2S,5R)—N-(4-methoxyphenyl)-p-menthanecarboxamide (WS-12), FEMA 4681; (2S,5R)—N-[4-(2-amino-2-oxoethyl)phenyl]-p-menthanecarboxamide, FEMA 4684; N-cyclopropyl-5-methyl-2-isopropylcyclohexanecarbonecarboxamide, FEMA 4693; 2-[(2-p-menthoxy)ethoxy]ethanol, FEMA 4718; 2,6-diethyl-5-isopropyl-2-methyltetrahydropyran, FEMA 4680; a TRPV1 antagonist that inhibits heat sensation and thus enhances cooling agents trans-4-tert-butylcyclohexanol, FEMA 4724; 2-(p-tolyloxy)-N-(1H-pyrazol-5-yl)-N-((thiophen-2-yl)methyl)acetamide, FEMA 4809; racemic N-isopropyl-5-methylcyclohexyl)cyclopropanecarboxamide, FEMA 4558; menthone glycerol ketal, FEMA 3807 and 3748; menthoxypropane-1,2-diolFEMA 3784; N-(2-hydroxyethyl)-2,3-dimethyl-2-isopropylbutyramide, FEMA 4602; N-(1,1-dimethyl-2-hydroxyethyl)2,2-diethylbutanamide, FEMA 4603); 1R,2S,5R)—N-(4-methoxyphenyl)-p-menthanecarboxamide, WS-12, N-cyclopropyl-5-methyl-2-isopropylcyclohexanecarbonecarboxamide, FEMA 4693; (1R,3R,4S)-3-menthyl-3,6-dioxaheptanoate, (1R,2S,5R)-3-menthyl methoxyacetate, (1R,2S,5R)-3-menthyl 3,6,9-trioxadecanoate, (1R,2S,5R)-3-menthyl 3,6,9-trioxadecanoate, (1R,2S,5R)-3-menthyl (2-hydroxyethoxy)acetate & (1R,2S,5R)-menthyl 11-hydroxy-3,6,9-trioxaundecanoate, N-(4-cyanomethylphenyl) p-menthanecarboxamide FEMA 4496; N,N-dimethyl menthyl succinamide (2-isopropyl-5-methylcyclohexyl 4-(dimethylamino)-4-oxobutanoate), FEMA 4230; N-(4-cyanomethylphenyl) p-menthanecarboxamide, FEMA 4496; N-(2-pyridin-2-ylethyl) p-menthanecarboxamide, FEMA 4549; menthyl lactate, FEMA 3748; N-(4-cyanomethylphenyl) p-menthanecarboxamide, FEMA 4496; N-(2-pyridin-2-ylethyl) p-menthanecarboxamide, FEMA 4549; menthyl lactate, FEMA 3748; menthol, WS-3, WS-23 and (−)-menthoxypropane-1,2-diol (TK-10), 6-isopropyl-3,9-dimethyl-1,4-dioxaspiro[4.5]decan-2-one, FEMA 4285; menthane carboxamides, N-benzo[1,3] dioxol-5-yl-3-p-menthanecarboxamide, N-benzooxazol-4-yl-3-p-menthanecarboxamide, N-4-([1,2,4]triazol-1-yl)-phenyl-3-p-menthanecarboxamide & N-4-(pyrazol-1-yl)-phenyl-3-p-menthanecarboxamide, 2,2,5,6,6-pentamethyl-2,3,6,6a-tetrahydropentalen-3a(1H)-ol, 5-(2-hydroxy-2-methylpropyl)-3,4,4-trimethylcyclopent-2-en-1-one, pyridinalkylcyclohexane carboxamides, (1R,2S,5R)-2-isopropyl-5-methyl-N-(2-(pyridin-2-yl)ethyl)cyclohexanecarboxamide, FEMA 4549, (2S,5R)-2-isopropyl-5-methyl-N-(2-(pyridin-4-yl)ethyl)cyclohexanecarboxamide, N-(4-cyanomethylphenyl) p-menthanecarboxamide, FEMA 4496; 1-isopropyl-4-methyl-bicyclo[2.2.2-1oct-5-ene-2,3-dicarbinol, 4-methoxy-N-phenyl-N-[2-(pyridin-2-yl)ethyl]benzamide, 4-methoxy-N-phenyl-N-[2-(pyridin-2-yl)ethyl]benzenesulfonamide, 4-chloro-N-phenyl-N-[2-(pyridin-2-yl)ethyl]benzenesulfonamide, 4-cyano-N-phenyl-N-[2-(pyridin-2-yl)ethyl]benzenesulfonamide, 4-((benzhydrylamino)methyl)-2-methoxyphenol, 4-((bis(4-methoxyphenyl)-methylamino)-methyl)-2-methoxyphenol, 4-((1,2-diphenylethylamino)methyl)-2-methoxyphenol, 4-((benzhydryloxy)methyl)-2-methoxyphenol, 4-((9H-fluoren-9-ylamino)methyl)-2- or 4-((benzhydrylamino)methyl)-2-ethoxyphenol, 1-(4-methoxyphenyl)-2-(1-methyl-1H-benzo[d]imidazol-2-yl)vinyl4-methoxybenzoate, 2-(1-isopropyl-6-methyl-1H-benzo[d]imidazol-2-yl)-1-(4-methoxyphenyl)vinyl4-methoxybenzoate, (Z)-2-(1-isopropyl-5-methyl-1H-benzo[d]imidazol-2-yl)-1-(4-methoxy-phenyl)vinyl-4-methoxybenzoate, N-(1-methyl-1-isopropylbutyl)benzamide, fenchyl, D-bornyl, L-bornyl, exo-norbornyl, 2-methylisobornyl, 2-ethylfenchyl, 2-methylbornyl, cis-pinan-2-yl, verbanyl and isobornyl derivatives, menthyl oxamate derivatives, menthyl 3-oxocarboxylic acid esters, L-menthyl 3-oxobutyrate, L-menthyl 3-oxopentanoate, 3,4-methylenedioxycinnamic acid, N,N-diphenylamide, (1R,2R,4S)-dihydroumbellulol, (1R,2R,5R)—N-ethyl-5-methyl-2-(prop-1-en-2-yl)cyclohexanecarboxamide, 1-[2-hydroxyphenyl]-4-[2-nitrophenyl-]-1,2,3,6-tetrahydropyrimidine-2-one), (2E,6E/Z,8E)-N-(2-methylpropyl)-2,6,8-decatrienamide, FEMA 4668; octadiene amides, octatriene amides, nonadiene amides, nonatriene amides, decadiene amides, decatriene amides, menthone, isopulegol, isopulegone including geometric isomers and non-nitrogen containing derivatives, cubebol, ketals from menthone, fenchol derivatives, bornyl derivatives, N,N-diethyl-m-toluamide, para-menthane-3,8-diol, menthyl pyrrolidone carboxylate, and derivatives of 2-isopropyl-5-methylcyclohexane.

4. The biting arthropod control or repellent formulation of clause 1 further comprising at least one compound (a) selected from the group consisting of:

(1) alkyl ketones and cyclic ketones, saturated or unsaturated, branched or unbranched, containing from about 6 to about 18 carbon atoms, or any range of carbon atoms within said range;

(2) compounds of the structure (A)

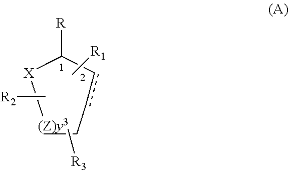

wherein:

R is selected from —OH, ═O, —OC(O)R₄, —OR₆, and —(OR₆)₂, wherein each R₆ is independently selected from an alkyl group containing from about 1 to about 4 carbon atoms and R₄ is a branched or straight chain, saturated or unsaturated, hydrocarbyl group with zero to two double bonds and from about 1 to about 15 carbon atoms;

X is O or CH₂, with the proviso that when X is O, R can only be ═O;

each Z is independently selected from (CH) and (CH₂);

y is a numeral selected from 1 and 2;

R₁ is selected from H or a branched or straight chain, saturated or unsaturated, hydrocarbyl group with zero to two double bonds and from about 1 to about 15 carbon atoms;

R₂ is selected from H and a branched or straight chain, saturated or unsaturated, hydrocarbyl group with zero to three double bonds and from about 1 to about 15 carbon atoms;

R₃ is selected from H, a branched or straight chain, saturated or unsaturated, hydrocarbyl group with zero to three double bonds and from about 1 to about 15 carbon atoms, —(CH₂)ₙOH, —C(O)OR₅, —CH₂C(O)OR₇, —CH₂C(O)R₈, —C(O)NR₉R₁₀, and —CH₂C(O)NR₁₁R₁₂, wherein each of R₅, R₇, R₈, R₉, R₁₀, R₁₁ and R₁₂ is independently selected from H and a branched or straight chain, saturated or unsaturated, hydrocarbyl group with zero to three double bonds and from about 1 to about 15 carbon atoms, and n is n integer of from 1 to 12;

the bond between the 2 and 3 positions in the ring structure may be a single or a double bond; and

wherein the compounds of structure (A) contain from about 11 to about 20 carbon atoms; and includes optical isomers, diastereomers and enantiomers of the compounds of structure (A);

(3) branched or unbranched, straight chain or cyclic, saturated or unsaturated, carboxylic acids containing from about 3 to about 18 carbon atoms or any range of carbon atoms within said range, including isomers thereof; and

(4) esters of branched or unbranched, straight chain or cyclic, saturated or unsaturated, carboxylic acids containing from about 3 to about 18 carbon atoms or any range of carbon atoms within said range, including isomers thereof.

5. The method of clause 1 further comprising at least one compound (a) selected from the group consisting of: geranyl acetone (6,10-dimethyl-5,9-undecadien-2-one), methyl undecyl ketone (2-tridecanone), geranylcyclopentanone (2-(3,7-dimethylocta-2,6-dienyl)cyclopentan-1-one), octenylcyclopentanone (2-(2-octen-1-yl)-cyclopentanone), methyl decyl ketone (2-dodecanone), nootkatone (4,4a-dimethyl-6-prop-1-en-2-yl-3,4,5,6,7,8-hexahydronaphthalen-2-one), alpha-ionone (4-(2,6,6-trimethyl-2-cyclohexenyl)-3-buten-2-one), beta ionone (4-(2,6,6-trimethyl-1-cyclohexenyl)-3-buten-2-one), alpha-isomethylionone (3-methyl-4-(2,6,6-trimethyl-2-cyclohexen-1-yl)-3-buten-2-one), nectaryl (2-(2-(4-methyl-3-cyclohexen-1-yl) propyl) cyclopentanone), isobutylionone ((E)-5-Methyl-1-(2,6,6-trimethyl-1-cyclohex-2-enyl) hex-1-en-3-one), isolongifolen-9-one ((1R)-2,2,7,7-tetramethyltricyclo[6.2.1.01,6] undec-5-en-4-one) dimethylionone ((E)-2-methyl-1-(2,2,6-trimethyl-1-cyclohex-3-enyl)pent-1-en-3-one), isolongifolanone (2,2,7,7-tetramethyltricyclo [6.2.1.01,6]undecan-5-one), pseudoionone (6,10-dimethyl-3,5,9-undecatrien-2-one), 2-cyclopentylcyclopentanone, methyl nonyl ketone, 2-decen2-one and 1-carvone.

6. The method of clause 1 further comprising at least one compound (a) selected from the group consisting of:

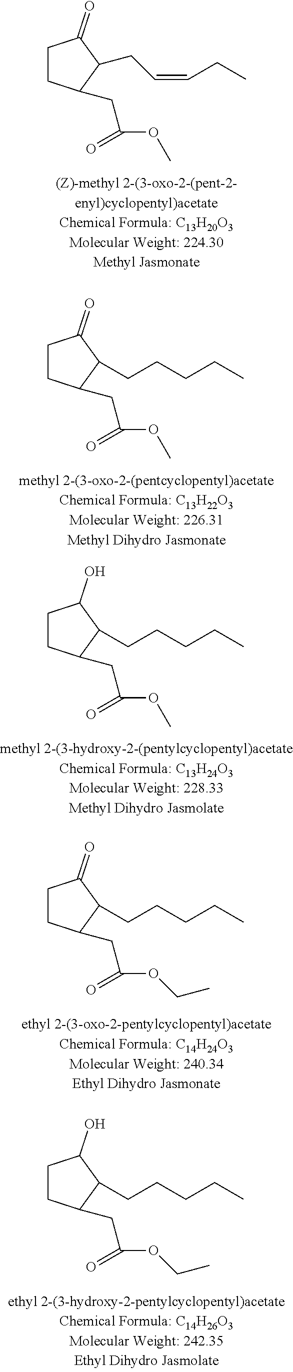 [SMILES: CC/C=C\CC1C(=O)CCC1CC(=O)OC ; CCCCCC1C(=O)CCC1CC(=O)OC ; CCCCCC1C(O)CCC1CC(=O)OC ; CCCCCC1C(=O)CCC1CC(=O)OCC ; CCCCCC1C(O)CCC1CC(=O)OCC]

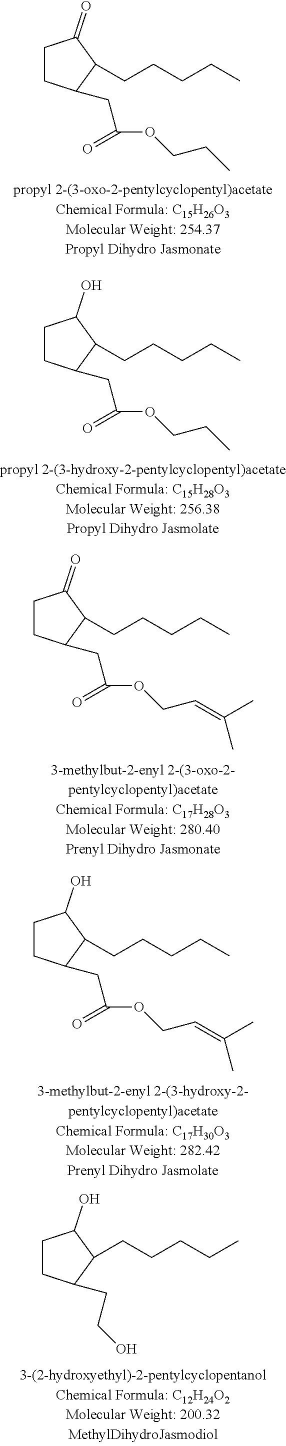 [SMILES: CCCCCC1C(=O)CCC1CC(=O)OCCC ; CCCCCC1C(O)CCC1CC(=O)OCCC ; CCCCCC1C(=O)CCC1CC(=O)OCC=C(C)C ; CCCCCC1C(O)CCC1CC(=O)OCC=C(C)C ; CCCCCC1C(O)CCC1CCO]

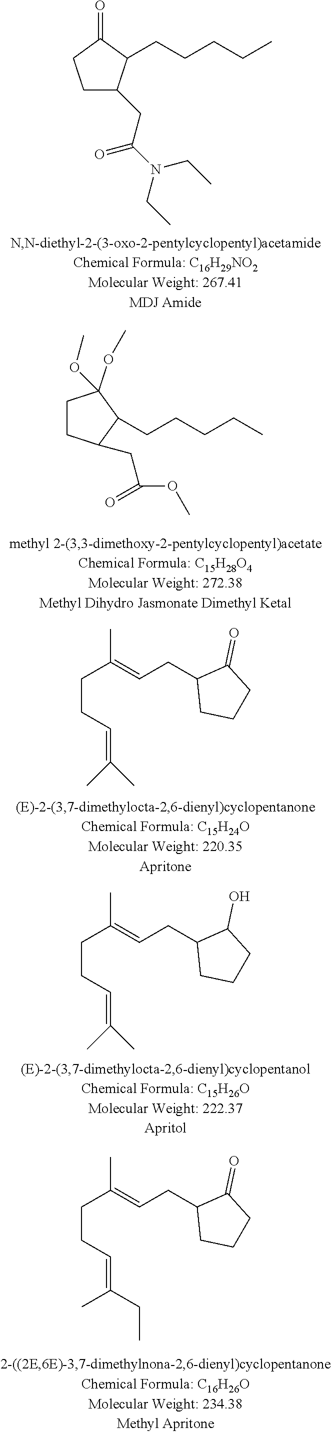 [SMILES: CCCCCC1C(=O)CCC1CC(=O)N(CC)CC ; CCCCCC1C(CC(=O)OC)CCC1(OC)OC ; CC(C)=CCC/C(C)=C/CC1CCCC1=O ; CC(C)=CCC/C(C)=C/CC1CCCC1O ; CC/C(C)=C/CC/C(C)=C/CC1CCCC1=O]

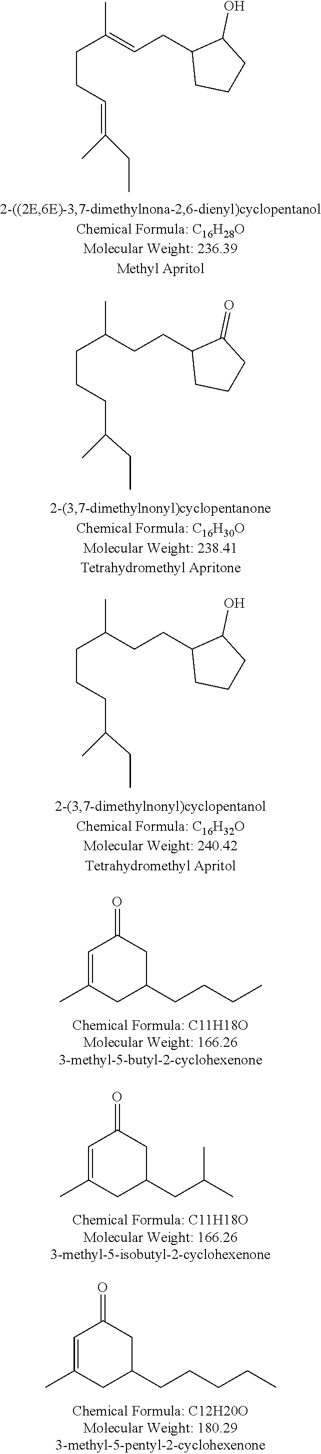

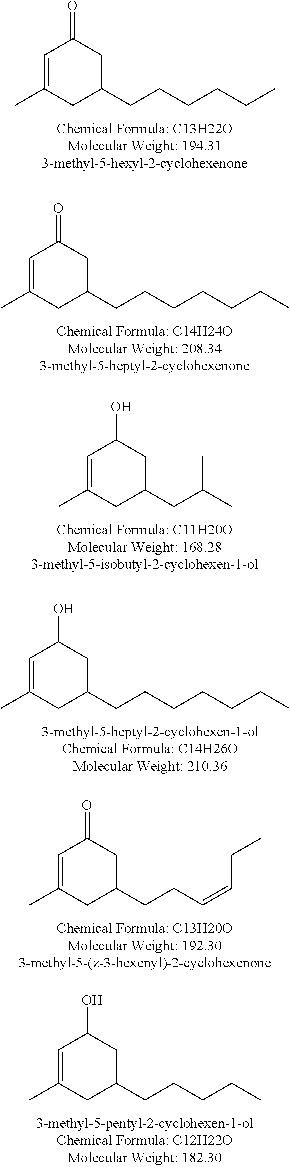

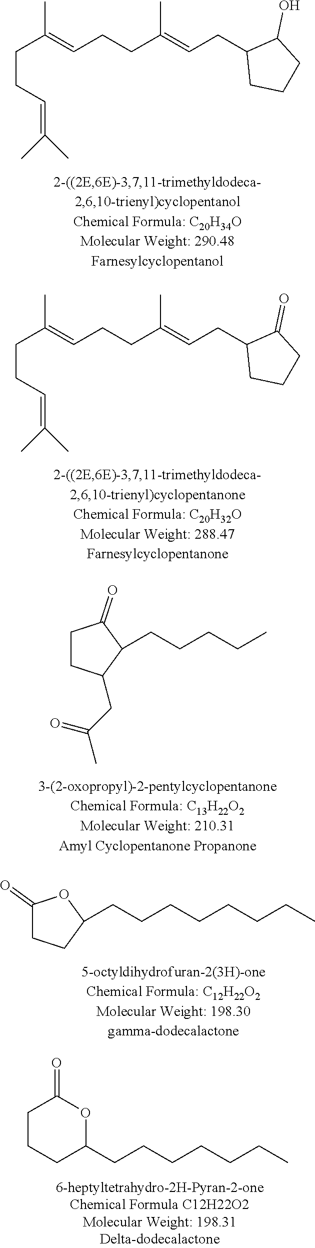 [SMILES: CC(C)=CCC/C(C)=C/CC/C(C)=C/CC1CCCC1O ; CC(C)=CCC/C(C)=C/CC/C(C)=C/CC1CCCC1=O ; CCCCCC1C(=O)CCC1CC(C)=O ; CCCCCCCCC1CCC(=O)O1 ; CCCCCCCC1CCCC(=O)O1]

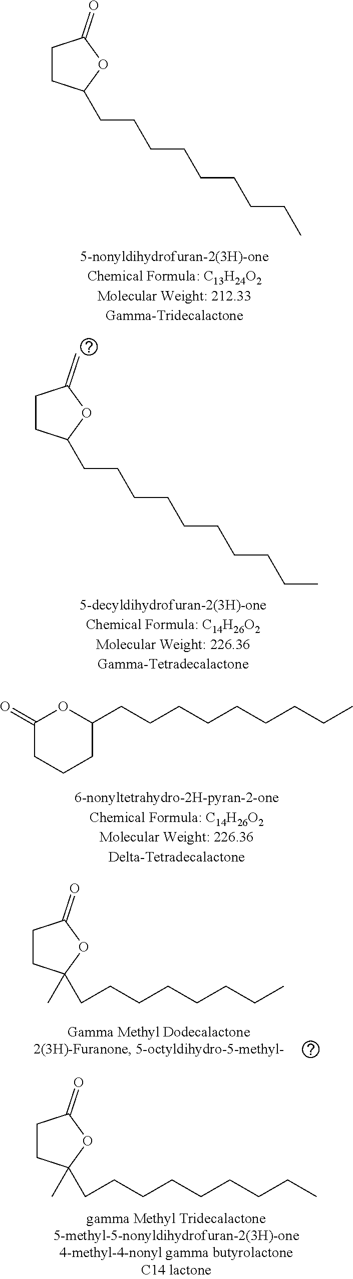 [SMILES: CCCCCCCCCC1CCC(=O)O1 ; C=C1CCC(CCCCCCCCCC)O1 ; CCCCCCCCCC1CCCC(=O)O1 ; CCCCCCCCC1(C)CCC(=O)O1 ; CCCCCCCCCC1(C)CCC(=O)O1]

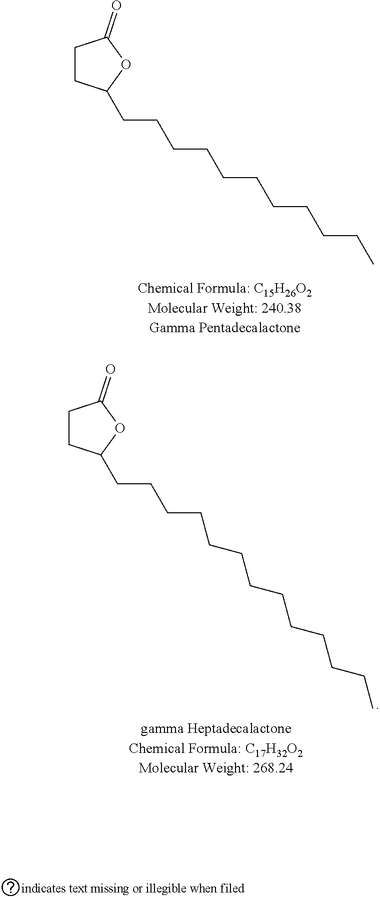 [SMILES: CCCCCCCCCCCC1CCC(=O)O1 ; CCCCCCCCCCCCCC1CCC(=O)O1]

7. The biting arthropod control or repellent formulation of clause 1 wherein the at least one sensate compound is present in an amount from about 0.5 to about 25% by weight.

8. The biting arthropod control or repellent formulation of clause 1 wherein the at least one sensate compound is present in an amount from about 2.5 to about 20% by weight.

9. The biting arthropod control or repellent formulation of clause 1 wherein the at least one sensate compound is present in an amount from about 5 to about 15% by weight.

10. The biting arthropod control or repellent formulation of clause 1 wherein the one or more sensate compounds selected from the group consisting of menthol, menthone, isopulegol, isopulegone including geometric isomers and non-nitrogen containing derivatives, cubebol, ketals from menthone, fenchol derivatives, and bornyl derivatives, are present in an amount from about 0.5 to about 25% by weight.

11. The biting arthropod control or repellent formulation of clause 1 wherein the one or more sensate compounds selected from the group consisting of menthol, menthone, isopulegol, isopulegone including geometric isomers and non-nitrogen containing derivatives, cubebol, ketals from menthone, fenchol derivatives, and bornyl derivatives, are present in an amount from about 2.5 to about 20% by weight.

12. The biting arthropod control or repellent formulation of clause 1 wherein the one or more sensate compounds selected from the group consisting of menthol, menthone, isopulegol, isopulegone including geometric isomers and non-nitrogen containing derivatives, cubebol, ketals from menthone, fenchol derivatives, and bornyl derivatives, are present in an amount from about 5 to about 15% by weight.

13. The biting arthropod control or repellent formulation of clause 1 comprising at least one sensate compound and at least one compound (a).

14. The biting arthropod control or repellent formulation of clause 1 comprising a sensate compound and a compound (a), wherein the sensate compound and the compound (a) are present in an amount from about 0.5 to about 25% by weight, and in a weight ratio of the sensate compound to compound (a) from about 0.1:2 to about 2:0.1.

15. The biting arthropod control or repellent formulation of clause 1 comprising a sensate compound and a compound (a), wherein the sensate compound and the compound (a) are present in an amount from about 2.5 to about 20% by weight, and in a weight ratio of the sensate compound to compound (a) from about 0.2:1 to about 1:0.2.

16. The biting arthropod control or repellent formulation of clause 1 comprising a sensate compound and a compound (a), wherein the sensate compound and the compound (a) are present in an amount from about 5 to about 15% by weight, and in a weight ratio of the sensate compound to compound (a) from about 0.3:1 to about 1:0.3.

17. The biting arthropod control or repellent formulation of clause 1 wherein the biting arthropods are selected from the group consisting of: mosquitoes, bed bugs, biting flies, ticks, ants, fleas, biting midges, and spiders.

18. A method for the control or repellency of biting arthropods, the method comprising bringing the biting arthropods into contact with a biting arthropod control or repellent formulation, wherein the biting arthropod control or repellent formulation comprises at least one sensate compound; wherein the at least one sensate compound is present in an effective amount sufficient to control or repel biting arthropods.

19. The method of clause 18 wherein the at least one sensate compound is selected from those set forth in clause 2.

20. The method of clause 18 wherein the at least one sensate compound is selected from the group consisting of: WS-23 (2-isopropyl-N,2,3-trimethylbutyramide), FEMA 3804; WS-3 (N-ethyl-p-menthane-3-carboxamide), FEMA 3455; WS-5 [ethyl 3-(p-menthane-3-carboxamido)acetate], FEMA 4309; WS-12 (1R,2S,5R)—N-(4-methoxyphenyl)-p-menthanecarboxamide, FEMA 4681; WS-27 (N-ethyl-2,2-diisopropylbutanamide), FEMA 4557; N-cyclopropyl-5-methyl-2-isopropylcyclohexanecarboxamide, FEMA 4693; WS-116 (N-(1,1-dimethyl-2-hydroxyethyl)-2,2-diethylbutanamide), FEMA 4603; menthoxyethanol, FEMA 4154; N-(4-cyanomethylphenyl)-p-menthanecarboxamide, FEMA 4496; N-(2-(pyridin-2-yl)ethyl)-3-p-menthanecarboxamide, FEMA 4549; N-(2-hydroxyethyl)-2-isopropyl-2,3-dimethylbutanamide, FEMA 4602; N-(4-(carbamoylmethyl)phenyl)-menthylcarboxamide, FEMA 4684; (1R,2S,5R)—N-(4-methoxyphenyl)-p-menthanecarboxamide (WS-12), FEMA 4681; (2S,5R)—N-[4-(2-amino-2-oxoethyl)phenyl]-p-menthanecarboxamide, FEMA 4684; N-cyclopropyl-5-methyl-2-isopropylcyclohexanecarbonecarboxamide, FEMA 4693; 2-[(2-p-menthoxy)ethoxy]ethanol, FEMA 4718; 2,6-diethyl-5-isopropyl-2-methyltetrahydropyran, FEMA 4680; a TRPV1 antagonist that inhibits heat sensation and thus enhances cooling agents trans-4-tert-butylcyclohexanol, FEMA 4724; 2-(p-tolyloxy)-N-(1H-pyrazol-5-yl)-N-((thiophen-2-yl)methyl)acetamide, FEMA 4809; racemic N-isopropyl-5-methylcyclohexyl)cyclopropanecarboxamide, FEMA 4558; menthone glycerol ketal, FEMA 3807 and 3748; menthoxypropane-1,2-diolFEMA 3784; N-(2-hydroxyethyl)-2,3-dimethyl-2-isopropylbutyramide, FEMA 4602; N-(1,1-dimethyl-2-hydroxyethyl)2,2-diethylbutanamide, FEMA 4603); 1R,2S,5R)—N-(4-methoxyphenyl)-p-menthanecarboxamide, WS-12, N-cyclopropyl-5-methyl-2-isopropylcyclohexanecarbonecarboxamide, FEMA 4693; (1R,3R,4S)-3-menthyl-3,6-dioxaheptanoate, (1R,2S,5R)-3-menthyl methoxyacetate, (1R,2S,5R)-3-menthyl 3,6,9-trioxadecanoate, (1R,2S,5R)-3-menthyl 3,6,9-trioxadecanoate, (1R,2S,5R)-3-menthyl (2-hydroxyethoxy)acetate & (1R,2S,5R)-menthyl 11-hydroxy-3,6,9-trioxaundecanoate, N-(4-cyanomethylphenyl) p-menthanecarboxamide FEMA 4496; N,N-dimethyl menthyl succinamide (2-isopropyl-5-methylcyclohexyl 4-(dimethylamino)-4-oxobutanoate), FEMA 4230; N-(4-cyanomethylphenyl) p-menthanecarboxamide, FEMA 4496; N-(2-pyridin-2-ylethyl) p-menthanecarboxamide, FEMA 4549; menthyl lactate, FEMA 3748; N-(4-cyanomethylphenyl) p-menthanecarboxamide, FEMA 4496; N-(2-pyridin-2-ylethyl) p-menthanecarboxamide, FEMA 4549; menthyl lactate, FEMA 3748; menthol, WS-3, WS-23 and (−)-menthoxypropane-1,2-diol (TK-10), 6-isopropyl-3,9-dimethyl-1,4-dioxaspiro[4.5]decan-2-one, FEMA 4285; menthane carboxamides, N-benzo[1,3] dioxol-5-yl-3-p-menthanecarboxamide, N-benzooxazol-4-yl-3-p-menthanecarboxamide, N-4-([1,2,4]triazol-1-yl)-phenyl-3-p-menthanecarboxamide & N-4-(pyrazol-1-yl)-phenyl-3-p-menthanecarboxamide, 2,2,5,6,6-pentamethyl-2,3,6,6a-tetrahydropentalen-3a(1H)-ol, 5-(2-hydroxy-2-methylpropyl)-3,4,4-trimethylcyclopent-2-en-1-one, pyridinalkylcyclohexane carboxamides, (1R,2S,5R)-2-isopropyl-5-methyl-N-(2-(pyridin-2-yl)ethyl)cyclohexanecarboxamide, FEMA 4549, (2S,5R)-2-isopropyl-5-methyl-N-(2-(pyridin-4-yl)ethyl)cyclohexanecarboxamide, N-(4-cyanomethylphenyl) p-menthanecarboxamide, FEMA 4496; 1-isopropyl-4-methyl-bicyclo[2.2.2-1oct-5-ene-2,3-dicarbinol, 4-methoxy-N-phenyl-N-[2-(pyridin-2-yl)ethyl]benzamide, 4-methoxy-N-phenyl-N-[2-(pyridin-2-yl)ethyl]benzenesulfonamide, 4-chloro-N-phenyl-N-[2-(pyridin-2-yl)ethyl]benzenesulfonamide, 4-cyano-N-phenyl-N-[2-(pyridin-2-yl)ethyl]benzenesulfonamide, 4-((benzhydrylamino)methyl)-2-methoxyphenol, 4-((bis(4-methoxyphenyl)-methylamino)-methyl)-2-methoxyphenol, 4-((1,2-diphenylethylamino)methyl)-2-methoxyphenol, 4-((benzhydryloxy)methyl)-2-methoxyphenol, 4-((9H-fluoren-9-ylamino)methyl)-2- or 4-((benzhydrylamino)methyl)-2-ethoxyphenol, 1-(4-methoxyphenyl)-2-(1-methyl-1H-benzo[d]imidazol-2-yl)vinyl4-methoxybenzoate, 2-(1-isopropyl-6-methyl-1H-benzo[d]imidazol-2-yl)-1-(4-methoxyphenyl)vinyl4-methoxybenzoate, (Z)-2-(1-isopropyl-5-methyl-1H-benzo[d]imidazol-2-yl)-1-(4-methoxy-phenyl)vinyl-4-methoxybenzoate, N-(1-methyl-1-isopropylbutyl)benzamide, fenchyl, D-bornyl, L-bornyl, exo-norbornyl, 2-methylisobornyl, 2-ethylfenchyl, 2-methylbornyl, cis-pinan-2-yl, verbanyl and isobornyl derivatives, menthyl oxamate derivatives, menthyl 3-oxocarboxylic acid esters, L-menthyl 3-oxobutyrate, L-menthyl 3-oxopentanoate, 3,4-methylenedioxycinnamic acid, N,N-diphenylamide, (1R,2R,4S)-dihydroumbellulol, (1R,2R,5R)—N-ethyl-5-methyl-2-(prop-1-en-2-yl)cyclohexanecarboxamide, 1-[2-hydroxyphenyl]-4-[2-nitrophenyl-]-1,2,3,6-tetrahydropyrimidine-2-one), (2E,6E/Z,8E)-N-(2-methylpropyl)-2,6,8-decatrienamide, FEMA 4668; octadiene amides, octatriene amides, nonadiene amides, nonatriene amides, decadiene amides, decatriene amides, menthone, isopulegol, isopulegone including geometric isomers and non-nitrogen containing derivatives, cubebol, ketals from menthone, fenchol derivatives, bornyl derivatives, N,N-diethyl-m-toluamide, para-menthane-3,8-diol, menthyl pyrrolidone carboxylate, and derivatives of 2-isopropyl-5-methylcyclohexane.

21. The method of clause 18 wherein the biting arthropod control or repellent formulation further comprises at least one compound (a) selected from the group consisting of:

(1) alkyl ketones and cyclic ketones, saturated or unsaturated, branched or unbranched, containing from about 6 to about 18 carbon atoms, or any range of carbon atoms within said range;

(2) compounds of the structure (A)

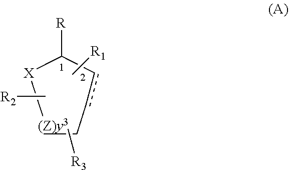

wherein:

R is selected from —OH, ═O, —OC(O)R₄, —OR₆, and —(OR₆)₂, wherein each R₆ is independently selected from an alkyl group containing from about 1 to about 4 carbon atoms and R₄ is a branched or straight chain, saturated or unsaturated, hydrocarbyl group with zero to two double bonds and from about 1 to about 15 carbon atoms;

X is O or CH₂, with the proviso that when X is O, R can only be ═O;

each Z is independently selected from (CH) and (CH₂);

y is a numeral selected from 1 and 2;

R₁ is selected from H or a branched or straight chain, saturated or unsaturated, hydrocarbyl group with zero to two double bonds and from about 1 to about 15 carbon atoms;

R₂ is selected from H and a branched or straight chain, saturated or unsaturated, hydrocarbyl group with zero to three double bonds and from about 1 to about 15 carbon atoms;

R₃ is selected from H, a branched or straight chain, saturated or unsaturated, hydrocarbyl group with zero to three double bonds and from about 1 to about 15 carbon atoms, —(CH₂)ₙOH, —C(O)OR₅, —CH₂C(O)OR₇, —CH₂C(O)R₈, —C(O)NR₉R₁₀, and —CH₂C(O)NR₁₁R₁₂, wherein each of R₅, R₇, R₈, R₉, R₁₀, R₁₁ and R₁₂ is independently selected from H and a branched or straight chain, saturated or unsaturated, hydrocarbyl group with zero to three double bonds and from about 1 to about 15 carbon atoms, and n is n integer of from 1 to 12;

the bond between the 2 and 3 positions in the ring structure may be a single or a double bond; and

wherein the compounds of structure (A) contain from about 11 to about 20 carbon atoms; and includes optical isomers, diastereomers and enantiomers of the compounds of structure (A);

(3) branched or unbranched, straight chain or cyclic, saturated or unsaturated, carboxylic acids containing from about 3 to about 18 carbon atoms or any range of carbon atoms within said range, including isomers thereof; and

(4) esters of branched or unbranched, straight chain or cyclic, saturated or unsaturated, carboxylic acids containing from about 3 to about 18 carbon atoms or any range of carbon atoms within said range, including isomers thereof.

22. The method of clause 18 wherein the biting arthropod control or repellent formulation further comprises at least one compound (a) selected from the group consisting of at least one compound (a) selected from the group consisting of: geranyl acetone (6,10-dimethyl-5,9-undecadien-2-one), methyl undecyl ketone (2-tridecanone), geranylcyclopentanone (2-(3,7-dimethylocta-2,6-dienyl)cyclopentan-1-one), octenylcyclopentanone (2-(2-octen-1-yl)-cyclopentanone), methyl decyl ketone (2-dodecanone), nootkatone (4,4a-dimethyl-6-prop-1-en-2-yl-3,4,5,6,7,8-hexahydronaphthalen-2-one), alpha-ionone (4-(2,6,6-trimethyl-2-cyclohexenyl)-3-buten-2-one), beta ionone (4-(2,6,6-trimethyl-1-cyclohexenyl)-3-buten-2-one), alpha-isomethylionone (3-methyl-4-(2,6,6-trimethyl-2-cyclohexen-1-yl)-3-buten-2-one), nectaryl (2-(2-(4-methyl-3-cyclohexen-1-yl) propyl) cyclopentanone), isobutylionone ((E)-5-Methyl-1-(2,6,6-trimethyl-1-cyclohex-2-enyl) hex-1-en-3-one), isolongifolen-9-one ((1R)-2,2,7,7-tetramethyltricyclo[6.2.1.01,6] undec-5-en-4-one) dimethylionone ((E)-2-methyl-1-(2,2,6-trimethyl-1-cyclohex-3-enyl)pent-1-en-3-one), isolongifolanone (2,2,7,7-tetramethyltricyclo[6.2.1.01,6]undecan-5-one), pseudoionone (6,10-dimethyl-3,5,9-undecatrien-2-one), 2-cyclopentylcyclopentanone, methyl nonyl ketone, 2-decen2-one and 1-carvone.

23. The method of clause 18 wherein the biting arthropod control or repellent formulation further comprises at least one compound (a) selected from those set forth in clause 6.

24. The method of clause 18 wherein the at least one sensate compound is present in an amount from about 0.5 to about 25%.

25. The method of clause 18 wherein the at least one sensate compound is present in an amount from about 2.5 to about 20% by weight.

26. The method of clause 18 wherein the at least one sensate compound is present in an amount from about 5 to about 15% by weight.

27. The method of clause 18 wherein the one or more sensate compounds selected from the group consisting of menthol, menthone, isopulegol, isopulegone including geometric isomers and non-nitrogen containing derivatives, cubebol, ketals from menthone, fenchol derivatives, and bornyl derivatives, are present in an amount from about 0.5 to about 25% by weight.

28. The method of clause 18 wherein the one or more sensate compounds selected from the group consisting of menthol, menthone, isopulegol, isopulegone including geometric isomers and non-nitrogen containing derivatives, cubebol, ketals from menthone, fenchol derivatives, and bornyl derivatives, are present in an amount from about 2.5 to about 20% by weight.

29. The method of clause 18 wherein the one or more sensate compounds selected from the group consisting of menthol, menthone, isopulegol, isopulegone including geometric isomers and non-nitrogen containing derivatives, cubebol, ketals from menthone, fenchol derivatives, and bornyl derivatives, are present in an amount from about 5 to about 15% by weight.

30. The method of clause 18 wherein the biting arthropod control or repellent formulation comprises at least one sensate compound and at least one compound (a).

31. The method of clause 18 wherein the at least one sensate compound and the compound (a) are present in an amount from about 0.5 to about 25% by weight, and in a weight ratio of the sensate compound to compound (a) from about 0.1:2 to about 2:0.1.

32. The method of clause 18 wherein the at least one sensate compound and the compound (a) are present in an amount from about 2.5 to about 20% by weight, and in a weight ratio of the sensate compound to compound (a) from about 0.2:1 to about 1:0.2.

33. The method of clause 18 wherein the at least one sensate compound and the compound (a) are present in an amount from about 5 to about 15% by weight, and in a weight ratio of the sensate compound to compound (a) from about 0.3:1 to about 1:0.3.

34. The method of clause 18 wherein the biting arthropods are selected from the group consisting of: mosquitoes, bed bugs, biting flies, ticks, ants, fleas, biting midges, and spiders.

35. A biting arthropod control or repellent formulation for the control or repellency of biting arthropods, the formulation comprising:

(I) at least one compound (a) selected from the group consisting of:

(1) alkyl ketones and cyclic ketones, saturated or unsaturated, branched or unbranched, containing from about 6 to about 18 carbon atoms, or any range of carbon atoms within said range;

(2) compounds of the structure (A)

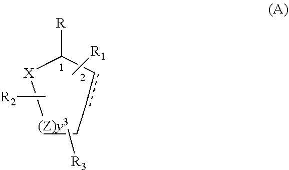

wherein:

R is selected from —OH, ═O, —OC(O)R₄, —OR₆, and —(OR₆)₂, wherein each R₆ is independently selected from an alkyl group containing from about 1 to about 4 carbon atoms and R₄ is a branched or straight chain, saturated or unsaturated, hydrocarbyl group with zero to two double bonds and from about 1 to about 15 carbon atoms;

X is O or CH₂, with the proviso that when X is O, R can only be ═O;

each Z is independently selected from (CH) and (CH₂);

y is a numeral selected from 1 and 2;

R₁ is selected from H or a branched or straight chain, saturated or unsaturated, hydrocarbyl group with zero to two double bonds and from about 1 to about 15 carbon atoms;

R₂ is selected from H and a branched or straight chain, saturated or unsaturated, hydrocarbyl group with zero to three double bonds and from about 1 to about 15 carbon atoms;

R₃ is selected from H, a branched or straight chain, saturated or unsaturated, hydrocarbyl group with zero to three double bonds and from about 1 to about 15 carbon atoms, —(CH₂)ₙOH, —C(O)OR₅, —CH₂C(O)OR₇, —CH₂C(O)R₈, —C(O)NR₉R₁₀, and —CH₂C(O)NR₁₁R₁₂, wherein each of R₅, R₇, R₈, R₉, R₁₀, R₁₁ and R₁₂ is independently selected from H and a branched or straight chain, saturated or unsaturated, hydrocarbyl group with zero to three double bonds and from about 1 to about 15 carbon atoms, and n is n integer of from 1 to 12;

the bond between the 2 and 3 positions in the ring structure may be a single or a double bond; and

wherein the compounds of structure (A) contain from about 11 to about 20 carbon atoms; and includes optical isomers, diastereomers and enantiomers of the compounds of structure (A);

(3) branched or unbranched, straight chain or cyclic, saturated or unsaturated, carboxylic acids containing from about 3 to about 18 carbon atoms or any range of carbon atoms within said range, including isomers thereof; and

(4) esters of branched or unbranched, straight chain or cyclic, saturated or unsaturated, carboxylic acids containing from about 3 to about 18 carbon atoms or any range of carbon atoms within said range, including isomers thereof; and

(II) at least one sensate compound.

36. The biting arthropod control or repellent formulation of clause 35 wherein the alkyl and cyclic ketones of compound (a) comprise geranyl acetone (6,10-dimethyl-5,9-undecadien-2-one), farnesyl acetone (5,9,13-pentadecatrien-2-one), 6,10,14-trimethyl-)methyl undecyl ketone (2-tridecanone), methyl decyl ketone (2-dodecanone), alpha-ionone (4-(2,6,6-trimethyl-2-cyclohexenyl)-3-buten-2-one), beta ionone (4-(2,6,6-trimethyl-1-cyclohexenyl)-3-buten-2-one), alpha-isomethylionone (3-methyl-4-(2,6,6-trimethyl-2-cyclohexen-1-yl)-3-buten-2-one), isobutylionone ((E)-5-methyl-1-(2,6,6-trimethyl-1-cyclohex-2-enyl) hex-1-en-3-one), isolongifolen-9-one ((1R)-2,2,7,7-tetramethyltricyclo[6.2.1.01,6] undec-5-en-4-one), dimethylionone ((E)-2-methyl-1-(2,2,6-trimethyl-1-cyclohex-3-enyl)pent-1-en-3-one), isolongifolanone (2,2,7,7-tetramethyltricyclo[6.2.1.01,6]undecan-5-one), pseudoionone (6,10-dimethyl-3,5,9-undecatrien-2-one), 2-cyclopentylcyclopentanone, methyl nonyl ketone (2-undecanone), and 3-decen-2-one.

37. The biting arthropod control or repellent formulation of clause 35 wherein the alkyl and cyclic ketones of compound (a) comprise methyl decyl ketone, methyl undecyl ketone, methyl nonyl ketone, geranyl acetone, farnesyl acetone, ionone, and isolongifolenone.

38. The biting arthropod control or repellent formulation of clause 35 wherein compounds of structure (A) of the at least one compound (a) comprise a compound wherein R is ═O or —OH, X is CH₂, Z is (CH) or (CH₂), y is 1, the bond between positions 2 and 3 is a single bond, R₁ is H, R₂ is H, and R₃ is an alkenyl group having at least 11 carbon atoms and 1 or 2 double bonds.

39. The biting arthropod control or repellent formulation of clause 35 wherein compounds of structure (A) of the at least one compound (a) comprise a compound wherein R is ═O or —OH, X is CH₂, Z is (CH) or (CH₂), y is 1, the bond between positions 2 and 3 is a single bond, R₁ is an alkyl group having at least 5 carbon atoms, R₂ is H, and R₃ is —C(O)OR₅, and R₅ is an alkyl or alkenyl group containing at least 3 carbon atoms.

40. The biting arthropod control or repellent formulation of clause 35 wherein compounds of structure (A) of the at least one compound (a) comprise a compound wherein R is ═O, X is O, Z is CH or CH₂, y is 1 or 2, the bond between positions 2 and 3 is a single bond, R₁ is an alkyl group of from 7 to 11 carbon atoms, R₂ is H, and R₃ is H or CH₃.

41. The biting arthropod control or repellent formulation of clause 35 wherein compounds of structure (A) of the at least one compound (a) are selected from those set forth in clause 6.

42. The biting arthropod control or repellent formulation of clause 35 wherein the compounds of structure (A) of compounds (a) are selected from the group consisting of: methyl apritone, methyl dihydrojasmonate, propyl dihydrojasmonate, gamma-dodecalactone, delta-dodecalactone, gamma-tridecalactone, gamma-tetradecalactone, gamma methyl dodecalactone, gamma methyl tridecalactone, 3-methyl-5-pentyl-2-cyclohexenone, 3-methyl-5-pentyl-2-cyclohexenol, 3-methyl-5-hexyl-2-cyclohexenone, and 3-methyl-5-heptyl-2-cyclohexenone.

43. The biting arthropod control or repellent formulation of clause 35 wherein the carboxylic acids of compounds (a) comprise lactic acid, salicylic acid, geranic acid, citronellic acid, 3-methyl-2-decenoic acid, and any isomers thereof.

44. The biting arthropod control or repellent formulation of clause 35 wherein the carboxylic acids of compounds (a) comprise lactic acid and isomers thereof.

45. The biting arthropod control or repellent formulation of clause 35 wherein the esters of carboxylic acids of compounds (a) comprise methyl lactate, ethyl lactate, propyl lactate, butyl lactate, amyl lactate, isoamyl lactate, hexyl lactate, cis-3-hexenyl lactate, methyl geranate, ethyl geranate, isoamyl geranate, methyl citronellate, ethyl citronellate, methyl salicylate, ethyl salicylate, amyl salicylate, isoamyl salicylate, hexyl salicylate, cis-3-hexenyl salicylate, and any isomers thereof.

46. The biting arthropod control or repellent formulation of clause 35 wherein the esters of carboxylic acids of compounds (a) comprise esters of salicylic acid and any isomers thereof.

47. The biting arthropod control or repellent formulation of clause 35 wherein the sensate compound is selected from those set forth in clause 2.

48. The biting arthropod control or repellent formulation of clause 35 wherein the at least one sensate compound is selected from the group consisting of: WS-23 (2-isopropyl-N,2,3-trimethylbutyramide), FEMA 3804; WS-3 (N-ethyl-p-menthane-3-carboxamide), FEMA 3455; WS-5 [ethyl 3-(p-menthane-3-carboxamido)acetate], FEMA 4309; WS-12 (1R,2S,5R)—N-(4-methoxyphenyl)-p-menthanecarboxamide, FEMA 4681; WS-27 (N-ethyl-2,2-diisopropylbutanamide), FEMA 4557; N-cyclopropyl-5-methyl-2-isopropylcyclohexanecarboxamide, FEMA 4693; WS-116 (N-(1,1-dimethyl-2-hydroxyethyl)-2,2-diethylbutanamide), FEMA 4603; menthoxyethanol, FEMA 4154; N-(4-cyanomethylphenyl)-p-menthanecarboxamide, FEMA 4496; N-(2-(pyridin-2-yl)ethyl)-3-p-menthanecarboxamide, FEMA 4549; N-(2-hydroxyethyl)-2-isopropyl-2,3-dimethylbutanamide, FEMA 4602; N-(4-(carbamoylmethyl)phenyl)-menthylcarboxamide, FEMA 4684; (1R,2S,5R)—N-(4-methoxyphenyl)-p-menthanecarboxamide (WS-12), FEMA 4681; (2S,5R)—N-[4-(2-amino-2-oxoethyl)phenyl]-p-menthanecarboxamide, FEMA 4684; N-cyclopropyl-5-methyl-2-isopropylcyclohexanecarbonecarboxamide, FEMA 4693; 2-[(2-p-menthoxy)ethoxy]ethanol, FEMA 4718; 2,6-diethyl-5-isopropyl-2-methyltetrahydropyran, FEMA 4680; a TRPV1 antagonist that inhibits heat sensation and thus enhances cooling agents trans-4-tert-butylcyclohexanol, FEMA 4724; 2-(p-tolyloxy)-N-(1H-pyrazol-5-yl)-N-((thiophen-2-yl)methyl)acetamide, FEMA 4809; racemic N-isopropyl-5-methylcyclohexyl)cyclopropanecarboxamide, FEMA 4558; menthone glycerol ketal, FEMA 3807 and 3748; menthoxypropane-1,2-diolFEMA 3784; N-(2-hydroxyethyl)-2,3-dimethyl-2-isopropylbutyramide, FEMA 4602; N-(1,1-dimethyl-2-hydroxyethyl)2,2-diethylbutanamide, FEMA 4603); 1R,2S,5R)—N-(4-methoxyphenyl)-p-menthanecarboxamide, WS-12, N-cyclopropyl-5-methyl-2-isopropylcyclohexanecarbonecarboxamide, FEMA 4693; (1R,3R,4S)-3-menthyl-3,6-dioxaheptanoate, (1R,2S,5R)-3-menthyl methoxyacetate, (1R,2S,5R)-3-menthyl 3,6,9-trioxadecanoate, (1R,2S,5R)-3-menthyl 3,6,9-trioxadecanoate, (1R,2S,5R)-3-menthyl (2-hydroxyethoxy)acetate & (1R,2S,5R)-menthyl 11-hydroxy-3,6,9-trioxaundecanoate, N-(4-cyanomethylphenyl) p-menthanecarboxamide FEMA 4496; N,N-dimethyl menthyl succinamide (2-isopropyl-5-methylcyclohexyl 4-(dimethylamino)-4-oxobutanoate), FEMA 4230; N-(4-cyanomethylphenyl) p-menthanecarboxamide, FEMA 4496; N-(2-pyridin-2-ylethyl) p-menthanecarboxamide, FEMA 4549; menthyl lactate, FEMA 3748; N-(4-cyanomethylphenyl) p-menthanecarboxamide, FEMA 4496; N-(2-pyridin-2-ylethyl) p-menthanecarboxamide, FEMA 4549; menthyl lactate, FEMA 3748; menthol, WS-3, WS-23 and (−)-menthoxypropane-1,2-diol (TK-10), 6-isopropyl-3,9-dimethyl-1,4-dioxaspiro[4.5]decan-2-one, FEMA 4285; menthane carboxamides, N-benzo[1,3] dioxol-5-yl-3-p-menthanecarboxamide, N-benzooxazol-4-yl-3-p-menthanecarboxamide, N-4-([1,2,4]triazol-1-yl)-phenyl-3-p-menthanecarboxamide & N-4-(pyrazol-1-yl)-phenyl-3-p-menthanecarboxamide, 2,2,5,6,6-pentamethyl-2,3,6,6a-tetrahydropentalen-3a(1H)-ol, 5-(2-hydroxy-2-methylpropyl)-3,4,4-trimethylcyclopent-2-en-1-one, pyridinalkylcyclohexane carboxamides, (1R,2S,5R)-2-isopropyl-5-methyl-N-(2-(pyridin-2-yl)ethyl)cyclohexanecarboxamide, FEMA 4549, (2S,5R)-2-isopropyl-5-methyl-N-(2-(pyridin-4-yl)ethyl)cyclohexanecarboxamide, N-(4-cyanomethylphenyl) p-menthanecarboxamide, FEMA 4496; 1-isopropyl-4-methyl-bicyclo[2.2.2-1oct-5-ene-2,3-dicarbinol, 4-methoxy-N-phenyl-N-[2-(pyridin-2-yl)ethyl]benzamide, 4-methoxy-N-phenyl-N-[2-(pyridin-2-yl)ethyl]benzenesulfonamide, 4-chloro-N-phenyl-N-[2-(pyridin-2-yl)ethyl]benzenesulfonamide, 4-cyano-N-phenyl-N-[2-(pyridin-2-yl)ethyl]benzenesulfonamide, 4-((benzhydrylamino)methyl)-2-methoxyphenol, 4-((bis(4-methoxyphenyl)-methylamino)-methyl)-2-methoxyphenol, 4-((1,2-diphenylethylamino)methyl)-2-methoxyphenol, 4-((benzhydryloxy)methyl)-2-methoxyphenol, 4-((9H-fluoren-9-ylamino)methyl)-2- or 4-((benzhydrylamino)methyl)-2-ethoxyphenol, 1-(4-methoxyphenyl)-2-(1-methyl-1H-benzo[d]imidazol-2-yl)vinyl4-methoxybenzoate, 2-(1-isopropyl-6-methyl-1H-benzo[d]imidazol-2-yl)-1-(4-methoxyphenyl)vinyl4-methoxybenzoate, (Z)-2-(1-isopropyl-5-methyl-1H-benzo[d]imidazol-2-yl)-1-(4-methoxy-phenyl)vinyl-4-methoxybenzoate, N-(1-methyl-1-isopropylbutyl)benzamide, fenchyl, D-bornyl, L-bornyl, exo-norbornyl, 2-methylisobornyl, 2-ethylfenchyl, 2-methylbornyl, cis-pinan-2-yl, verbanyl and isobornyl derivatives, menthyl oxamate derivatives, menthyl 3-oxocarboxylic acid esters, L-menthyl 3-oxobutyrate, L-menthyl 3-oxopentanoate, 3,4-methylenedioxycinnamic acid, N,N-diphenylamide, (1R,2R,4S)-dihydroumbellulol, (1R,2R,5R)—N-ethyl-5-methyl-2-(prop-1-en-2-yl)cyclohexanecarboxamide, 1-[2-hydroxyphenyl]-4-[2-nitrophenyl-]-1,2,3,6-tetrahydropyrimidine-2-one), (2E,6E/Z,8E)-N-(2-methylpropyl)-2,6,8-decatrienamide, FEMA 4668; octadiene amides, octatriene amides, nonadiene amides, nonatriene amides, decadiene amides, decatriene amides, menthone, isopulegol, isopulegone including geometric isomers and non-nitrogen containing derivatives, cubebol, ketals from menthone, fenchol derivatives, bornyl derivatives, N,N-diethyl-m-toluamide, para-menthane-3,8-diol, menthyl pyrrolidone carboxylate, and derivatives of 2-isopropyl-5-methylcyclohexane.

49. The biting arthropod control or repellent formulation of clause 35 comprising at least one compound (a) selected from the group consisting of: geranylacetone (6,10-dimethyl-5,9-undecadien-2-one), methyl undecyl ketone (2-tridecanone), geranylcyclopentanone (2-(3,7-dimethylocta-2,6-dienyl)cyclopentan-1-one), octenylcyclopentanone (2-(2-octen-1-yl)-cyclopentanone), methyl decyl ketone (2-dodecanone), nootkatone (4,4a-dimethyl-6-prop-1-en-2-yl-3,4,5,6,7,8-hexahydronaphthalen-2-one), alpha-ionone (4-(2,6,6-trimethyl-2-cyclohexenyl)-3-buten-2-one), beta ionone (4-(2,6,6-trimethyl-1-cyclohexenyl)-3-buten-2-one), alpha-isomethylionone (3-methyl-4-(2,6,6-trimethyl-2-cyclohexen-1-yl)-3-buten-2-one), nectaryl (2-(2-(4-methyl-3-cyclohexen-1-yl) propyl) cyclopentanone), isobutylionone ((E)-5-Methyl-1-(2,6,6-trimethyl-1-cyclohex-2-enyl) hex-1-en-3-one), isolongifolen-9-one ((1R)-2,2,7,7-tetramethyltricyclo[6.2.1.01,6] undec-5-en-4-one) dimethylionone ((E)-2-methyl-1-(2,2,6-trimethyl-1-cyclohex-3-enyl)pent-1-en-3-one), isolongifolanone (2,2,7,7-tetramethyltricyclo[6.2.1.01,6]undecan-5-one), pseudoionone (6,10-dimethyl-3,5,9-undecatrien-2-one), 2-cyclopentylcyclopentanone, methyl nonyl ketone, 2-decen2-one and 1-carvone; and at least one sensate compound selected from the group consisting of menthol, menthone, isopulegol, isopulegone including geometric isomers and non-nitrogen containing derivatives, cubebol, ketals from menthone, fenchol derivatives, bornyl derivatives, menthyl pyrrolidone carboxylate, and 2-isopropyl-5-methylcyclohexane derivatives.

50. The biting arthropod control or repellent formulation of clause 35 comprising at least one compound (a) selected from the group consisting of: octenyl cyclopentanone, geranyl cyclopentanone, methyl decyl ketone, methyl undecyl ketone, geranylacetone, ionone, isolongifolenone and nootkatone; and at least one sensate compound selected from the group consisting of menthol, menthone, isopulegol, isopulegone including geometric isomers and non-nitrogen containing derivatives, cubebol, ketals from menthone, fenchol derivatives, bornyl derivatives, and menthyl pyrrolidone carboxylate.

51. The biting arthropod control or repellent formulation of clause 35 wherein the amount of the at least one compound (a) and at least one sensate compound in an effective dose required to repel about 100% of a biting arthropod is less than the amount of the at least one compound (a) alone in an effective dose required to repel about 100% of the biting arthropod.

52. The biting arthropod control or repellent formulation of clause 35 wherein the at least one compound (a) and the at least one sensate compound are present in an amount from about 0.5 to about 25% by weight, and in a weight ratio of the at least one compound (a) to the at least one sensate compound from about 0.1:2 to about 2:0.1.

53. The biting arthropod control or repellent formulation of clause 35 wherein the at least one compound (a) and the at least one sensate compound are present in an amount from about 2.5 to about 20% by weight, and in a weight ratio of the at least one compound (a) to the at least one sensate compound from about 0.2:1 to about 1:0.2.

54. The biting arthropod control or repellent formulation of clause 35 wherein the at least one compound (a) and the at least one sensate compound are present in an amount from about 5 to about 15% by weight, and in a weight ratio of the at least one compound (a) to the at least one sensate compound from about 0.3:1 to about 1:0.3.

55. The biting arthropod control or repellent formulation of clause 35 wherein the amount of the one or more compounds (a) selected from the group consisting of octenyl cyclopentanone, geranyl cyclopentanone, methyl decyl ketone, methyl undecyl ketone, geranyl acetone, ionone, isolongifolenone, and nootkatone, and the one or more sensate compounds selected from the group consisting of menthol, menthone, isopulegol, isopulegone including geometric isomers and non-nitrogen containing derivatives, cubebol, ketals from menthone, fenchol derivatives, and bornyl derivatives, in an effective dose required to repel about 100% of a biting arthropod is less than the amount of the one or more compounds (a) alone in an effective dose required to repel about 100% of the biting arthropod.

56. The biting arthropod control or repellent formulation of clause 35 wherein the one or more compounds (a) selected from the group consisting of octenyl cyclopentanone, geranyl cyclopentanone, methyl decyl ketone, methyl undecyl ketone, geranyl acetone, ionone, isolongifolenone, and nootkatone, and the one or more sensate compounds selected from the group consisting of menthol, menthone, isopulegol, isopulegone including geometric isomers and non-nitrogen containing derivatives, cubebol, ketals from menthone, fenchol derivatives, and bornyl derivatives, are present in an amount from about 0.5 to about 25% by weight, and in a weight ratio of the one or more compounds (a) to the one or more sensate compounds from about 0.1:2 to about 2:0.1.

57. The biting arthropod control or repellent formulation of clause 35 wherein the one or more compounds (a) selected from the group consisting of octenyl cyclopentanone, geranyl cyclopentanone, methyl decyl ketone, methyl undecyl ketone, geranyl acetone, ionone, isolongifolenone, and nootkatone, and the one or more sensate compounds selected from the group consisting of menthol, menthone, isopulegol, isopulegone including geometric isomers and non-nitrogen containing derivatives, cubebol, ketals from menthone, fenchol derivatives, and bornyl derivatives, are present in an amount from about 2.5 to about 20% by weight, and in a weight ratio of the one or more compounds (a) to the one or more sensate compounds from about 0.2:1 to about 1:0.2.

58. The biting arthropod control or repellent formulation of clause 35 wherein the one or more compounds (a) selected from the group consisting of octenyl cyclopentanone, geranyl cyclopentanone, methyl decyl ketone, methyl undecyl ketone, geranyl acetone, ionone, isolongifolenone, and nootkatone, and the one or more sensate compounds selected from the group consisting of menthol, menthone, isopulegol, isopulegone including geometric isomers and non-nitrogen containing derivatives, cubebol, ketals from menthone, fenchol derivatives, and bornyl derivatives, are present in an amount from about 5 to about 15% by weight, and in a weight ratio of the one or more compounds (a) to the one or more sensate compounds from about 0.3:1 to about 1:0.3.

59. The biting arthropod control or repellent formulation of clause 35 wherein the biting arthropods are selected from the group consisting of: mosquitoes, bed bugs, biting flies, ticks, ants, fleas, biting midges, and spiders.

60. A method for the control or repellency of biting arthropods, the method comprising bringing the biting arthropods into contact with a biting arthropod control or repellent formulation, wherein the biting arthropod control or repellent formulation comprises:

(I) at least one compound (a) selected from the group consisting of:

(1) alkyl ketones and cyclic ketones, saturated or unsaturated, branched or unbranched, containing from about 6 to about 18 carbon atoms, or any range of carbon atoms within said range;

(2) compounds of the structure (A)

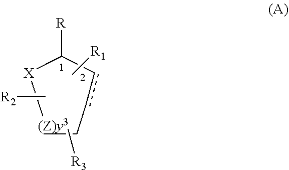

wherein:

R is selected from —OH, ═O, —OC(O)R₄, —OR₆, and —(OR₆)₂, wherein each R₆ is independently selected from an alkyl group containing from about 1 to about 4 carbon atoms and R₄ is a branched or straight chain, saturated or unsaturated, hydrocarbyl group with zero to two double bonds and from about 1 to about 15 carbon atoms;

X is O or CH₂, with the proviso that when X is O, R can only be ═O;

each Z is independently selected from (CH) and (CH₂);

y is a numeral selected from 1 and 2;

R₁ is selected from H or a branched or straight chain, saturated or unsaturated, hydrocarbyl group with zero to two double bonds and from about 1 to about 15 carbon atoms;

R₂ is selected from H and a branched or straight chain, saturated or unsaturated, hydrocarbyl group with zero to three double bonds and from about 1 to about 15 carbon atoms;

R₃ is selected from H, a branched or straight chain, saturated or unsaturated, hydrocarbyl group with zero to three double bonds and from about 1 to about 15 carbon atoms, —(CH₂)ₙOH, —C(O)OR₅, —CH₂C(O)OR₇, —CH₂C(O)R₈, —C(O)NR₉R₁₀, and —CH₂C(O)NR₁₁R₁₂, wherein each of R₅, R₇, R₈, R₉, R₁₀, R₁₁ and R₁₂ is independently selected from H and a branched or straight chain, saturated or unsaturated, hydrocarbyl group with zero to three double bonds and from about 1 to about 15 carbon atoms, and n is n integer of from 1 to 12;

the bond between the 2 and 3 positions in the ring structure may be a single or a double bond; and

wherein the compounds of structure (A) contain from about 11 to about 20 carbon atoms; and includes optical isomers, diastereomers and enantiomers of the compounds of structure (A);

(3) branched or unbranched, straight chain or cyclic, saturated or unsaturated, carboxylic acids containing from about 3 to about 18 carbon atoms or any range of carbon atoms within said range, including isomers thereof; and

(4) esters of branched or unbranched, straight chain or cyclic, saturated or unsaturated, carboxylic acids containing from about 3 to about 18 carbon atoms or any range of carbon atoms within said range, including isomers thereof; and

(II) at least one sensate compound.

61. The method of clause 60 wherein the alkyl and cyclic ketones of compound (a) comprise geranyl acetone (6,10-dimethyl-5,9-undecadien-2-one), farnesyl acetone (5,9,13-pentadecatrien-2-one), 6,10,14-trimethyl-)methyl undecyl ketone (2-tridecanone), methyl decyl ketone (2-dodecanone), alpha-ionone (4-(2,6,6-trimethyl-2-cyclohexenyl)-3-buten-2-one), beta ionone (4-(2,6,6-trimethyl-1-cyclohexenyl)-3-buten-2-one), alpha-isomethylionone (3-methyl-4-(2,6,6-trimethyl-2-cyclohexen-1-yl)-3-buten-2-one), isobutylionone ((E)-5-methyl-1-(2,6,6-trimethyl-1-cyclohex-2-enyl) hex-1-en-3-one), isolongifolen-9-one ((1R)-2,2,7,7-tetramethyltricyclo[6.2.1.01,6] undec-5-en-4-one), dimethylionone ((E)-2-methyl-1-(2,2,6-trimethyl-1-cyclohex-3-enyl)pent-1-en-3-one), isolongifolanone (2,2,7,7-tetramethyltricyclo[6.2.1.01,6]undecan-5-one), pseudoionone (6,10-dimethyl-3,5,9-undecatrien-2-one), 2-cyclopentylcyclopentanone, methyl nonyl ketone (2-undecanone), and 3-decen-2-one.

62. The method of clause 60 wherein the alkyl and cyclic ketones of compound (a) comprise methyl decyl ketone, methyl undecyl ketone, methyl nonyl ketone, geranyl acetone, farnesyl acetone, ionone, and isolongifolenone.

63. The method according to clause 60 wherein compounds of structure (A) of the at least one compound (a) comprise a compound wherein R is ═O or —OH, X is CH₂, Z is (CH) or (CH₂), y is 1, the bond between positions 2 and 3 is a single bond, R₁ is H, R₂ is H, and R₃ is an alkenyl group having at least 11 carbon atoms and 1 or 2 double bonds.

64. The method according to clause 60 wherein compounds of structure (A) of the at least one compound (a) comprise a compound wherein R is ═O or —OH, X is CH₂, Z is (CH) or (CH₂), y is 1, the bond between positions 2 and 3 is a single bond, R₁ is an alkyl group having at least 5 carbon atoms, R₂ is H, and R₃ is —C(O)OR₅, and R₅ is an alkyl or alkenyl group containing at least 3 carbon atoms.

65. The method of clause 60 wherein compounds of structure (A) of the at least one compound (a) comprise a compound wherein R is ═O, X is O, Z is CH or CH₂, y is 1 or 2, the bond between positions 2 and 3 is a single bond, R₁ is an alkyl group of from 7 to 11 carbon atoms, R₂ is H, and R₃ is H or CH₃.

66. The method of clause 60 wherein compounds of structure (A) of the at least one compound (a) are selected from those set forth in clause 6.

67. The method of clause 60 wherein compounds of structure (A) of the at least one compound (a) are selected from the group consisting of: methyl apritone, methyl dihydrojasmonate, propyl dihydrojasmonate, gamma-dodecalactone, delta-dodecalactone, gamma-tridecalactone, gamma-tetradecalactone, gamma methyl dodecalactone, gamma methyl tridecalactone, 3-methyl-5-pentyl-2-cyclohexenone, 3-methyl-5-pentyl-2-cyclohexenol, 3-methyl-5-hexyl-2-cyclohexenone, and 3-methyl-5-heptyl-2-cyclohexenone.

68. The method of clause 60 wherein the carboxylic acids of compounds (a) comprise lactic acid, salicylic acid, geranic acid, citronellic acid, 3-methyl-2-decenoic acid, and any isomers thereof.

69. The method of clause 60 wherein the carboxylic acids of compounds (a) comprise lactic acid and isomers thereof.

70. The method of clause 60 wherein the esters of carboxylic acids of compounds (a) comprise methyl lactate, ethyl lactate, propyl lactate, butyl lactate, amyl lactate, isoamyl lactate, hexyl lactate, cis-3-hexenyl lactate, methyl geranate, ethyl geranate, isoamyl geranate, methyl citronellate, ethyl citronellate, methyl salicylate, ethyl salicylate, amyl salicylate, isoamyl salicylate, hexyl salicylate, cis-3-hexenyl salicylate, and any isomers thereof.

71. The method of clause 60 wherein the esters of carboxylic acids of compounds (a) comprise esters of salicylic acid and any isomers thereof.

72. The method of clause 60 wherein the at least one sensate compound is selected from those set forth in clause 2.

73. The method of clause 60 wherein the at least one sensate compound is selected from the group consisting of: WS-23 (2-isopropyl-N,2,3-trimethylbutyramide), FEMA 3804; WS-3 (N-ethyl-p-menthane-3-carboxamide), FEMA 3455; WS-5 [ethyl 3-(p-menthane-3-carboxamido)acetate], FEMA 4309; WS-12 (1R,2S,5R)—N-(4-methoxyphenyl)-p-menthanecarboxamide, FEMA 4681; WS-27 (N-ethyl-2,2-diisopropylbutanamide), FEMA 4557; N-cyclopropyl-5-methyl-2-isopropylcyclohexanecarboxamide, FEMA 4693; WS-116 (N-(1,1-dimethyl-2-hydroxyethyl)-2,2-diethylbutanamide), FEMA 4603; menthoxyethanol, FEMA 4154; N-(4-cyanomethylphenyl)-p-menthanecarboxamide, FEMA 4496; N-(2-(pyridin-2-yl)ethyl)-3-p-menthanecarboxamide, FEMA 4549; N-(2-hydroxyethyl)-2-isopropyl-2,3-dimethylbutanamide, FEMA 4602; N-(4-(carbamoylmethyl)phenyl)-menthylcarboxamide, FEMA 4684; (1R,2S,5R)—N-(4-methoxyphenyl)-p-menthanecarboxamide (WS-12), FEMA 4681; (2S,5R)—N-[4-(2-amino-2-oxoethyl)phenyl]-p-menthanecarboxamide, FEMA 4684; N-cyclopropyl-5-methyl-2-isopropylcyclohexanecarbonecarboxamide, FEMA 4693; 2-[(2-p-menthoxy)ethoxy]ethanol, FEMA 4718; 2,6-diethyl-5-isopropyl-2-methyltetrahydropyran, FEMA 4680; a TRPV1 antagonist that inhibits heat sensation and thus enhances cooling agents trans-4-tert-butylcyclohexanol, FEMA 4724; 2-(p-tolyloxy)-N-(1H-pyrazol-5-yl)-N-((thiophen-2-yl)methyl)acetamide, FEMA 4809; racemic N-isopropyl-5-methylcyclohexyl)cyclopropanecarboxamide, FEMA 4558; menthone glycerol ketal, FEMA 3807 and 3748; menthoxypropane-1,2-diolFEMA 3784; N-(2-hydroxyethyl)-2,3-dimethyl-2-isopropylbutyramide, FEMA 4602; N-(1,1-dimethyl-2-hydroxyethyl)2,2-diethylbutanamide, FEMA 4603); 1R,2S,5R)—N-(4-methoxyphenyl)-p-menthanecarboxamide, WS-12, N-cyclopropyl-5-methyl-2-isopropylcyclohexanecarbonecarboxamide, FEMA 4693; (1R,3R,4S)-3-menthyl-3,6-dioxaheptanoate, (1R,2S,5R)-3-menthyl methoxyacetate, (1R,2S,5R)-3-menthyl 3,6,9-trioxadecanoate, (1R,2S,5R)-3-menthyl 3,6,9-trioxadecanoate, (1R,2S,5R)-3-menthyl (2-hydroxyethoxy)acetate & (1R,2S,5R)-menthyl 11-hydroxy-3,6,9-trioxaundecanoate, N-(4-cyanomethylphenyl) p-menthanecarboxamide FEMA 4496; N,N-dimethyl menthyl succinamide (2-isopropyl-5-methylcyclohexyl 4-(dimethylamino)-4-oxobutanoate), FEMA 4230; N-(4-cyanomethylphenyl) p-menthanecarboxamide, FEMA 4496; N-(2-pyridin-2-ylethyl) p-menthanecarboxamide, FEMA 4549; menthyl lactate, FEMA 3748; N-(4-cyanomethylphenyl) p-menthanecarboxamide, FEMA 4496; N-(2-pyridin-2-ylethyl) p-menthanecarboxamide, FEMA 4549; menthyl lactate, FEMA 3748; menthol, WS-3, WS-23 and (−)-menthoxypropane-1,2-diol (TK-10), 6-isopropyl-3,9-dimethyl-1,4-dioxaspiro[4.5]decan-2-one, FEMA 4285; menthane carboxamides, N-benzo[1,3] dioxol-5-yl-3-p-menthanecarboxamide, N-benzooxazol-4-yl-3-p-menthanecarboxamide, N-4-([1,2,4]triazol-1-yl)-phenyl-3-p-menthanecarboxamide & N-4-(pyrazol-1-yl)-phenyl-3-p-menthanecarboxamide, 2,2,5,6,6-pentamethyl-2,3,6,6a-tetrahydropentalen-3a(1H)-ol, 5-(2-hydroxy-2-methylpropyl)-3,4,4-trimethylcyclopent-2-en-1-one, pyridinalkylcyclohexane carboxamides, (1R,2S,5R)-2-isopropyl-5-methyl-N-(2-(pyridin-2-yl)ethyl)cyclohexanecarboxamide, FEMA 4549, (2S,5R)-2-isopropyl-5-methyl-N-(2-(pyridin-4-yl)ethyl)cyclohexanecarboxamide, N-(4-cyanomethylphenyl) p-menthanecarboxamide, FEMA 4496; 1-isopropyl-4-methyl-bicyclo[2.2.2-1oct-5-ene-2,3-dicarbinol, 4-methoxy-N-phenyl-N-[2-(pyridin-2-yl)ethyl]benzamide, 4-methoxy-N-phenyl-N-[2-(pyridin-2-yl)ethyl]benzenesulfonamide, 4-chloro-N-phenyl-N-[2-(pyridin-2-yl)ethyl]benzenesulfonamide, 4-cyano-N-phenyl-N-[2-(pyridin-2-yl)ethyl]benzenesulfonamide, 4-((benzhydrylamino)methyl)-2-methoxyphenol, 4-((bis(4-methoxyphenyl)-methylamino)-methyl)-2-methoxyphenol, 4-((1,2-diphenylethylamino)methyl)-2-methoxyphenol, 4-((benzhydryloxy)methyl)-2-methoxyphenol, 4-((9H-fluoren-9-ylamino)methyl)-2- or 4-((benzhydrylamino)methyl)-2-ethoxyphenol, 1-(4-methoxyphenyl)-2-(1-methyl-1H-benzo[d]imidazol-2-yl)vinyl4-methoxybenzoate, 2-(1-isopropyl-6-methyl-1H-benzo[d]imidazol-2-yl)-1-(4-methoxyphenyl)vinyl4-methoxybenzoate, (Z)-2-(1-isopropyl-5-methyl-1H-benzo[d]imidazol-2-yl)-1-(4-methoxy-phenyl)vinyl-4-methoxybenzoate, N-(1-methyl-1-isopropylbutyl)benzamide, fenchyl, D-bornyl, L-bornyl, exo-norbornyl, 2-methylisobornyl, 2-ethylfenchyl, 2-methylbornyl, cis-pinan-2-yl, verbanyl and isobornyl derivatives, menthyl oxamate derivatives, menthyl 3-oxocarboxylic acid esters, L-menthyl 3-oxobutyrate, L-menthyl 3-oxopentanoate, 3,4-methylenedioxycinnamic acid, N,N-diphenylamide, (1R,2R,4S)-dihydroumbellulol, (1R,2R,5R)—N-ethyl-5-methyl-2-(prop-1-en-2-yl)cyclohexanecarboxamide, 1-[2-hydroxyphenyl]-4-[2-nitrophenyl-]-1,2,3,6-tetrahydropyrimidine-2-one), (2E,6E/Z,8E)-N-(2-methylpropyl)-2,6,8-decatrienamide, FEMA 4668; octadiene amides, octatriene amides, nonadiene amides, nonatriene amides, decadiene amides, decatriene amides, menthone, isopulegol, isopulegone including geometric isomers and non-nitrogen containing derivatives, cubebol, ketals from menthone, fenchol derivatives, bornyl derivatives, N,N-diethyl-m-toluamide, para-menthane-3,8-diol, menthyl pyrrolidone carboxylate, and derivatives of 2-isopropyl-5-methylcyclohexane.

74. The method of clause 60 wherein the biting arthropod control or repellent formulation comprises at least one compound (a) selected from the group consisting of: geranylacetone (6,10-dimethyl-5,9-undecadien-2-one), methyl undecyl ketone (2-tridecanone), geranylcyclopentanone (2-(3,7-dimethylocta-2,6-dienyl)cyclopentan-1-one), octenylcyclopentanone (2-(2-octen-1-yl)-cyclopentanone), methyl decyl ketone (2-dodecanone), nootkatone (4,4a-dimethyl-6-prop-1-en-2-yl-3,4,5,6,7,8-hexahydronaphthalen-2-one), alpha-ionone (4-(2,6,6-trimethyl-2-cyclohexenyl)-3-buten-2-one), beta ionone (4-(2,6,6-trimethyl-1-cyclohexenyl)-3-buten-2-one), alpha-isomethylionone (3-methyl-4-(2,6,6-trimethyl-2-cyclohexen-1-yl)-3-buten-2-one), nectaryl (2-(2-(4-methyl-3-cyclohexen-1-yl) propyl) cyclopentanone), isobutylionone ((E)-5-Methyl-1-(2,6,6-trimethyl-1-cyclohex-2-enyl) hex-1-en-3-one), isolongifolen-9-one ((1R)-2,2,7,7-tetramethyltricyclo[6.2.1.01,6] undec-5-en-4-one) dimethylionone ((E)-2-methyl-1-(2,2,6-trimethyl-1-cyclohex-3-enyl)pent-1-en-3-one), isolongifolanone (2,2,7,7-tetramethyltricyclo [6.2.1.01,6]undecan-5-one), pseudoionone (6,10-dimethyl-3,5,9-undecatrien-2-one), 2-cyclopentylcyclopentanone, methyl nonyl ketone, 2-decen2-one and 1-carvone; and at least one sensate compound selected from the group consisting of menthol, menthone, isopulegol, isopulegone including geometric isomers and non-nitrogen containing derivatives, cubebol, ketals from menthone, fenchol derivatives, bornyl derivatives, and menthyl pyrrolidone carboxylate.

75. The method of clause 60 wherein the biting arthropod control or repellent formulation comprises at least one compound (a) selected from the group consisting of: octenyl cyclopentanone, geranyl cyclopentanone, methyl decyl ketone, methyl undecyl ketone, geranylacetone, ionone, isolongifolenone and nootkatone; and at least one sensate compound selected from the group consisting of menthol, menthone, isopulegol, isopulegone including geometric isomers and non-nitrogen containing derivatives, cubebol, ketals from menthone, fenchol derivatives, bornyl derivatives, and menthyl pyrrolidone carboxylate.

76. The method of clause 60 wherein the amount of the at least one compound (a) and at least one sensate compound in an effective dose required to repel about 100% of a biting arthropod is less than the amount of the at least one compound (a) alone in an effective dose required to repel about 100% of the biting arthropod.

77. The method of clause 60 wherein the at least one compound (a) and the at least one sensate compound are present in an amount from about 0.5 to about 25% by weight, and in a weight ratio of the at least one compound (a) to the at least one sensate compound from about 0.1:2 to about 2:0.1.

78. The method of clause 60 wherein the at least one compound (a) and the at least one sensate compound are present in an amount from about 2.5 to about 20% by weight, and in a weight ratio of the at least one compound (a) to the at least one sensate compound from about 0.2:1 to about 1:0.2.

79. The method of clause 60 wherein the at least one compound (a) and the at least one sensate compound are present in an amount from about 5 to about 15% by weight, and in a weight ratio of the at least one compound (a) to the at least one sensate compound from about 0.3:1 to about 1:0.3.

80. The method of clause 60 wherein the amount of the one or more compounds (a) selected from the group consisting of octenyl cyclopentanone, geranyl cyclopentanone, methyl decyl ketone, methyl undecyl ketone, geranyl acetone, ionone, isolongifolenone, and nootkatone, and the one or more sensate compounds selected from the group consisting of menthol, menthone, isopulegol, isopulegone including geometric isomers and non-nitrogen containing derivatives, cubebol, ketals from menthone, fenchol derivatives, and bornyl derivatives, in an effective dose required to repel about 100% of a biting arthropod is less than the amount of the one or more compounds (a) alone in an effective dose required to repel about 100% of the biting arthropod.

81. The method of clause 60 wherein the one or more compounds (a) selected from the group consisting of octenyl cyclopentanone, geranyl cyclopentanone, methyl decyl ketone, methyl undecyl ketone, geranyl acetone, ionone, isolongifolenone, and nootkatone, and the one or more sensate compounds selected from the group consisting of menthol, menthone, isopulegol, isopulegone including geometric isomers and non-nitrogen containing derivatives, cubebol, ketals from menthone, fenchol derivatives, and bornyl derivatives, are present in an amount from about 0.5 to about 25% by weight, and in a weight ratio of the one or more compounds (a) to the one or more sensate compounds from about 0.1:2 to about 2:0.1.

82. The method of clause 60 wherein the one or more compounds (a) selected from the group consisting of octenyl cyclopentanone, geranyl cyclopentanone, methyl decyl ketone, methyl undecyl ketone, geranyl acetone, ionone, isolongifolenone, and nootkatone, and the one or more sensate compounds selected from the group consisting of menthol, menthone, isopulegol, isopulegone including geometric isomers and non-nitrogen containing derivatives, cubebol, ketals from menthone, fenchol derivatives, and bornyl derivatives, are present in an amount from about 2.5 to about 20% by weight, and in a weight ratio of the one or more compounds (a) to the one or more sensate compounds from about 0.2:1 to about 1:0.2.

83. The method of clause 60 wherein the one or more compounds (a) selected from the group consisting of octenyl cyclopentanone, geranyl cyclopentanone, methyl decyl ketone, methyl undecyl ketone, geranyl acetone, ionone, isolongifolenone, and nootkatone, and the one or more sensate compounds selected from the group consisting of menthol, menthone, isopulegol, isopulegone including geometric isomers and non-nitrogen containing derivatives, cubebol, ketals from menthone, fenchol derivatives, and bornyl derivatives, are present in an amount from about 5 to about 15% by weight, and in a weight ratio of the one or more compounds (a) to the one or more sensate compounds from about 0.3:1 to about 1:0.3.

84. The method of clause 60 wherein the biting arthropods are selected from the group consisting of: mosquitoes, bed bugs, biting flies, ticks, ants, fleas, biting midges, and spiders.

The following non-limiting examples are provided to illustrate the disclosure.

### EXAMPLES

### Test System

Adult female Aedes aegypti were obtained from the i2LResearch USA, Inc. colony. Two hundred fifty (250) mosquitoes were used per replicate (seven replicates). Mosquitoes were at least 6 days old and had been deprived of sucrose solution for at least 18 hours prior to testing.

An exposure container was used to present the mosquitoes with a choice of blood-filled wells that were covered with collagen membranes (3 cm in diameter). The collagen membranes were treated by pipetting 6.25 μl of the test treatment onto the appropriate membrane and spreading it evenly with the tip of the pipette.

### Experimental Design

Exposure container. A 30.5 cm×30.5 cm×30.5 cm container (rigid plastic frame and a sleeved entry on one side and a sliding trap door on the bottom). The container was supported by four (4 cm high) legs.

Membrane feeder. Five wells (3 cm in diameter x 8 mm in depth) in line on a hollow plastic block (6 cm wide x 22 cm long x 3 cm deep). The plastic block fit into the bottom of the exposure container. Hoses mounted on either end of the membrane feeder carried warm water that was pumped from a water bath. The sliding plastic trap door in the bottom of the exposure container covered and uncovered the wells in the membrane feeder, allowing mosquitoes to access the blood-filled wells that were covered with treated collagen membranes.

Study set-up. The membrane feeder was connected to a heated water bath, and warm water passed through the feeder via a circulating pump so that the wells were warmed to 96-100° F. Seventy-two (72) mg of ATP (disodium salt) were added to 26 ml of bovine blood. Sodium citrate was also added to the blood during collection to prevent clotting. The blood was poured into the wells until it completely filled each well (meniscus slightly above the level of the well).

Circular pieces (3 cm in diameter) of collagen membrane were placed over each of the wells. Care was taken to eliminate all air bubbles from between the membrane and the surface of the blood. Once wells were prepared, the blood was allowed to warm until the membrane temperature reached 96-100° C. Temperature was confirmed using a surface thermometer.

Treatment and exposure to mosquitoes. Once the collagen membranes were placed over the blood-filled wells, they were treated as described above. The membranes were allowed to dry for five minutes. Then the exposure container was placed on the membrane feeder. The trap door in the floor of the container was slid back, exposing the mosquitoes to the membranes. The number of mosquitoes probing the membrane covering each well was recorded every two minutes for twenty minutes. If a minimum of 20 total control probes were not achieved in a replicate, the replicate was repeated.

The above procedures were repeated until seven acceptable replicates were completed. A new batch of 250 female mosquitoes and fresh blood were used for each replicate. The treatments were rotated so that each treatment was tested in each of the five well positions at least one time each. This was to cancel any positional bias.

Test results are set forth below. DEET is N,N-diethyl-m-toluamide. WS-23 is 2-isopropyl-N,2,3-trimethylbutyramide (FEMA 3804). Coolact 10 is menthoxypropane-1,2-diol (FEMA 3784).

| Concentration | DEET | WS-23 | Coolact 10 |
|---|---|---|---|
| 0.15% | 39.5% | 45.9% | 45.4 |
| 0.30% | 45.3% | 53.2% | 41.5 |

Additional test results are set forth below. All percentages are relative to 0.3 wt % DEET in the same test. The BRI mix is 50 wt % delta dodecalactone, 37.5 wt % propyl dihydrojasmonate, and 12.5 wt % methyl dihydrojasmolate. DEET is N,N-diethyl-m-toluamide. PMD is para-menthane-3,8-diol. WS-3 is N-ethyl-p-menthane-3-carboxamide (FEMA 3455). Spilanthol is (2E,6E/Z,8E)-N-(2-methylpropyl)-2,6,8-decatrienamide (FEMA 4668). The mixture of WS-3+BRI mix is in isopropanol and contains 0.225 wt % BRI mix and 0.075 wt % WS-3. The mixture of Spilanthol+BRI mix is in isopropanol and contains 0.225 wt % BRI mix and 0.075 wt % Spilanthol.

| Total | | | | |
|---|---|---|---|---|
| repellent | *BRImix | DEET | PMD | WS3 |
| 0.30% | 135.5% | 100.0% | 84.6% | 130.0% |

| Total | **WS3 + | ***Spilanthol + |
|---|---|---|
| repellent | BRImix | BRImix |
| 0.30% | 147.8% | 158.3% |

All patents and patent applications, and other documents cited herein are fully incorporated by reference to the extent such disclosure is not inconsistent with this disclosure and for all jurisdictions in which such incorporation is permitted.

When numerical lower limits and numerical upper limits are listed herein, ranges from any lower limit to any upper limit are contemplated. While the illustrative embodiments of the disclosure have been described with particularity, it will be understood that various other modifications will be apparent to and can be readily made by those skilled in the art without departing from the spirit and scope of the disclosure. Accordingly, it is not intended that the scope of the claims appended hereto be limited to the examples and descriptions set forth herein but rather that the claims be construed as encompassing all the features of patentable novelty which reside in the present disclosure, including all features which would be treated as equivalents thereof by those skilled in the art to which the disclosure pertains.

The present disclosure has been described above with reference to numerous embodiments and specific examples. Many variations will suggest themselves to those skilled in this art in light of the above detailed description. All such obvious variations are within the full intended scope of the appended claims.

What is claimed is:

1. A biting arthropod control or repellent formulation for the control or repellency of biting arthropods, the formulation comprising at least one sensate compound; wherein the at least one sensate compound is present in an effective amount sufficient to control or repel biting arthropods.

2. The biting arthropod control or repellent formulation of claim 1 wherein the sensate compound is selected from the group consisting of:

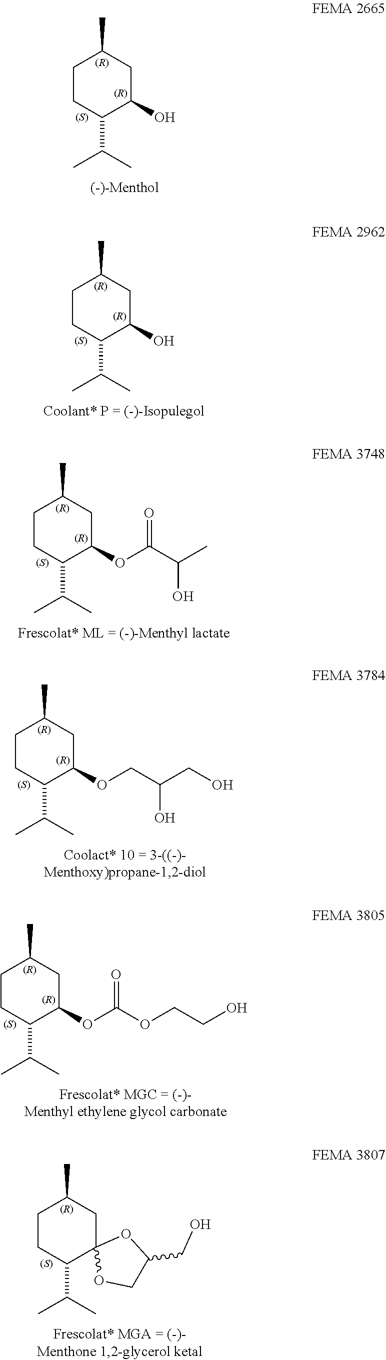

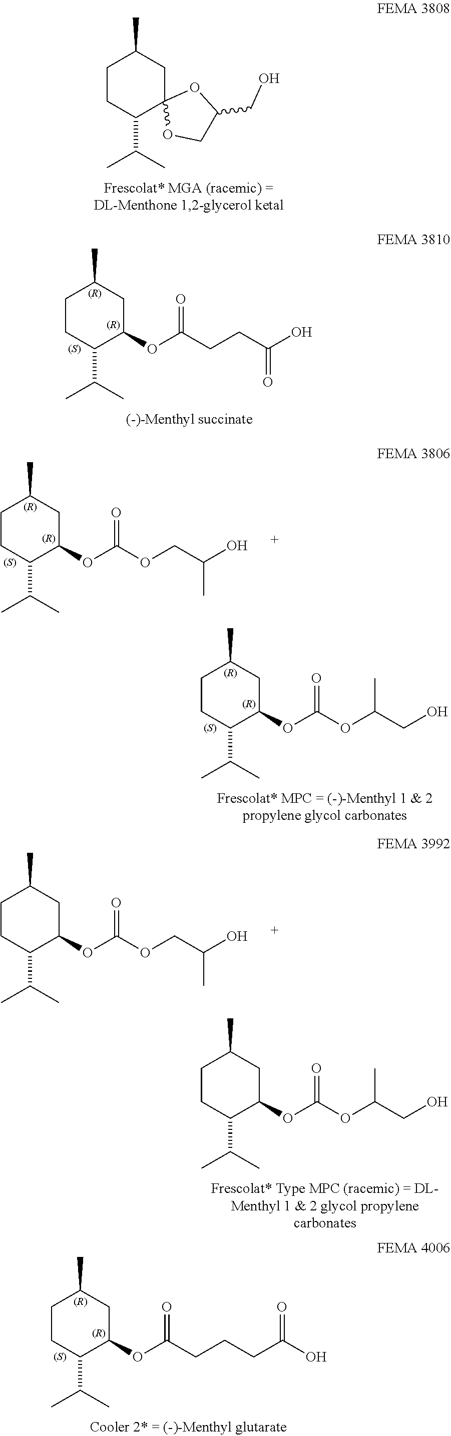

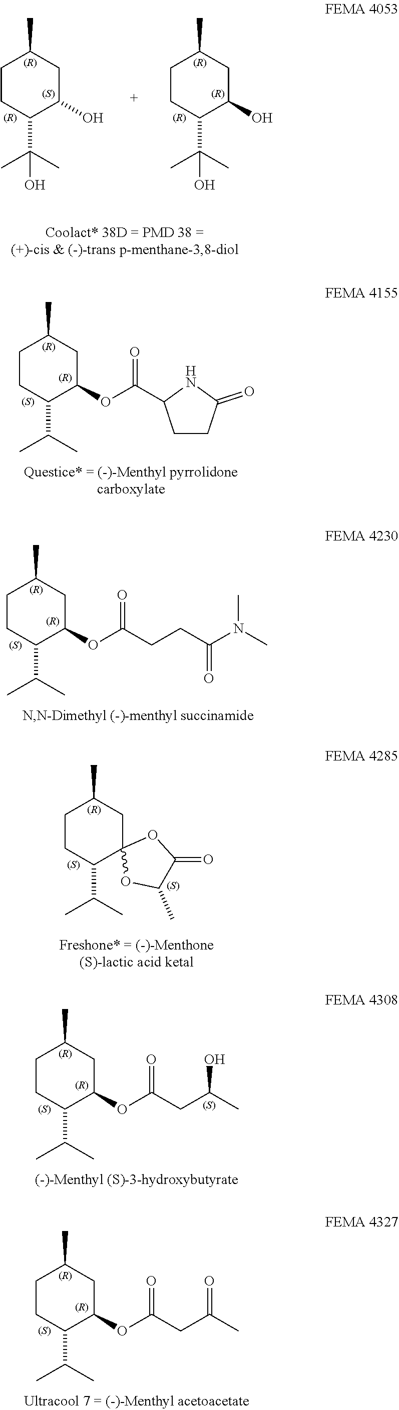

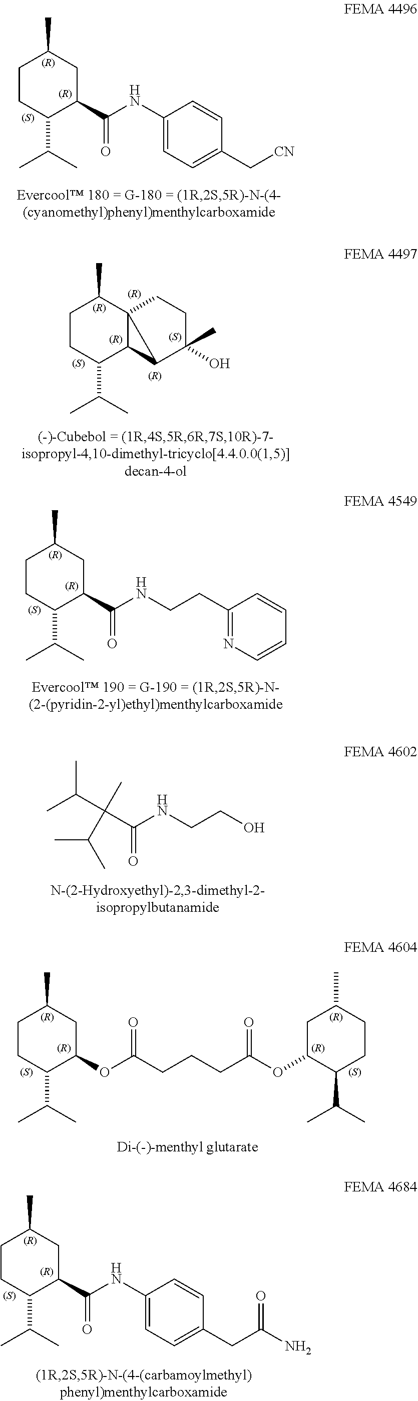

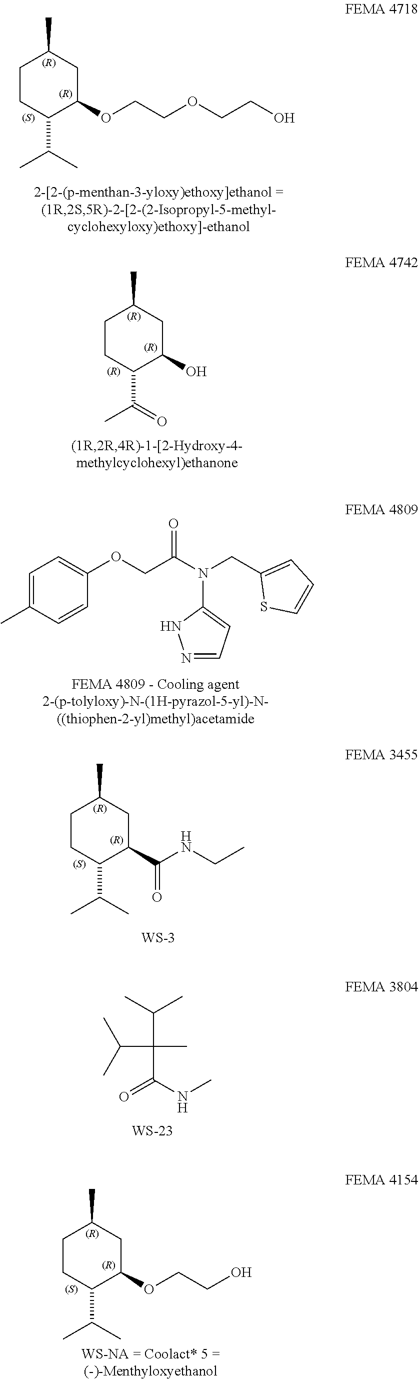

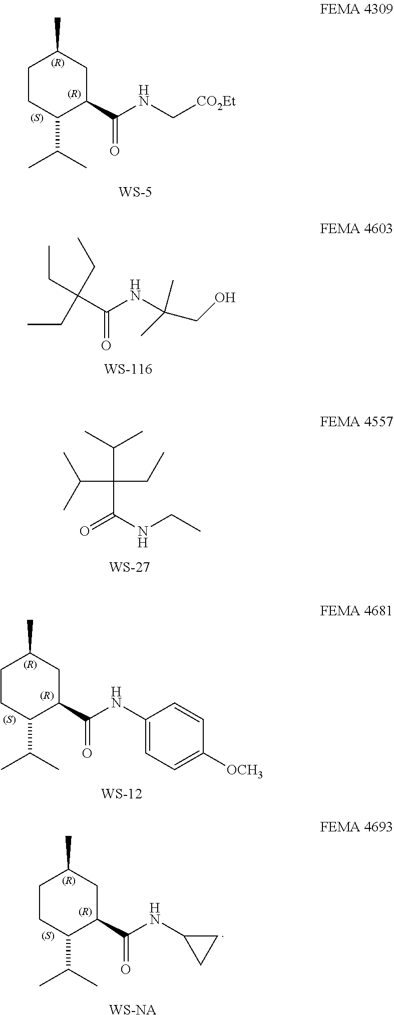

3. The biting arthropod control or repellent formulation of claim 1 wherein the at least one sensate compound is selected from the group consisting of: WS-23 (2-isopropyl-N,2,3-trimethylbutyramide), FEMA 3804; WS-3 (N-ethyl-p-menthane-3-carboxamide), FEMA 3455; WS-5 [ethyl 3-(p-menthane-3-carboxamido)acetate], FEMA 4309; WS-12 (1R,2S,5R)—N-(4-methoxyphenyl)-p-menthanecarboxamide, FEMA 4681; WS-27 (N-ethyl-2,2-diisopropylbutanamide), FEMA 4557; N-cyclopropyl-5-methyl-2-isopropylcyclohexanecarboxamide, FEMA 4693; WS-116 (N-(1,1-dimethyl-2-hydroxyethyl)-2,2-diethylbutanamide), FEMA 4603; menthoxyethanol, FEMA 4154; N-(4-cyanomethylphenyl)-p-menthanecarboxamide, FEMA 4496; N-(2-(pyridin-2-yl)ethyl)-3-p-menthanecarboxamide, FEMA 4549; N-(2-hydroxyethyl)-2-isopropyl-2,3-dimethylbutanamide, FEMA 4602; N-(4-(carbamoylmethyl)phenyl)-menthylcarboxamide, FEMA 4684; (1R,2S,5R)—N-(4-methoxyphenyl)-p-menthanecarboxamide (WS-12), FEMA 4681; (2S,5R)—N-[4-(2-amino-2-oxoethyl)phenyl]-p-menthanecarboxamide, FEMA 4684; N-cyclopropyl-5-methyl-2-isopropylcyclohexanecarbonecarboxamide, FEMA 4693; 2-[(2-p-menthoxy)ethoxy]ethanol, FEMA 4718; 2,6-diethyl-5-isopropyl-2-methyltetrahydropyran, FEMA 4680; a TRPV1 antagonist that inhibits heat sensation and thus enhances cooling agents trans-4-tert-butylcyclohexanol, FEMA 4724; 2-(p-tolyloxy)-N-(1H-pyrazol-5-yl)-N-((thiophen-2-yl)methyl)acetamide, FEMA 4809; racemic N-isopropyl-5-methylcyclohexyl)cyclopropanecarboxamide, FEMA 4558; menthone glycerol ketal, FEMA 3807 and 3748; menthoxypropane-1,2-diol FEMA 3784; N-(2-hydroxyethyl)-2,3-dimethyl-2-isopropylbutyramide, FEMA 4602; N-(1,1-dimethyl-2-hydroxyethyl)2,2-diethylbutanamide, FEMA 4603); 1R,2S,5R)—N-(4-methoxyphenyl)-p-menthanecarboxamide, WS-12, N-cyclopropyl-5-methyl-2-isopropylcyclohexanecarbonecarboxamide, FEMA 4693; (1R,3R,4S)-3-menthyl-3,6-dioxaheptanoate, (1R,2S,5R)-3-menthyl methoxyacetate, (1R,2S,5R)-3-menthyl 3,6,9-trioxadecanoate, (1R,2S,5R)-3-menthyl 3,6,9-trioxadecanoate, (1R,2S,5R)-3-menthyl (2-hydroxyethoxy)acetate & (1R,2S,5R)-menthyl 11-hydroxy-3,6,9-trioxaundecanoate, N-(4-cyanomethylphenyl) p-menthanecarboxamide FEMA 4496; N,N-dimethyl menthyl succinamide (2-isopropyl-5-methylcyclohexyl 4-(dimethylamino)-4-oxobutanoate), FEMA 4230; N-(4-cyanomethylphenyl) p-menthanecarboxamide, FEMA 4496; N-(2-pyridin-2-ylethyl) p-menthanecarboxamide, FEMA 4549; menthyl lactate, FEMA 3748; N-(4-cyanomethylphenyl) p-menthanecarboxamide, FEMA 4496; N-(2-pyridin-2-ylethyl) p-menthanecarboxamide, FEMA 4549; menthyl lactate, FEMA 3748; menthol, WS-3, WS-23 and (−)-menthoxypropane-1,2-diol (TK-10), 6-isopropyl-3,9-dimethyl-1,4-dioxaspiro[4.5]decan-2-one, FEMA 4285; menthane carboxamides, N-benzo[1,3] dioxol-5-yl-3-p-menthanecarboxamide, N-benzooxazol-4-yl-3-p-menthanecarboxamide, N-4-([1,2,4]triazol-1-yl)-phenyl-3-p-menthanecarboxamide & N-4-(pyrazol-1-yl)-phenyl-3-p-menthanecarboxamide, 2,2,5,6,6-pentamethyl-2,3,6,6a-tetrahydropentalen-3a(1H)-ol, 5-(2-hydroxy-2-methylpropyl)-3,4,4-trimethylcyclopent-2-en-1-one, pyridinalkylcyclohexane carboxamides, (1R,2S,5R)-2-isopropyl-5-methyl-N-(2-(pyridin-2-yl)ethyl)cyclohexanecarboxamide, FEMA 4549, (2S,5R)-2-isopropyl-5-methyl-N-(2-(pyridin-4-yl)ethyl)cyclohexanecarboxamide, N-(4-cyanomethylphenyl) p-menthanecarboxamide, FEMA 4496; 1-isopropyl-4-methyl-bicyclo[2.2.2-1oct-5-ene-2,3-dicarbinol, 4-methoxy-N-phenyl-N-[2-(pyridin-2-yl)ethyl]benzamide, 4-methoxy-N-phenyl-N-[2-(pyridin-2-yl)ethyl]benzenesulfonamide, 4-chloro-N-phenyl-N-[2-(pyridin-2-yl)ethyl]benzenesulfonamide, 4-cyano-N-phenyl-N-[2-(pyridin-2-yl)ethyl]benzenesulfonamide, 4-((benzhydrylamino)methyl)-2-methoxyphenol, 4-((bis(4-methoxyphenyl)-methylamino)-methyl)-2-methoxyphenol, 4-((1,2-diphenylethylamino)methyl)-2-methoxyphenol, 4-((benzhydryloxy)methyl)-2-methoxyphenol, 4-((9H-fluoren-9-ylamino)methyl)-2- or 4-((benzhydrylamino)methyl)-2-ethoxyphenol, 1-(4-methoxyphenyl)-2-(1-methyl-1H-benzo[d]imidazol-2-yl)vinyl4-methoxybenzoate, 2-(1-isopropyl-6-methyl-1H-benzo[d]imidazol-2-yl)-1-(4-methoxyphenyl)vinyl4-methoxybenzoate, (Z)-2-(1-isopropyl-5-methyl-1H-benzo[d]imidazol-2-yl)-1-(4-methoxy-phenyl)vinyl-4-methoxybenzoate, N-(1-methyl-1-isopropylbutyl)benzamide, fenchyl, D-bornyl, L-bornyl, exo-norbornyl, 2-methylisobornyl, 2-ethylfenchyl, 2-methylbornyl, cis-pinan-2-yl, verbanyl and isobornyl derivatives, menthyl oxamate derivatives, menthyl 3-oxocarboxylic acid esters, L-menthyl 3-oxobutyrate, L-menthyl 3-oxopentanoate, 3,4-methylenedioxycinnamic acid, N,N-diphenylamide, (1R,2R,4S)-dihydroumbellulol, (1R,2R,5R)—N-ethyl-5-methyl-2-(prop-1-en-2-yl)cyclohexanecarboxamide, 1-[2-hydroxyphenyl]-4-[2-nitrophenyl-]-1,2,3,6-tetrahydropyrimidine-2-one), (2E,6E/Z,8E)-N-(2-methylpropyl)-2,6,8-decatrienamide, FEMA 4668; octadiene amides, octatriene amides, nonadiene amides, nonatriene amides, decadiene amides, decatriene amides, menthone, isopulegol, isopulegone including geometric isomers and non-nitrogen containing derivatives, cubebol, ketals from menthone, fenchol derivatives, bornyl derivatives, N,N-diethyl-m-toluamide, para-menthane-3,8-diol, menthyl pyrrolidone carboxylate, and derivatives of 2-isopropyl-5-methylcyclohexane.

4. The biting arthropod control or repellent formulation of claim 1 further comprising at least one compound (a) selected from the group consisting of:
(1) alkyl ketones and cyclic ketones, saturated or unsaturated, branched or unbranched, containing from about 6 to about 18 carbon atoms, or any range of carbon atoms within said range;
(2) compounds of the structure (A) 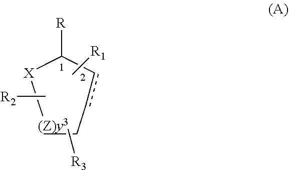
wherein:
R is selected from —OH, ═O, —OC(O)R₄, —OR₆, and —(OR₆)₂, wherein each R₆ is independently selected from an alkyl group containing from about 1 to about 4 carbon atoms and R₄ is a branched or straight chain, saturated or unsaturated, hydrocarbyl group with zero to two double bonds and from about 1 to about 15 carbon atoms;
X is O or CH₂, with the proviso that when X is O, R can only be ═O;
each Z is independently selected from (CH) and (CH₂);
y is a numeral selected from 1 and 2;
R₁ is selected from H or a branched or straight chain, saturated or unsaturated, hydrocarbyl group with zero to two double bonds and from about 1 to about 15 carbon atoms;
R₂ is selected from H and a branched or straight chain, saturated or unsaturated, hydrocarbyl group with zero to three double bonds and from about 1 to about 15 carbon atoms;
R₃ is selected from H, a branched or straight chain, saturated or unsaturated, hydrocarbyl group with zero to three double bonds and from about 1 to about 15 carbon atoms, —(CH₂)ₙOH, —C(O)OR₅, —CH₂C(O)OR₇, —CH₂C(O)R₈, —C(O)NR₉R₁₀, and —CH₂C(O)NR₁₁R₁₂, wherein each of R₅, R₇, R₈, R₉, R₁₀, R₁₁ and R₁₂ is independently selected from H and a branched or straight chain, saturated or unsaturated, hydrocarbyl group with zero to three double bonds and from about 1 to about 15 carbon atoms, and n is n integer of from 1 to 12;
the bond between the 2 and 3 positions in the ring structure may be a single or a double bond; and
wherein the compounds of structure (A) contain from about 11 to about 20 carbon atoms; and includes optical isomers, diastereomers and enantiomers of the compounds of structure (A);
(3) branched or unbranched, straight chain or cyclic, saturated or unsaturated, carboxylic acids containing from about 3 to about 18 carbon atoms or any range of carbon atoms within said range, including isomers thereof; and
(4) esters of branched or unbranched, straight chain or cyclic, saturated or unsaturated, carboxylic acids containing from about 3 to about 18 carbon atoms or any range of carbon atoms within said range, including isomers thereof.

5. The method of claim 1 further comprising at least one compound (a) selected from the group consisting of:

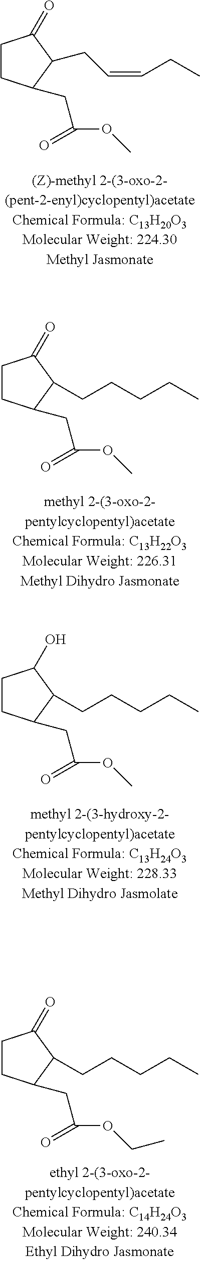 [SMILES: CC/C=C\CC1C(=O)CCC1CC(=O)OC ; CCCCCC1C(=O)CCC1CC(=O)OC ; CCCCCC1C(O)CCC1CC(=O)OC ; CCCCCC1C(=O)CCC1CC(=O)OCC]

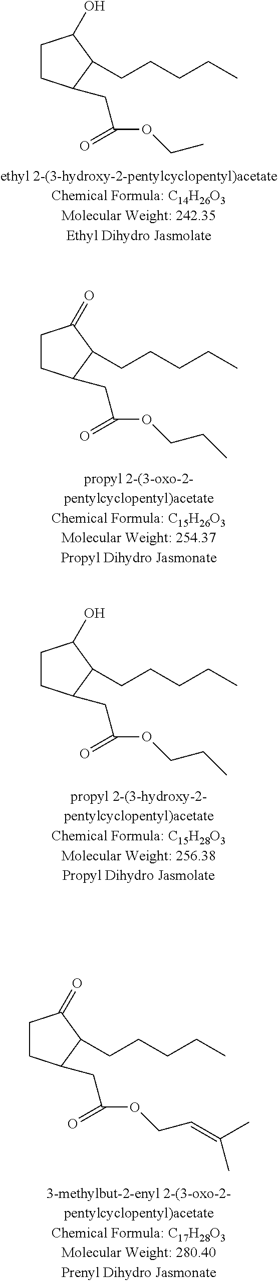 [SMILES: CCCCCC1C(O)CCC1CC(=O)OCC ; CCCCCC1C(=O)CCC1CC(=O)OCCC ; CCCCCC1C(O)CCC1CC(=O)OCCC ; CCCCCC1C(=O)CCC1CC(=O)OCC=C(C)C]

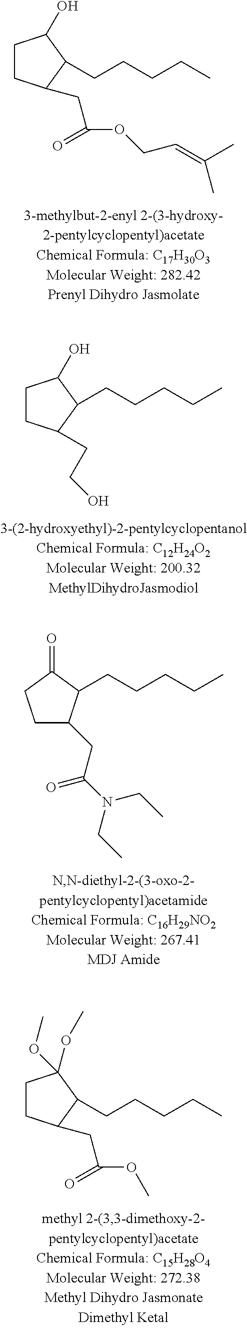 [SMILES: CCCCCC1C(O)CCC1CC(=O)OCC=C(C)C ; CCCCCC1C(O)CCC1CCO ; CCCCCC1C(=O)CCC1CC(=O)N(CC)CC ; CCCCCC1C(CC(=O)OC)CCC1(OC)OC]

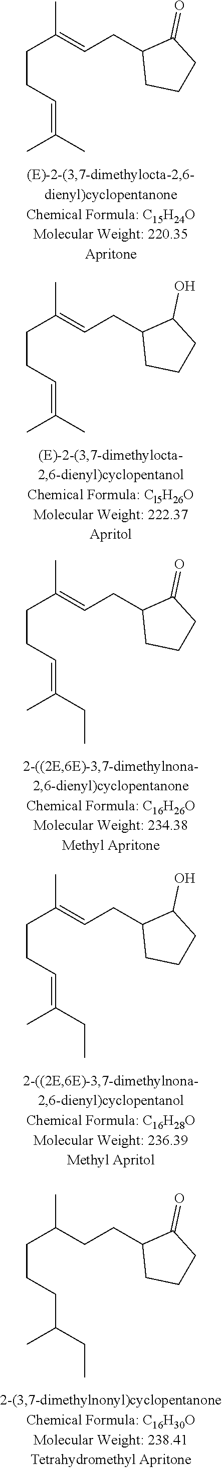 [SMILES: CC(C)=CCC/C(C)=C/CC1CCCC1=O ; CC(C)=CCC/C(C)=C/CC1CCCC1O ; CC/C(C)=C/CC/C(C)=C/CC1CCCC1=O ; CC/C(C)=C/CC/C(C)=C/CC1CCCC1O ; CCC(C)CCCC(C)CCC1CCCC1=O]

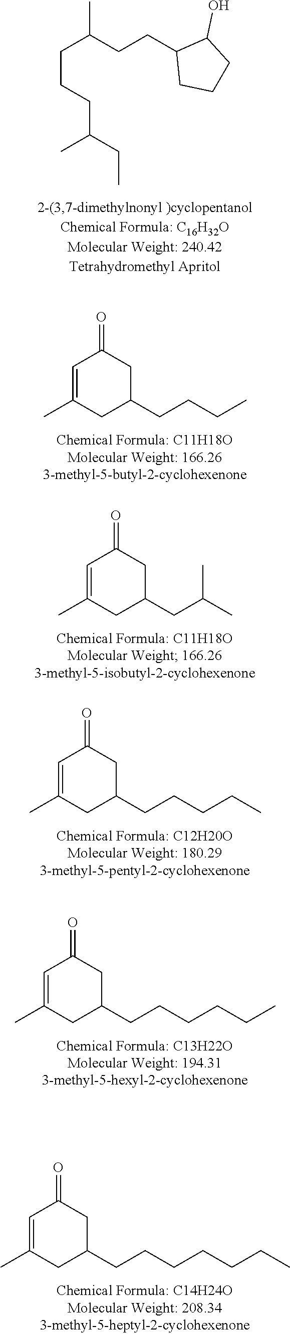

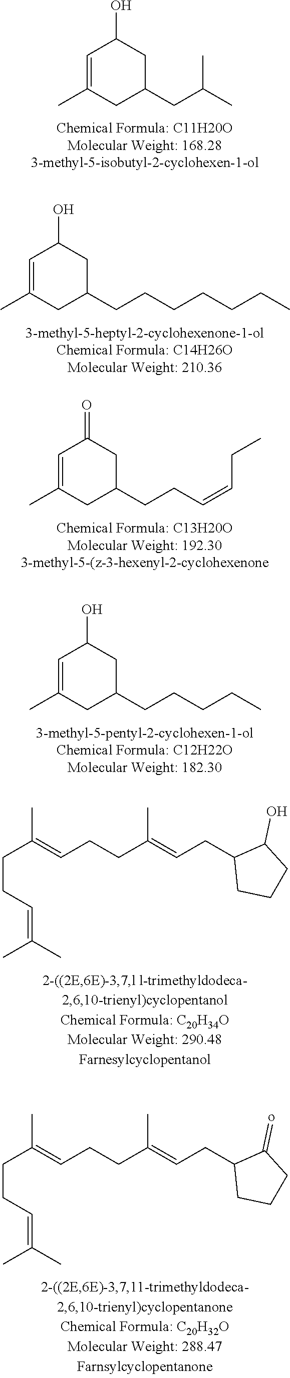

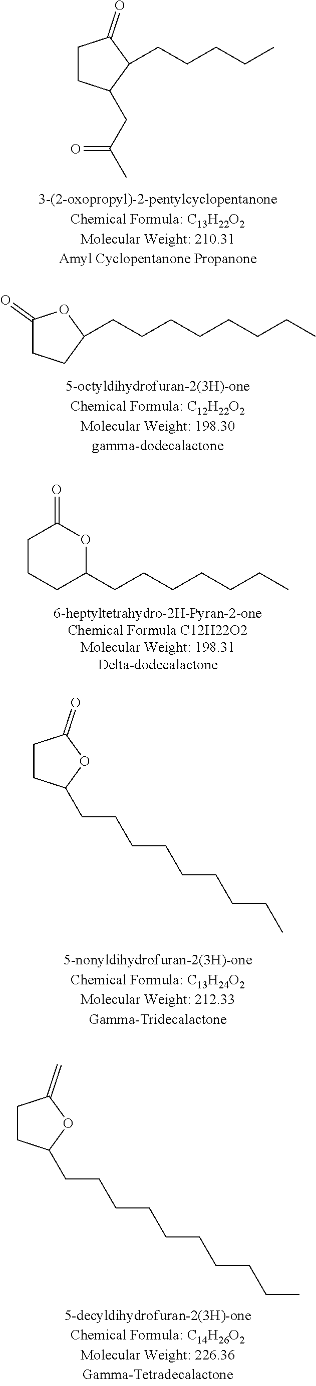 [SMILES: CCCCCC1C(=O)CCC1CC(C)=O ; CCCCCCCCC1CCC(=O)O1 ; CCCCCCCC1CCCC(=O)O1 ; CCCCCCCCCC1CCC(=O)O1 ; C=C1CCC(CCCCCCCCCC)O1]

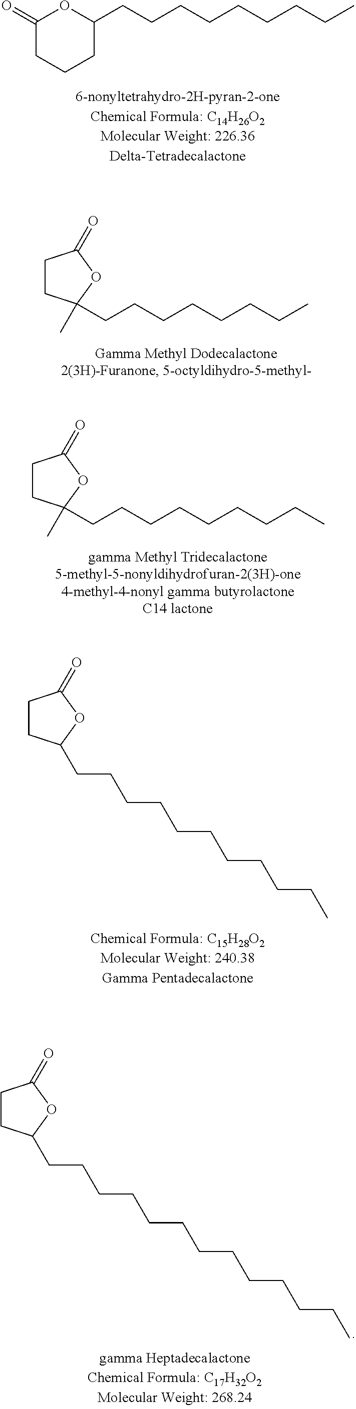 [SMILES: CCCCCCCCCC1CCCC(=O)O1 ; CCCCCCCCC1(C)CCC(=O)O1 ; CCCCCCCCCC1(C)CCC(=O)O1 ; CCCCCCCCCCCC1CCC(=O)O1 ; CCCCCCCCCCCCCC1CCC(=O)O1]

6. The biting arthropod control or repellent formulation of claim 1 wherein the at least one sensate compound is present in an amount from about 0.5 to about 25% by weight.

7. The biting arthropod control or repellent formulation of claim 4 wherein the one or more sensate compounds are selected from the group consisting of menthol, menthone, isopulegol, isopulegone including geometric isomers and non-nitrogen containing derivatives, cubebol, ketals from menthone, fenchol derivatives, and bornyl derivatives; wherein the one or more compounds (a) are selected from the group consisting of methyl apritone, methyl dihydrojasmonate, propyl dihydrojasmonate, methyl dihydrojasmolate, gamma-dodecalactone, delta-dodecalactone, gamma-tridecalactone, gamma-tetradecalactone, gamma methyl dodecalactone, gamma methyl tridecalactone, 3-methyl-5-pentyl-2-cyclohexenone, 3-methyl-5-pentyl-2-cyclohexenol, 3-methyl-5-hexyl-2-cyclohexenone, and 3-methyl-5-heptyl-2-cyclohexenone; and wherein the one or more sensate compounds and the one or more compounds (a) are present in an amount from about 0.5 to about 25% by weight.

8. The biting arthropod control or repellent formulation of claim 4 comprising a sensate compound and a compound (a), wherein the sensate compound and the compound (a) are present in an amount from about 0.5 to about 25% by weight, and in a weight ratio of the sensate compound to compound (a) from about 0.1:2 to about 2:0.1.

9. The biting arthropod control or repellent formulation of claim 1 wherein the biting arthropods are selected from the group consisting of: mosquitoes, bed bugs, biting flies, ticks, ants, fleas, biting midges, and spiders.

10. A method for the control or repellency of biting arthropods, the method comprising bringing the biting arthropods into contact with a biting arthropod control or repellent formulation, wherein the biting arthropod control or repellent formulation comprises at least one sensate compound; wherein the at least one sensate compound is present in an effective amount sufficient to control or repel biting arthropods.

11. The method of claim 10 wherein the at least one sensate compound is selected from the group consisting of:

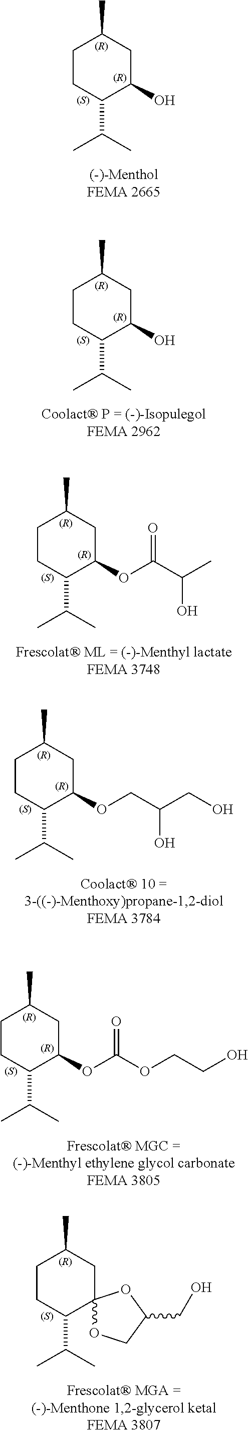

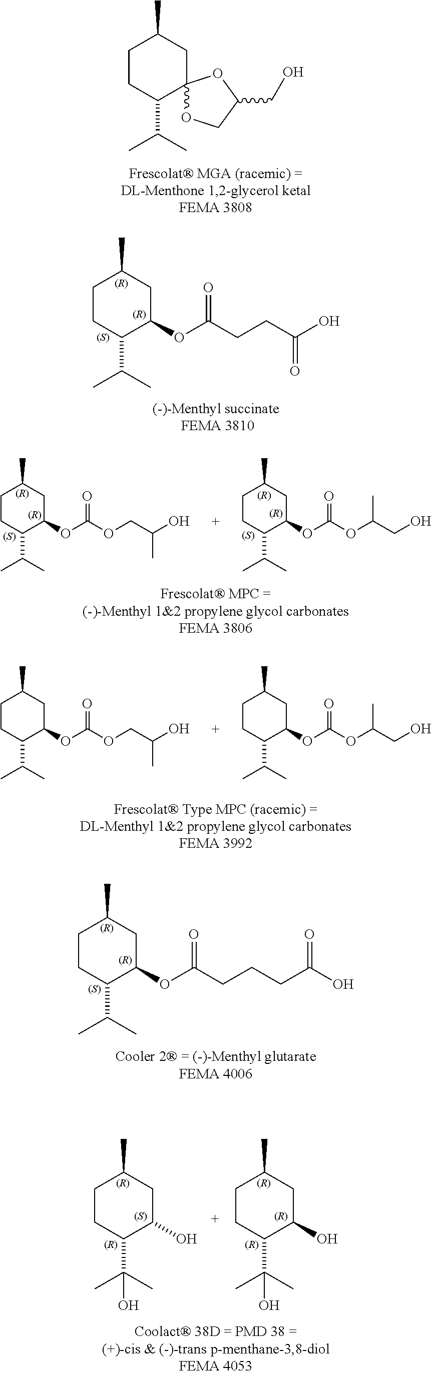

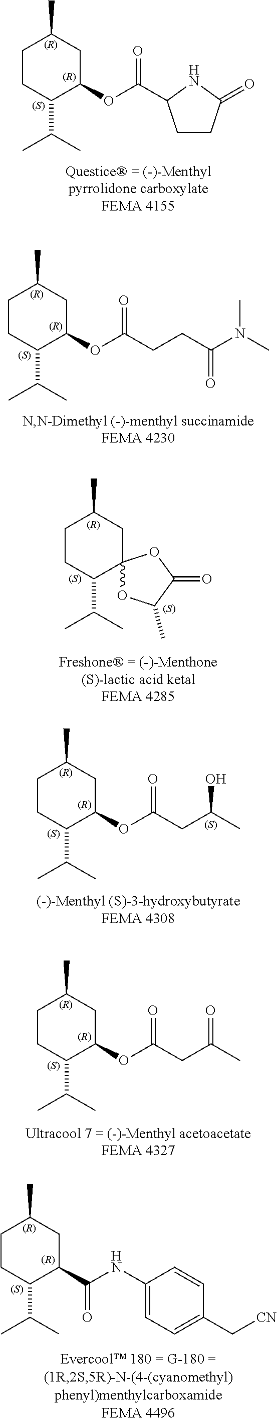

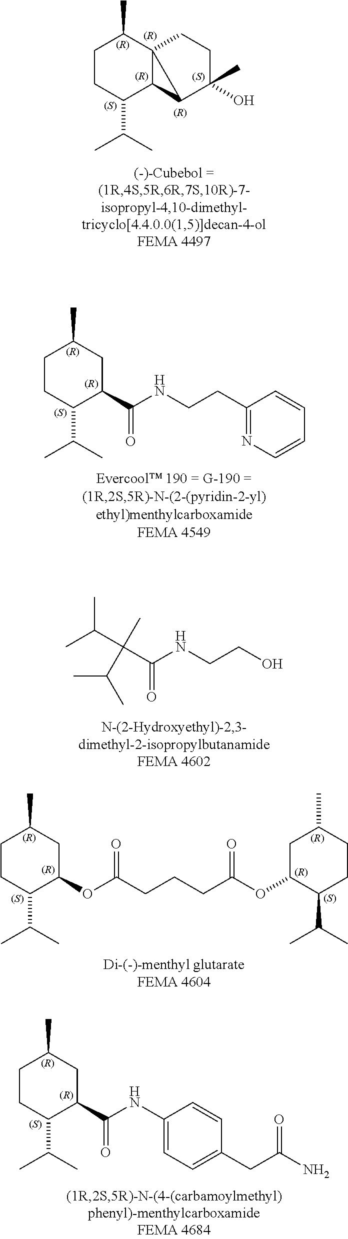

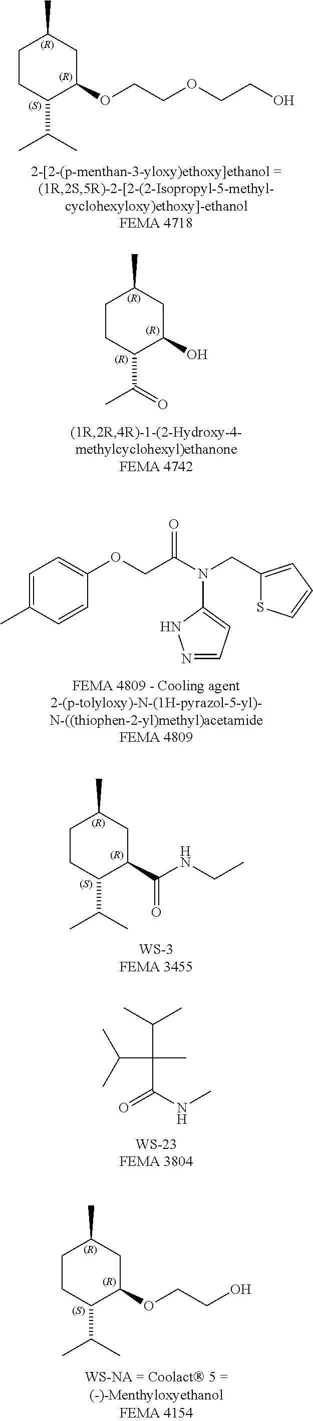

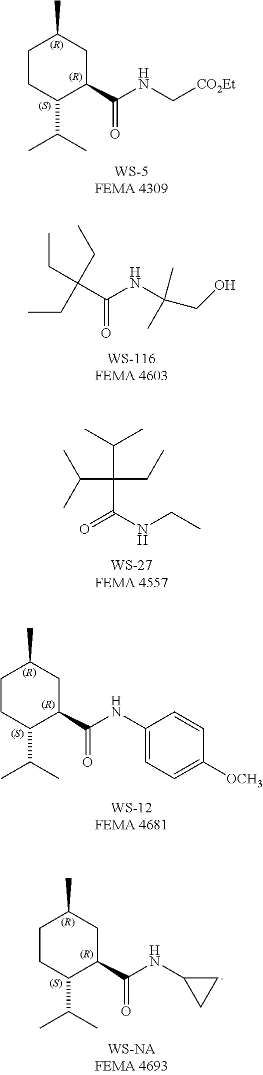

12. The method of claim 10 wherein the at least one sensate compound is selected from the group consisting of: WS-23 (2-isopropyl-N,2,3-trimethylbutyramide), FEMA 3804; WS-3 (N-ethyl-p-menthane-3-carboxamide), FEMA 3455; WS-5 [ethyl 3-(p-menthane-3-carboxamido)acetate], FEMA 4309; WS-12 (1R,2S,5R)—N-(4-methoxyphenyl)-p-menthanecarboxamide, FEMA 4681; WS-27 (N-ethyl-2,2-diisopropylbutanamide), FEMA 4557; N-cyclopropyl-5-methyl-2-isopropylcyclohexanecarboxamide, FEMA 4693; WS-116 (N-(1,1-dimethyl-2-hydroxyethyl)-2,2-diethylbutanamide), FEMA 4603; menthoxyethanol, FEMA 4154; N-(4-cyanomethylphenyl)-p-menthanecarboxamide, FEMA 4496; N-(2-(pyridin-2-yl)ethyl)-3-p-menthanecarboxamide, FEMA 4549; N-(2-hydroxyethyl)-2-isopropyl-2,3-dimethylbutanamide, FEMA 4602; N-(4-(carbamoylmethyl)phenyl)-menthylcarboxamide, FEMA 4684; (1R,2S,5R)—N-(4-methoxyphenyl)-p-menthanecarboxamide (WS-12), FEMA 4681; (2S,5R)—N-[4-(2-amino-2-oxoethyl)phenyl]-p-menthanecarboxamide, FEMA 4684; N-cyclopropyl-5-methyl-2-isopropylcyclohexanecarbonecarboxamide, FEMA 4693; 2-[(2-p-menthoxy)ethoxy]ethanol, FEMA 4718; 2,6-diethyl-5-isopropyl-2-methyltetrahydropyran, FEMA 4680; a TRPV1 antagonist that inhibits heat sensation and thus enhances cooling agents trans-4-tert-butylcyclohexanol, FEMA 4724; 2-(p-tolyloxy)-N-(1H-pyrazol-5-yl)-N-((thiophen-2-yl)methyl)acetamide, FEMA 4809; racemic N-isopropyl-5-methylcyclohexyl)cyclopropanecarboxamide, FEMA 4558; menthone glycerol ketal, FEMA 3807 and 3748; menthoxypropane-1,2-diol FEMA 3784; N-(2-hydroxyethyl)-2,3-dimethyl-2-isopropylbutyramide, FEMA 4602; N-(1,1-dimethyl-2-hydroxyethyl)2,2-diethylbutanamide, FEMA 4603); 1R,2S,5R)—N-(4-methoxyphenyl)-p-menthanecarboxamide, WS-12, N-cyclopropyl-5-methyl-2-isopropylcyclohexanecarbonecarboxamide, FEMA 4693; (1R,3R,4S)-3-menthyl-3,6-dioxaheptanoate, (1R,2S,5R)-3-menthyl methoxyacetate, (1R,2S,5R)-3-menthyl 3,6,9-trioxadecanoate, (1R,2S,5R)-3-menthyl 3,6,9-trioxadecanoate, (1R,2S,5R)-3-menthyl (2-hydroxyethoxy)acetate & (1R,2S,5R)-menthyl 11-hydroxy-3,6,9-trioxaundecanoate, N-(4-cyanomethylphenyl) p-menthanecarboxamide FEMA 4496; N,N-dimethyl menthyl succinamide (2-isopropyl-5-methylcyclohexyl 4-(dimethylamino)-4-oxobutanoate), FEMA 4230; N-(4-cyanomethylphenyl) p-menthanecarboxamide, FEMA 4496; N-(2-pyridin-2-ylethyl) p-menthanecarboxamide, FEMA 4549; menthyl lactate, FEMA 3748; N-(4-cyanomethylphenyl) p-menthanecarboxamide, FEMA 4496; N-(2-pyridin-2-ylethyl) p-menthanecarboxamide, FEMA 4549; menthyl lactate, FEMA 3748; menthol, WS-3, WS-23 and (−)-menthoxypropane-1,2-diol (TK-10), 6-isopropyl-3,9-dimethyl-1,4-dioxaspiro[4.5]decan-2-one, FEMA 4285; menthane carboxamides, N-benzo[1,3] dioxol-5-yl-3-p-menthanecarboxamide, N-benzooxazol-4-yl-3-p-menthanecarboxamide, N-4-([1,2,4]triazol-1-yl)-phenyl-3-p-menthanecarboxamide & N-4-(pyrazol-1-yl)-phenyl-3-p-menthanecarboxamide, 2,2,5,6,6-pentamethyl-2,3,6,6a-tetrahydropentalen-3a(1H)-ol, 5-(2-hydroxy-2-methylpropyl)-3,4,4-trimethylcyclopent-2-en-1-one, pyridinalkylcyclohexane carboxamides, (1R,2S,5R)-2-isopropyl-5-methyl-N-(2-(pyridin-2-yl)ethyl)cyclohexanecarboxamide, FEMA 4549, (2S,5R)-2-isopropyl-5-methyl-N-(2-(pyridin-4-yl)ethyl)cyclohexanecarboxamide, N-(4-cyanomethylphenyl) p-menthanecarboxamide, FEMA 4496; 1-isopropyl-4-methyl-bicyclo[2.2.2-1oct-5-ene-2,3-dicarbinol, 4-methoxy-N-phenyl-N-[2-(pyridin-2-yl)ethyl]benzamide, 4-methoxy-N-phenyl-N-[2-(pyridin-2-yl)ethyl]benzenesulfonamide, 4-chloro-N-phenyl-N-[2-(pyridin-2-yl)ethyl]benzenesulfonamide, 4-cyano-N-phenyl-N-[2-(pyridin-2-yl)ethyl]benzenesulfonamide, 4-((benzhydrylamino)methyl)-2-methoxyphenol, 4-((bis(4-methoxyphenyl)-methylamino)-methyl)-2-methoxyphenol, 4-((1,2-diphenylethylamino)methyl)-2-methoxyphenol, 4-((benzhydryloxy)methyl)-2-methoxyphenol, 4-((9H-fluoren-9-ylamino)methyl)-2- or 4-((benzhydrylamino)methyl)-2-ethoxyphenol, 1-(4-methoxyphenyl)-2-(1-methyl-1H-benzo[d]imidazol-2-yl)vinyl4-methoxybenzoate, 2-(1-isopropyl-6-methyl-1H-benzo[d]imidazol-2-yl)-1-(4-methoxyphenyl)vinyl4-methoxybenzoate, (Z)-2-(1-isopropyl-5-methyl-1H-benzo[d]imidazol-2-yl)-1-(4-methoxy-phenyl)vinyl-4-methoxybenzoate, N-(1-methyl-1-isopropylbutyl)benzamide, fenchyl, D-bornyl, L-bornyl, exo-norbornyl, 2-methylisobornyl, 2-ethylfenchyl, 2-methylbornyl, cis-pinan-2-yl, verbanyl and isobornyl derivatives, menthyl oxamate derivatives, menthyl 3-oxocarboxylic acid esters, L-menthyl 3-oxobutyrate, L-menthyl 3-oxopentanoate, 3,4-methylenedioxycinnamic acid, N,N-diphenylamide, (1R,2R,4S)-dihydroumbellulol, (1R,2R,5R)—N-ethyl-5-methyl-2-(prop-1-en-2-yl)cyclohexanecarboxamide, 1-[2-hydroxyphenyl]-4-[2-nitrophenyl-]-1,2,3,6-tetrahydropyrimidine-2-one), (2E,6E/Z,8E)-N-(2-methylpropyl)-2,6,8-decatrienamide, FEMA 4668; octadiene amides, octatriene amides, nonadiene amides, nonatriene amides, decadiene amides, decatriene amides, menthone, isopulegol, isopulegone including geometric isomers and non-nitrogen containing derivatives, cubebol, ketals from menthone, fenchol derivatives, bornyl derivatives, N,N-diethyl-m-toluamide, para-menthane-3,8-diol, menthyl pyrrolidone carboxylate, and derivatives of 2-isopropyl-5-methylcyclohexane.

13. The method of claim 10 wherein the biting arthropod control or repellent formulation further comprises at least one compound (a) selected from the group consisting of:
(1) alkyl ketones and cyclic ketones, saturated or unsaturated, branched or unbranched, containing from about 6 to about 18 carbon atoms, or any range of carbon atoms within said range;
(2) compounds of the structure (A) 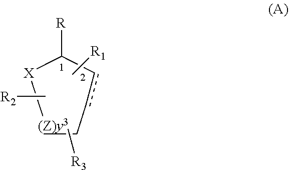
wherein:
R is selected from —OH, ═O, —OC(O)R₄, —OR₆, and —(OR₆)₂, wherein each R₆ is independently selected from an alkyl group containing from about 1 to about 4 carbon atoms and R₄ is a branched or straight chain, saturated or unsaturated, hydrocarbyl group with zero to two double bonds and from about 1 to about 15 carbon atoms;
X is O or CH₂, with the proviso that when X is O, R can only be ═O;
each Z is independently selected from (CH) and (CH₂);
y is a numeral selected from 1 and 2;
R₁ is selected from H or a branched or straight chain, saturated or unsaturated, hydrocarbyl group with zero to two double bonds and from about 1 to about 15 carbon atoms;
R₂ is selected from H and a branched or straight chain, saturated or unsaturated, hydrocarbyl group with zero to three double bonds and from about 1 to about 15 carbon atoms;
R₃ is selected from H, a branched or straight chain, saturated or unsaturated, hydrocarbyl group with zero to three double bonds and from about 1 to about 15 carbon atoms, —(CH₂)ₙOH, —C(O)OR₅, —CH₂C(O)OR₇, —CH₂C(O)R₈, —C(O)NR₉R₁₀, and —CH₂C(O)NR₁₁R₁₂, wherein each of R₅, R₇, R₈, R₉, R₁₀, R₁₁ and R₁₂ is independently selected from H and a branched or straight chain, saturated or unsaturated, hydrocarbyl group with zero to three double bonds and from about 1 to about 15 carbon atoms, and n is n integer of from 1 to 12;
the bond between the 2 and 3 positions in the ring structure may be a single or a double bond; and
wherein the compounds of structure (A) contain from about 11 to about 20 carbon atoms; and includes optical isomers, diastereomers and enantiomers of the compounds of structure (A);
(3) branched or unbranched, straight chain or cyclic, saturated or unsaturated, carboxylic acids containing from about 3 to about 18 carbon atoms or any range of carbon atoms within said range, including isomers thereof; and
(4) esters of branched or unbranched, straight chain or cyclic, saturated or unsaturated, carboxylic acids containing from about 3 to about 18 carbon atoms or any range of carbon atoms within said range, including isomers thereof.

14. The method of claim 10 wherein the biting arthropod control or repellent formulation further comprises at least one compound (a) selected from the group consisting of:

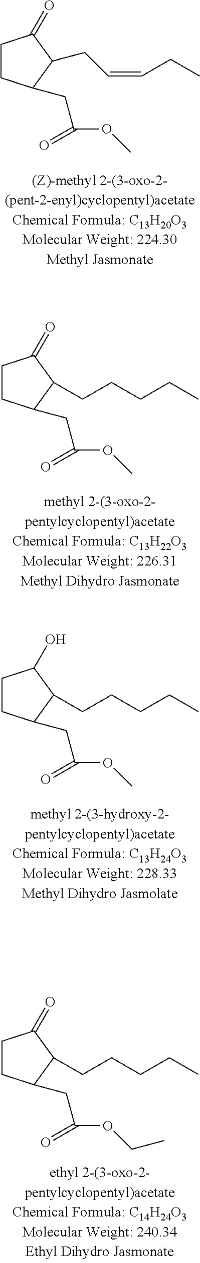 [SMILES: CC/C=C\CC1C(=O)CCC1CC(=O)OC ; CCCCCC1C(=O)CCC1CC(=O)OC ; CCCCCC1C(O)CCC1CC(=O)OC ; CCCCCC1C(=O)CCC1CC(=O)OCC]

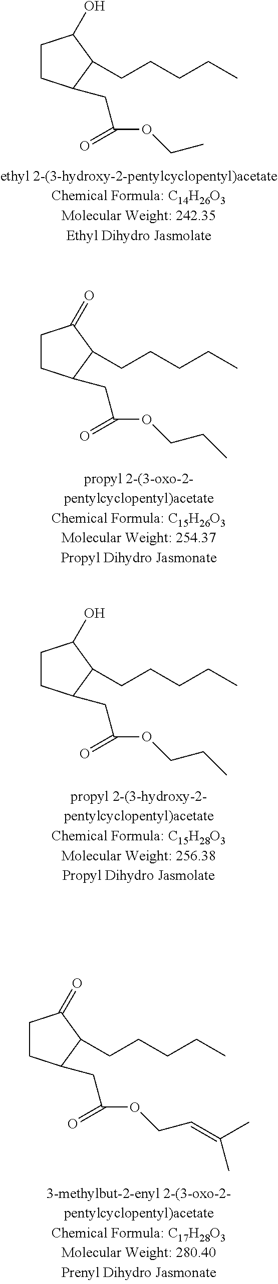 [SMILES: CCCCCC1C(O)CCC1CC(=O)OCC ; CCCCCC1C(=O)CCC1CC(=O)OCCC ; CCCCCC1C(O)CCC1CC(=O)OCCC ; CCCCCC1C(=O)CCC1CC(=O)OCC=C(C)C]

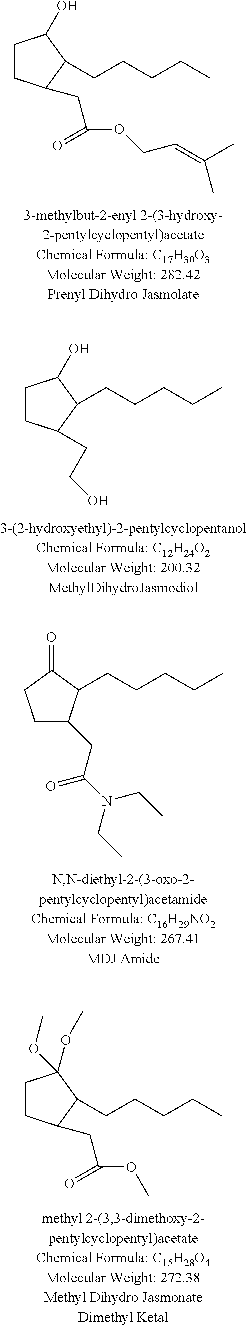 [SMILES: CCCCCC1C(O)CCC1CC(=O)OCC=C(C)C ; CCCCCC1C(O)CCC1CCO ; CCCCCC1C(=O)CCC1CC(=O)N(CC)CC ; CCCCCC1C(CC(=O)OC)CCC1(OC)OC]

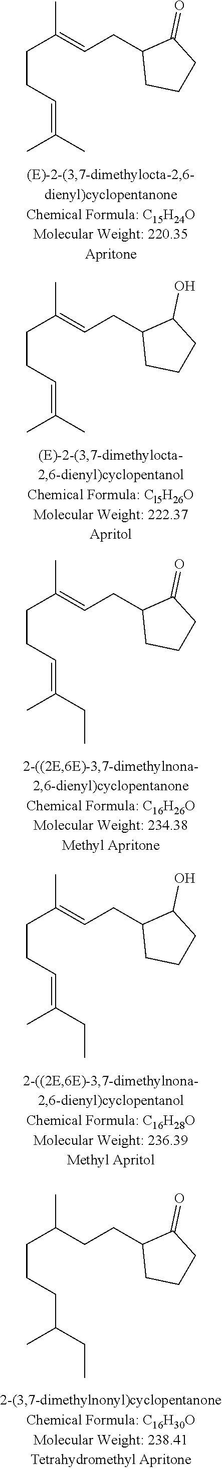 [SMILES: CC(C)=CCC/C(C)=C/CC1CCCC1=O ; CC(C)=CCC/C(C)=C/CC1CCCC1O ; CC/C(C)=C/CC/C(C)=C/CC1CCCC1=O ; CC/C(C)=C/CC/C(C)=C/CC1CCCC1O ; CCC(C)CCCC(C)CCC1CCCC1=O]

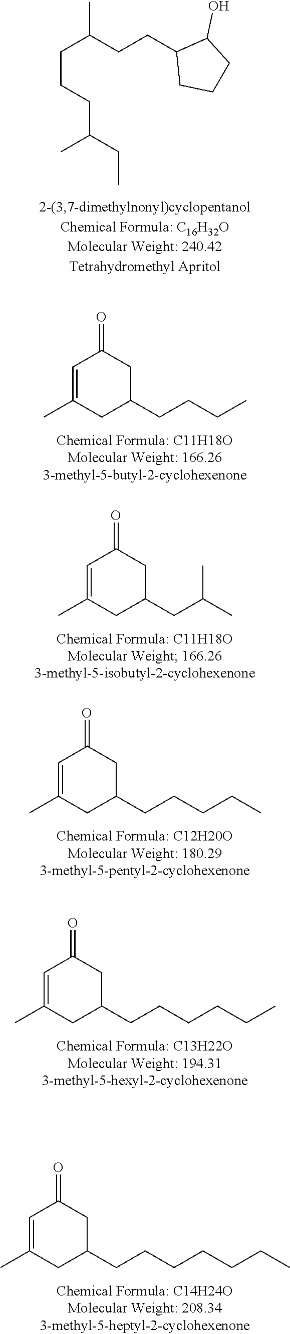

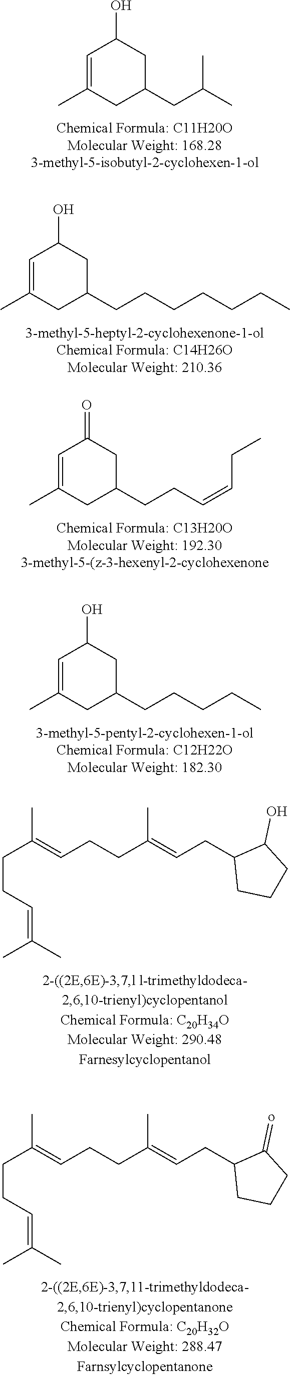

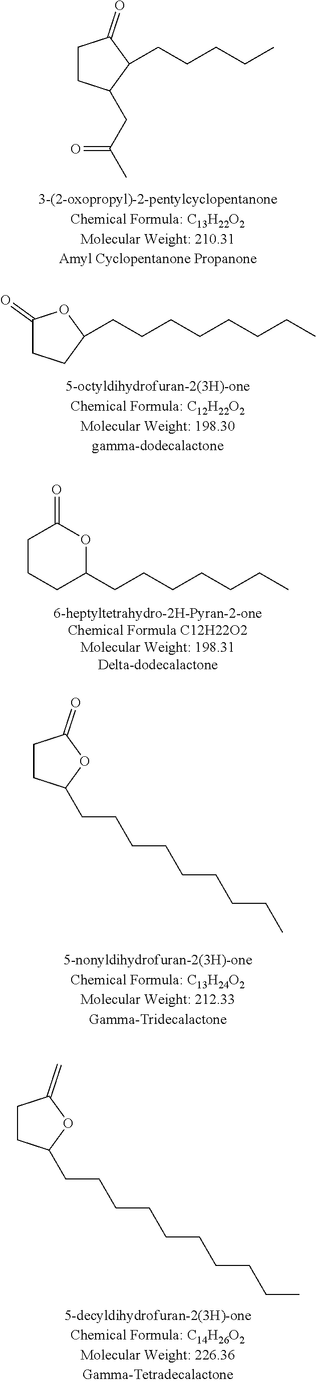 [SMILES: CCCCCC1C(=O)CCC1CC(C)=O ; CCCCCCCCC1CCC(=O)O1 ; CCCCCCCC1CCCC(=O)O1 ; CCCCCCCCCC1CCC(=O)O1 ; C=C1CCC(CCCCCCCCCC)O1]

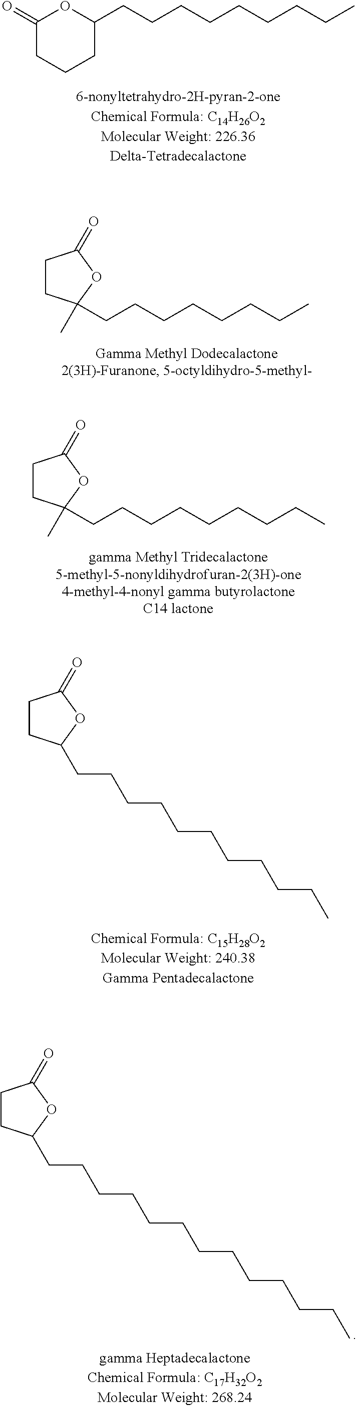 [SMILES: CCCCCCCCCC1CCCC(=O)O1 ; CCCCCCCCC1(C)CCC(=O)O1 ; CCCCCCCCCC1(C)CCC(=O)O1 ; CCCCCCCCCCCC1CCC(=O)O1 ; CCCCCCCCCCCCCC1CCC(=O)O1]

15. The method of claim 10 wherein the at least one sensate compound is present in an amount from about 0.5 to about 25%.

16. The method of claim 13 wherein the one or more sensate compounds are selected from the group consisting of menthol, menthone, isopulegol, isopulegone including geometric isomers and non-nitrogen containing derivatives, cubebol, ketals from menthone, fenchol derivatives, and bornyl derivatives; wherein the one or more compounds (a) are selected from the group consisting of methyl apritone, methyl dihydrojasmonate, propyl dihydrojasmonate, methyl dihydrojasmolate, gamma-dodecalactone, delta-dodecalactone, gamma-tridecalactone, gamma-tetradecalactone, gamma methyl dodecalactone, gamma methyl tridecalactone, 3-methyl-5-pentyl-2-cyclohexenone, 3-methyl-5-pentyl-2-cyclohexenol, 3-methyl-5-hexyl-2-cyclohexenone, and 3-methyl-5-heptyl-2-cyclohexenone; and wherein the one or more sensate compounds and the one or more compounds (a) are present in an amount from about 0.5 to about 25% by weight.

17. The method of claim 13 wherein the at least one sensate compound and the compound (a) are present in an amount from about 0.5 to about 25% by weight, and in a weight ratio of the sensate compound to compound (a) from about 0.1:2 to about 2:0.1.

18. The method of claim 10 wherein the biting arthropods are selected from the group consisting of: mosquitoes, bed bugs, biting flies, ticks, ants, fleas, biting midges, and spiders.

19. A biting arthropod control or repellent formulation for the control or repellency of biting arthropods, the formulation comprising:
(I) at least one compound (a) selected from the group consisting of:
(1) alkyl ketones and cyclic ketones, saturated or unsaturated, branched or unbranched, containing from about 6 to about 18 carbon atoms, or any range of carbon atoms within said range;
(2) compounds of the structure (A) 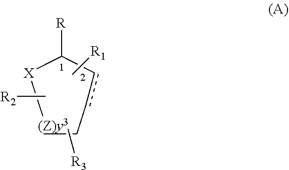
wherein:
R is selected from —OH, ═O, —OC(O)R₄, —OR₆, and —(OR₆)₂, wherein each R₆ is independently selected from an alkyl group containing from about 1 to about 4 carbon atoms and R₄ is a branched or straight chain, saturated or unsaturated, hydrocarbyl group with zero to two double bonds and from about 1 to about 15 carbon atoms;
X is O or CH₂, with the proviso that when X is O, R can only be ═O;
each Z is independently selected from (CH) and (CH₂);
y is a numeral selected from 1 and 2;
R₁ is selected from H or a branched or straight chain, saturated or unsaturated, hydrocarbyl group with zero to two double bonds and from about 1 to about 15 carbon atoms;
R₂ is selected from H and a branched or straight chain, saturated or unsaturated, hydrocarbyl group with zero to three double bonds and from about 1 to about 15 carbon atoms;
R₃ is selected from H, a branched or straight chain, saturated or unsaturated, hydrocarbyl group with zero to three double bonds and from about 1 to about 15 carbon atoms, —(CH₂)ₙOH, —C(O)OR₅, —CH₂C(O)OR₇, —CH₂C(O)R₈, —C(O)NR₉R₁₀, and —CH₂C(O)NR₁₁R₁₂, wherein each of R₅, R₇, R₈, R₉, R₁₀, R₁₁ and R₁₂ is independently selected from H and a branched or straight chain, saturated or unsaturated, hydrocarbyl group with zero to three double bonds and from about 1 to about 15 carbon atoms, and n is n integer of from 1 to 12;
the bond between the 2 and 3 positions in the ring structure may be a single or a double bond; and
wherein the compounds of structure (A) contain from about 11 to about 20 carbon atoms; and includes optical isomers, diastereomers and enantiomers of the compounds of structure (A);
(3) branched or unbranched, straight chain or cyclic, saturated or unsaturated, carboxylic acids containing from about 3 to about 18 carbon atoms or any range of carbon atoms within said range, including isomers thereof; and
(4) esters of branched or unbranched, straight chain or cyclic, saturated or unsaturated, carboxylic acids containing from about 3 to about 18 carbon atoms or any range of carbon atoms within said range, including isomers thereof; and
(II) at least one sensate compound.

20. A method for the control or repellency of biting arthropods, the method comprising bringing the biting arthropods into contact with a biting arthropod control or repellent formulation, wherein the biting arthropod control or repellent formulation comprises:
(I) at least one compound (a) selected from the group consisting of:
(1) alkyl ketones and cyclic ketones, saturated or unsaturated, branched or unbranched, containing from about 6 to about 18 carbon atoms, or any range of carbon atoms within said range;
(2) compounds of the structure (A) 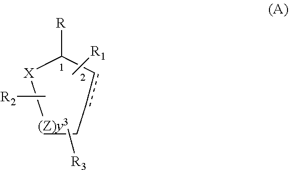
wherein:
R is selected from —OH, ═O, —OC(O)R₄, —OR₆, and —(OR₆)₂, wherein each R₆ is independently selected from an alkyl group containing from about 1 to about 4 carbon atoms and R₄ is a branched or straight chain, saturated or unsaturated, hydrocarbyl group with zero to two double bonds and from about 1 to about 15 carbon atoms;
X is O or CH₂, with the proviso that when X is O, R can only be ═O;
each Z is independently selected from (CH) and (CH₂);
y is a numeral selected from 1 and 2;
R₁ is selected from H or a branched or straight chain, saturated or unsaturated, hydrocarbyl group with zero to two double bonds and from about 1 to about 15 carbon atoms;
R₂ is selected from H and a branched or straight chain, saturated or unsaturated, hydrocarbyl group with zero to three double bonds and from about 1 to about 15 carbon atoms;
R₃ is selected from H, a branched or straight chain, saturated or unsaturated, hydrocarbyl group with zero to three double bonds and from about 1 to about 15 carbon atoms, —(CH₂)ₙOH, —C(O)OR₅, —CH₂C(O)OR₇, —CH₂C(O)R₈, —C(O)NR₉R₁₀, and —CH₂C(O)NR₁₁R₁₂, wherein each of R₅, R₇, R₈, R₉, R₁₀, R₁₁ and R₁₂ is independently selected from H and a branched or straight chain, saturated or unsaturated, hydrocarbyl group with zero to three double bonds and from about 1 to about 15 carbon atoms, and n is n integer of from 1 to 12;
the bond between the 2 and 3 positions in the ring structure may be a single or a double bond; and
wherein the compounds of structure (A) contain from about 11 to about 20 carbon atoms; and includes optical isomers, diastereomers and enantiomers of the compounds of structure (A);
(3) branched or unbranched, straight chain or cyclic, saturated or unsaturated, carboxylic acids containing from about 3 to about 18 carbon atoms or any range of carbon atoms within said range, including isomers thereof; and
(4) esters of branched or unbranched, straight chain or cyclic, saturated or unsaturated, carboxylic acids containing from about 3 to about 18 carbon atoms or any range of carbon atoms within said range, including isomers thereof; and
(II) at least one sensate compound.
